(19) United States
(12) Patent Application Publication
(10) Pub. No.: US 2026/0205858 A1
(43) Pub. Date: Jul. 16, 2026

(54) METHOD AND APPARATUS FOR CHANNEL STATE INFORMATION REPORT IN WIRELESS COMMUNICATION SYSTEMS

(71) Applicant: Samsung Electronics Co., Ltd., Suwon-si (KR)

(72) Inventors: Youngrok JANG, Suwon-si (KR); Kyungjun CHOI, Suwon-si (KR); Hyoungju JI, Suwon-si (KR); Seongmok LIM, Suwon-si (KR); Ameha Tsegaye ABEBE, Suwon-si (KR); Kyoungmin PARK, Suwon-si (KR)

(21) Appl. No.: 19/442,546

(22) Filed: Jan. 7, 2026

(30) Foreign Application Priority Data
Jan. 10, 2025 (KR) 10-2025-0003908

(51) Int. Cl. H04W 24/10

(52) U.S. Cl. CPC H04W 24/10

(57) ABSTRACT

The disclosure relates to a 5G or 6G communication system for supporting a higher data transmission rate. The disclosure relates to operations of a user equipment (UE) and a base station in a wireless communication system. A method for transmitting/receiving uplink reference signals in a wireless communication system, and an apparatus capable of performing the same is provided.

### CROSS-REFERENCE TO RELATED APPLICATION(S)

This application is based on and claims priority under 35 U.S.C. § 119(a) of a Korean patent application number 10-2025-0003908, filed on Jan. 10, 2025, in the Korean Intellectual Property Office, the disclosure of which is incorporated by reference herein in its entirety.

### BACKGROUND

### 1. Field

The disclosure relates to operations of a terminal and a base station in a wireless communication system. More particularly, the disclosure relates to a method for reporting channel state information in a wireless communication system, and an apparatus capable of performing the same.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and At (Artificial Intelligence) from the design stage and internalizing end-to-end At support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide an apparatus and a method capable of effectively providing services in a mobile communication system.

Additional aspects will be set forth in part in the description which follows and, in part, will be apparent from the description, or may be learned by practice of the presented embodiments.

In accordance with an aspect of the disclosure, an apparatus and a method capable of effectively providing services in a mobile communication system are provided. A method performed by a user equipment (UE) in a wireless communication system, the method comprising: receiving, from a base station, configuration information on a channel state information (CSI) report associated with a event type, the configuration information includes information on a report of a current beam and a threshold associated with the event type; identifying that a reference signal received power (RSRP) of the current beam is lower than the threshold; and transmitting, to the base station, the CSI report including the RSRP of the current beam based on the information on the report of the current beam.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of a bandwidth part configuration in a wireless communication system according to an embodiment of the disclosure;

FIG. 4 illustrates radio protocol structures of a base station and a UE in single cell, carrier aggregation, and dual connectivity situations in a wireless communication system according to an embodiment of the disclosure;

FIG. 5 illustrates a beam application time which may be considered in a case where a unified transmission configuration indication (TCI) scheme is used in a wireless communication system according to an embodiment of the disclosure;

FIG. 6 illustrates another medium access control (MAC)-control element (CE) structure for activation and indication of a joint TCI state or a separate downlink (DL) or uplink (UL) TCI state in a wireless communication system according to an embodiment of the disclosure;

FIG. 7 illustrates an example of an aperiodic CSI reporting method in a wireless communication system according to an embodiment of the disclosure;

FIG. 8 illustrates an example of a control resource set configuration of a downlink control channel in a wireless communication system according to an embodiment of the disclosure;

FIG. 9 illustrates a structure of a downlink control channel in a wireless communication system according to an embodiment of the disclosure;

FIG. 10 is a diagram illustrating a channel measurement and channel state reporting scheme according to a base station's configuration and indication in a wireless communication system according to an embodiment of the disclosure;

FIG. 11 is a diagram illustrating a method for determining a current reception beam in the case of [event 3] in a wireless communication system according to an embodiment of the disclosure;

FIG. 12 is a diagram illustrating an operation process of a UE and a base station regarding CSI reporting started by the UE by using a physical uplink control channel (PUCCH) resource for triggering reception beam performance reporting started from the UE in a wireless communication system according to an embodiment of the disclosure;

FIG. 13 is a diagram illustrating an operation process of a UE and a base station regarding CSI reporting started by the UE by using a pair of a reserved PUCCH resource and physical uplink shared channel (PUSCH) transmission in a wireless communication system according to an embodiment of the disclosure;

FIG. 14 illustrates a structure of a UE in a wireless communication system according to an embodiment of the disclosure; and

FIG. 15 illustrates a structure of a base station in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or long term evolution advanced (LTE-A) systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. The contents of the disclosure may be applied to frequency division duplex (FDD) and time division duplex (TDD) systems.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of third generation partnership project (3GPP), LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, various transmission/reception technologies including a further enhanced multi-input multi-output (MIMO) transmission technique may be required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

Hereinafter, a frame structure of a 5G system will be described in more detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

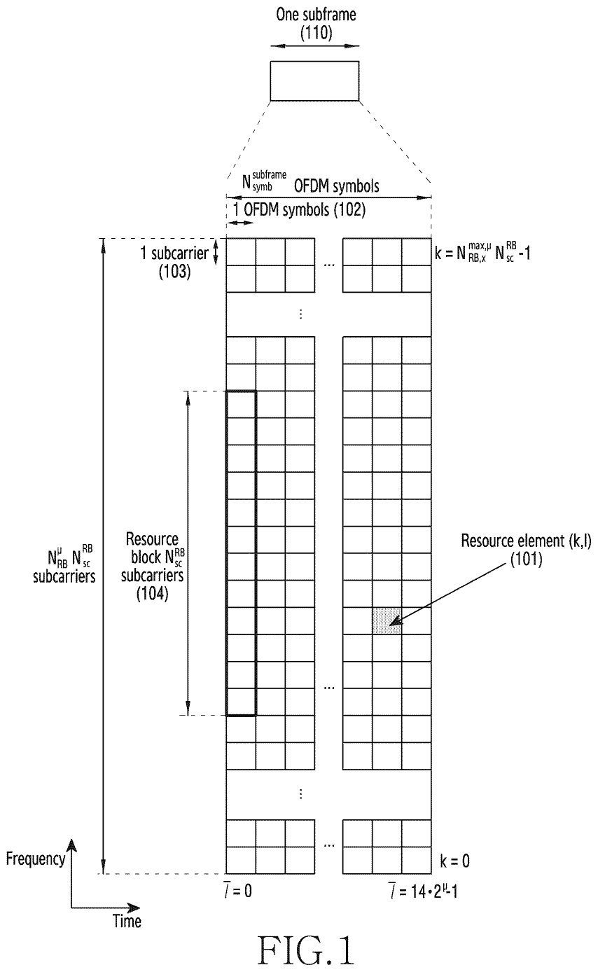

FIG. 1 illustrates a basic structure of a time-frequency domain, which is a radio resource domain used to transmit data or control channels, in a 5G system according to an embodiment of the disclosure.

The horizontal axis in FIG. 1 represents a time domain, and the vertical axis in FIG. 1 represents a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain,

$${N}_{SC}^{R B}$$

(for example, 12) consecutive REs may constitute one resource block (RB) 104. In the time domain, one subframe 110 may include multiple OFDM symbols 102. For example, the length of one subframe may be 1 ms.

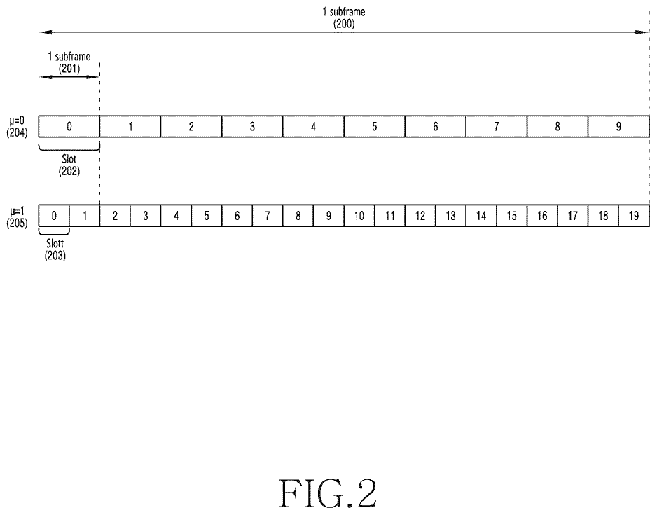

FIG. 2 illustrates a structure of a frame, a subframe, and a slot in a wireless communication system according to an embodiment of the disclosure.

FIG. 2 illustrates an example of a structure of a frame 200, a subframe 201, and a slot 202. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot

$${N}_{s y m b}^{s l o t} = 14 ) .$$

One subframe 201 may include one or multiple slots 202 and 203, and the number of slots 202 and 203 per one subframe 201 may vary depending on configuration values μ 204 or 205 for the subcarrier spacing. The example of FIG. 2 shows the case of μ=0 (204) and the case of μ=1 (205) as a configuration value for a subcarrier spacing. In the case of μ=0 (204), one subframe 201 may include one slot 202, and in the case of μ=1 (205), one subframe 201 may include two slots 203. That is, the number of slots per one subframe

$${N}_{s l o t}^{s u b f r ame , μ}$$

may differ depending on the subcarrier spacing configuration value μ, and the number of slots per one frames

$${N}_{s l o t}^{f r ame , μ}$$

may differ accordingly.

$${N}_{slot}^{s u b f r ame , μ} and {N}_{s l o t}^{f r ame , μ}$$

may be defined according to each subcarrier spacing configuration μ as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in a 5G communication system will be described in detail with reference to the accompanying drawings.

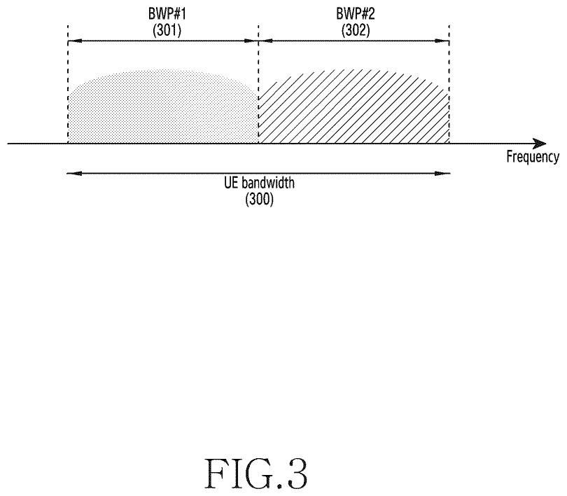

FIG. 3 illustrates an example of a bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

TABLE 2

| | |
|---|---|
| BWP ::= | SEQUENCE { |
| bwp-Id | BWP-Id, |
| (bandwidth part identifier) | |
| locationAndBandwidth | INTEGER (1..65536), |
| (bandwidth part location) | ENUMERATED {n0, n1, n2, n3, |
| subcarrierSpacing | |
| n4, n5}, | |
| (subcarrier spacing) | |
| cyclicPrefix | ENUMERATED { extended } |
| (cyclic prefix) | |
| } | |

Obviously, the above example is not limiting, and various parameters related to the bandwidth part may be configured for the UE, in addition to the above configuration information. The base station may transfer the configuration information in Table 2 to the UE through upper layer signaling (for example, radio resource control (RRC) message). One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify (transmit or deliver) the UE of configuration information, such as frequency allocation information regarding control resource set #0, time allocation information, and numerology, through the MIB. In addition, the base station may notify the UE of configuration information regarding the monitoring cycle and occasion with regard to control resource set #0, that is, configuration information regarding search space #0, through the MIB. The UE may consider that a frequency domain configured by CORESET #0 acquired from the MIB is an initial bandwidth part for initial access. The ID of the initial bandwidth part may be considered to be 0.

Obviously, the above embodiment is not limiting, and the bandwidth part configuration supported by the 5G communication system, may be used for various purposes.

According to an embodiment, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control region (for example, CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered (or configured) as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. For example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside the received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (TBWP) required during a bandwidth part change are specified in standards, and may be defined as given in Table 3 below, for example.

TABLE 3

BWP switch delay TBWP (slots)

| μ | NR Slot length (ms) | Type 1Note 1 | Type 2Note 1 |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+TBWP, and may transmit/receive a data channel scheduled by the corresponding DCI in the newly changed bandwidth part. If the base station wants to schedule a data channel by using the new bandwidth part, the base station may determine time domain resource allocation regarding the data channel, based on the UE's bandwidth part change delay time (TBWP). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI indicating a bandwidth part change will indicate a slot offset (K0 or K2) value smaller than the bandwidth part change delay time (TBWP).

If the UE has received DCI (for example, DCI format 1_1 or 01) indicating a bandwidth part change, the UE may perform no transmission or reception during a time interval from the third symbol of the slot used to receive a PDCCH including the corresponding DCI to the start point of the slot indicated by a slot offset (for example, K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [Regarding CA/DC]

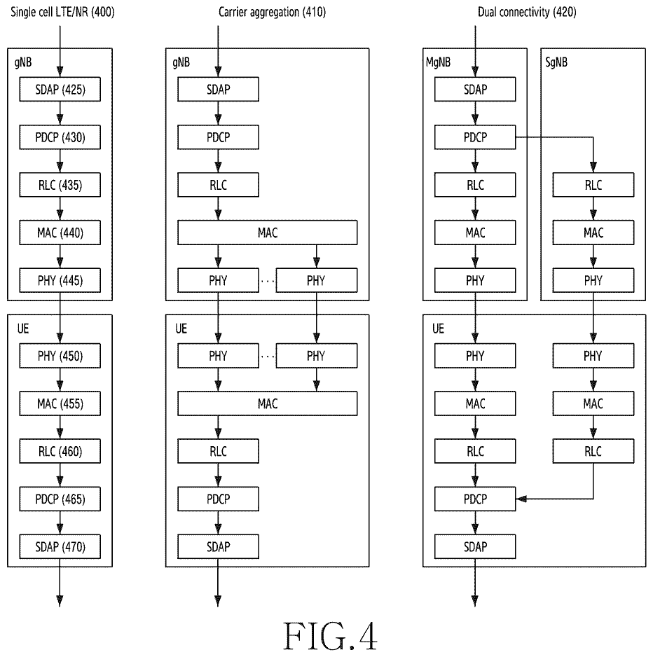

FIG. 4 illustrates radio protocol structures of a base station and a UE in single cell, carrier aggregation, and dual connectivity situations according to an embodiment of the disclosure.

Referring to FIG. 4, a radio protocol of a next-generation mobile communication system includes an NR service data adaptation protocol (SDAP) 425 or 470, an NR packet data convergence protocol (PDCP) 430 or 465, an NR radio link control (RLC) 435 or 460, and an NR medium access controls (MAC) 440 or 455, on each of UE and NR base station sides.

The main functions of the NR SDAP 425 or 470 may include some of functions below.
Transfer of user plane data
Mapping between a quality of service (QoS) flow and a data radio bearer (DRB) for both DL and UL
Marking QoS flow ID in both DL and UL packets
Reflective QoS flow to DRB mapping for the UL SDAP protocol data units (PDUs)

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 430 or 465 may include some of functions below.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer service data units (SDUs)
Retransmission of PDCP SDUs
Ciphering and deciphering
Timer-based SDU discard in uplink

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC 435 or 460 may include some of functions below.
Transfer of upper layer PDUs
In-sequence delivery of upper layer PDUs
Out-of-sequence delivery of upper layer PDUs
Error Correction through automatic repeat request (ARQ)
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

Among the above-described functions, the in-sequence delivery of the NR RLC device may refer to a function of delivering RLC SDUs, received from the lower layer, to the upper layer in sequence. The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery function of the NR RLC device may refer to a function of instantly delivering RLC SDUs received from the lower layer to the upper layer regardless of the order, may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MAC 440 or 455 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through hybrid ARQ (HARQ)
Priority handling between logical channels of one UE
Priority handling between UEs by means of dynamic scheduling
multimedia broadcast/multicast service (MBMS) service identification
Transport format selection
Padding

An NR PHY layer 445 or 450 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 400. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 410. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 420.

### [Unified TCI State]

Hereinafter, a single TCI state indication and activation method based on a unified TCI scheme is described. The unified TCI scheme may mean a scheme of integrating and managing, through a TCI state, a transmission and/or reception beam management scheme, which has been classified as a TCI state scheme used in downlink reception of a UE and a spatial relation info scheme used in uplink transmission in conventional Rel-15 and 16. Therefore, in a case where a UE receives an indication from a base station, based on the unified TCI scheme, the UE may perform beam management even for uplink transmission by using a TCI state. If the higher layer signaling TCI-State having the higher layer signaling tci-stateId-r17 is configured for a UE by a base station, the UE may perform an operation based on the unified TCI scheme by using the TCI-State. TCI-State may exist in two types including a joint TCI state and a separate TCI state.

The first type is a joint TCI state, and all TCI states to be applied to uplink transmission and downlink reception may be indicated to a UE by a base station through one value of TCI-State. If joint TCI state-based TCI-state is indicated to the UE, a parameter to be used in downlink channel estimation may be indicated to the UE by the base station by using an RS corresponding to quasi co-located (qcl)-Type1 in the joint TCI state-based TCI-state, and a parameter to be used as a downlink reception beam or reception filter may be indicated thereto by using an RS corresponding to qcl-Type2. If joint TCI state-based TCI-state is indicated to the UE by the base station, a parameter to be used as an uplink transmission beam or transmission filter may be indicated to the UE by the base station by using an RS corresponding to qcl-Type2 in joint DL/UL TCI state-based TCI-state. If a joint TCI state is indicated to the UE by the base station, the UE may apply the same beam to uplink transmission and downlink reception.

The second type is a separate TCI state, and a UL TCI state to be applied to uplink transmission and a DL TCI state to be applied to downlink reception may be individually indicated to a UE by a base station. If a UL TCI state is indicated to the UE by the base station, a parameter to be used as an uplink transmission beam or transmission filter may be indicated to the UE by the base station by using a reference RS or a source RS configured in the indicated UL TCI state. If a DL TCI state is indicated to the UE by the base station, a parameter to be used in downlink channel estimation may be indicated to the UE by the base station by using an RS corresponding to qcl-Type1 configured in the DL TCI state, and a parameter to be used as a downlink reception beam or reception filter may be indicated thereto by using an RS corresponding to qcl-Type2.

If a DL TCI state and a UL TCI state are indicated together to the UE, a parameter to be used as an uplink transmission beam or transmission filter may be indicated to the UE by the base station by using a reference RS or a source RS configured in the UL TCI state. Then, a parameter to be used in downlink channel estimation may be indicated to the UE by the base station by using an RS corresponding to qcl-Type1 configured in the DL TCI state, and a parameter to be used as a downlink reception beam or reception filter may be indicated thereto by using an RS corresponding to qcl-Type2. If the reference RSs or source RSs configured in the DL TCI state and UL TCI state indicated to the UE are different from each other, the UE may apply individual beams to uplink transmission and downlink reception, based on the UL TCI state and DL TCI state indicated by the base station.

A maximum of 128 values of joint TCI state may be configured for a UE by a base station through higher layer signaling by each particular bandwidth part in a particular cell. A maximum of 64 or 128 DL TCI states, each of which is one among separate TCI states, may be configured for the UE by the base station through higher layer signaling, based on a UE capability report by each particular bandwidth part in a particular cell. The UE may use the same higher layer signaling structure for a DL TCI state among separate TCI states and a joint TCI state. For example, if 128 joint TCI states are configured and 64 DL TCI states, each of which is one among separate TCI states, are configured, the 64 DL TCI states may be included in the 128 joint TCI states.

A maximum of 32 or 64 UL TCI states, each of which is one among separate TCI states, may be configured for the UE through higher layer signaling, based on a UE capability report by each particular bandwidth part in a particular cell. A UL TCI state among separate TCI states and a joint TCI state may also use the same higher layer signaling structure like the relation between a DL TCI state among separate TCI states and a joint TCI state, or a UL TCI state among separate TCI states may also use a higher layer signaling structure different from that of a joint TCI state and a DL TCI state among separate TCI states.

As described above, using different or identical higher layer signaling structures may be defined in a specification. Alternatively, using different or identical higher layer signaling structures may be distinguished through another higher layer signaling that is configured by the base station, based on a UE capability report including information on a usage scheme supportable by the UE among two types of usage schemes.

A transmission and/or reception beam-related indication may be received by the UE in a unified TCI scheme by using one scheme among a joint TCI state and a separate TCI state configured by the base station. Whether to use one of a joint TCI state and a separate TCI state may be configured for the UE by the base station through higher layer signaling.

The UE may receive a transmission and/or reception beam-related indication through higher layer signaling by using one scheme selected from among a joint TCI state and a separate TCI state, and a method of indicating a transmission and/or reception beam by the base station may be classified as two types of methods including a MAC-CE-based indication method and a MAC-CE-based activation and DCI-based indication method.

In a case where the UE receives a transmission and/or reception beam-related indication through higher layer signaling by using a joint TCI state scheme, the UE may receive a MAC-CE indicating a joint TCI state from the base station to perform a transmission and/or reception beam application operation. The base station may schedule reception of a PDSCH including the MAC-CE indicating the joint TCI state to the UE through a PDCCH. If a MAC-CE includes one joint TCI state, the UE may determine an uplink transmission beam or transmission filter and a downlink reception beam or reception filter by using the indicated joint TCI state after 3 ms after transmission of a PUCCH including HARQ-ACK information indicating whether reception of a PDSCH including the MAC-CE including the one joint TCI state is successful. If a MAC-CE includes two or more joint TCI states, the UE may identify that the multiple joint TCI states indicated by the MAC-CE correspond to respective codepoints of a TCI state field of DCI format 1_1 or 1_2 after 3 ms after the transmission of a PUCCH including HARQ-ACK information indicating whether reception of a PDSCH including the MAC-CE including the two or more joint TCI states is successful, and activate the indicated joint TCI states. Thereafter, the UE may receive DCI format 1_1 or 1_2 to apply one joint TCI state indicated by a TCI state field in the received DCI to uplink transmission and downlink reception beams. DCI format 1_1 or 12 may include downlink data channel scheduling information (with DL assignment) or not include same (without DL assignment).

In a case where the UE receives a transmission and/or reception beam-related indication through higher layer signaling by using a separate TCI state scheme, the UE may receive a MAC-CE indicating a separate TCI state from the base station to perform a transmission and/or reception beam application operation. The base station may schedule reception of a PDSCH including the MAC-CE indicating the separate TCI state to the UE through a PDCCH. If a MAC-CE includes one separate TCI state set, the UE may determine an uplink transmission beam or transmission filter by using separate TCI states included in the indicated separate TCI state set after 3 ms after PUCCH transmission including HARQ-ACK information meaning whether a PDSCH has been successfully received. In addition, the UE may determine a downlink reception beam or reception filter by using separate TCI states included in the indicated separate TCI state set after 3 ms after PUCCH transmission including HARQ-ACK information meaning whether a PDSCH has been successfully received. The separate TCI state set may be referred to as single or multiple separate TCI states which one codepoint of a TCI state field in DCI format 1_1 or 1_2 may have. One separate TCI state set may include one DL TCI state, include one UL TCI state, or include one DL TCI state and one UL TCI state. If a MAC-CE includes two or more separate TCI state sets, the UE may identify that the multiple separate TCI state sets indicated by the MAC-CE correspond to respective codepoints of a TCI state field of DCI format 1_1 or 1_2 after 3 ms from transmission of a PUCCH including HARQ-ACK information indicating whether reception of a PDSCH is successful, and may activate the indicated separate TCI state sets. Each codepoint of the TCI state field of DCI format 1_1 or 1_2 may indicate one DL TCI state, indicate one UL TCI state, or indicate one DL TCI state and one UL TCI state. The UE may receive DCI format 1_1 or 1_2 to apply a separate TCI state set indicated by a TCI state field in the DCI to uplink transmission and downlink reception beams. DCI format 11 or 12 may include downlink data channel scheduling information (with DL assignment) or not include same (without DL assignment).

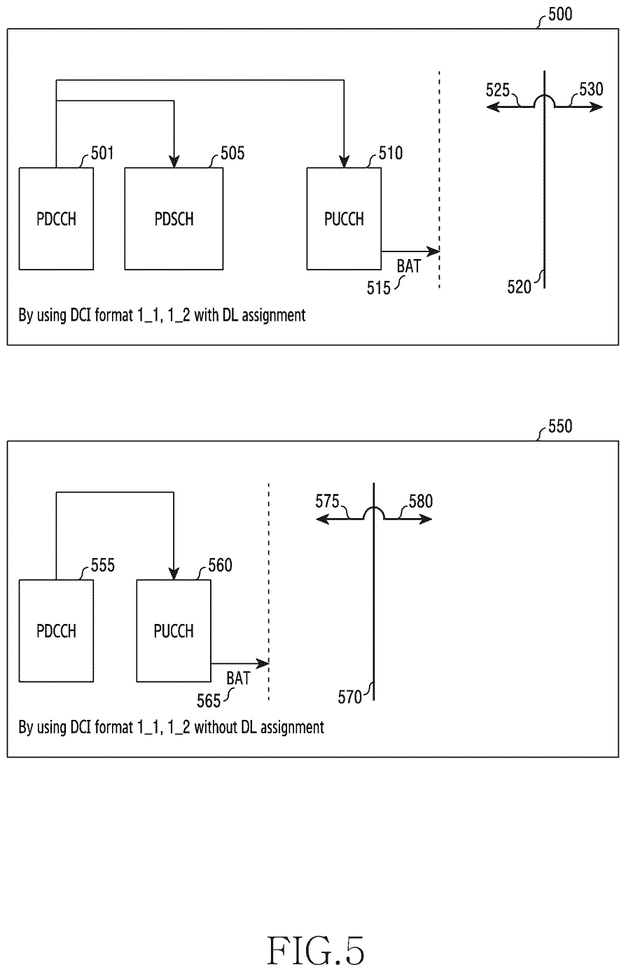

FIG. 5 is a diagram illustrating a beam application time which may be considered when a unified TCI scheme is used in a wireless communication system according to an embodiment of the disclosure.

Referring to FIG. 5, as described above, a UE may receive, from a base station, DCI format 1_1 or 1_2 including or not including downlink data channel scheduling information (with DL assignment or without DL assignment), and apply one joint TCI state or one separate TCI state set indicated by a TCI state field in the DCI to uplink transmission and downlink reception beams.

DCI format 1_1 or 1_2 with DL assignment (500): If a UE receives, from a base station, DCI format 1_1 or 1_2 including downlink data channel scheduling information (501) so that one joint TCI state or one separate TCI state set based on a unified TCI scheme is indicated, the UE may receive a PDSCH scheduled based on the received DCI (505), and transmit a PUCCH including a HARQ-ACK indicating whether reception of the DCI and the PDSCH is successful (510). The HARQ-ACK may include whether reception is successful, for both the DCI and the PDSCH. If the UE fails to receive at least one of the DCI and the PDSCH, the UE may transmit a NACK, and if the UE succeeds in receiving both of them, the UE may transmit an ACK.

DCI format 1_1 or 1_2 without DL assignment (550): If a UE receives, from a base station, DCI format 1_1 or 1_2 not including downlink data channel scheduling information (555) so that one joint TCI state or one separate TCI state set based on a unified TCI scheme is indicated, the UE may assume at least one combination of the following items for the DCI. However, the disclosure is not limited thereto.
The DCI includes a CRC scrambled using a CS-RNTI.
The values of all bits assigned to all fields used as redundancy version (RV) fields are 1.
The values of all bits assigned to all fields used as modulation and coding scheme (MCS) fields are 1.
The values of all bits assigned to all fields used as new data indication (NDI) fields are 0.
In a case of frequency domain resource allocation (FDRA) type 0, the values of all bits assigned to an FDRA field are 0, in a case of FDRA type 1, the values of all bits assigned to an FDRA field are 1, and in a case of an FDRA scheme being dynamicSwitch, the values of all bits assigned to an FDRA field are 0.

The UE may transmit, to the base station, a PUCCH including a HARQ-ACK indicating whether DCI format 1_1 or 1_2 on which the items described above are assumed is successfully received (560).
With respect to DCI format 1_1 or 1_2 both with DL assignment (500) and without DL assignment (550), if a new TCI state indicated through DCI 501 or 555 is the same as a TCI state having been previously indicated and thus having been being applied to uplink transmission and downlink reception beams, the UE may maintain the previously applied TCI state. If the new TCI state is different from the previously indicated TCI state, the UE may determine, as a time point for application of a joint TCI state or separate TCI state set, which is indicatable by a TCI state field included in the DCI, a time point 530 or 580 after the first slot 520 or 570 after passage of a time interval as long as a beam application time (BAT) 515 or 565 after PUCCH transmission, and may use the previously indicated TCI-state at a time point 525 or 575 before the corresponding slot 520 or 570.
With respect to DCI format 1_1 or 1_2 both with DL assignment (500) and without DL assignment (550), the BAT is a particular number of OFDM symbols, and may be configured through higher layer signaling, based on UE capability report information. Numerologies of the BAT and the first slot after the BAT may be determined based on the smallest numerology among all cells to which a joint TCI state or separate TCI set indicated through DCI is applied.

The UE may apply one joint TCI state indicated through a MAC-CE or DCI to reception for control resource sets connected to all UE-specific search spaces, reception of a PDSCH scheduled by a PDCCH transmitted from the control resource sets and transmission of a PUSCH, and transmission of all PUCCH resources.

If one separate TCI state set indicated through a MAC-CE or DCI includes one DL TCI state, a UE may apply the one separate TCI state set to reception for control resource sets connected to all UE-specific search spaces, and reception of a PDSCH scheduled by a PDCCH transmitted from control resource sets connected to all UE-specific search spaces. In addition, the UE may apply a previously indicated UL TCI state to all PUSCH and PUCCH resources.

If one separate TCI state set indicated through a MAC-CE or DCI includes one UL TCI state, the UE may apply the UL TCI state to all PUSCH and PUCCH resources. The UE may apply a previously indicated DL TCI state to reception for control resource sets connected to all UE-specific search spaces, and reception of a PDSCH scheduled by a PDCCH transmitted from control resource sets connected to all UE-specific search spaces.

If one separate TCI state set indicated through a MAC-CE or DCI includes one DL TCI state and one UL TCI state, the UE may apply the DL TCI state to reception for control resource sets connected to all UE-specific search spaces, and reception of a PDSCH scheduled by a PDCCH transmitted from control resource sets connected to all UE-specific search spaces. The UE may apply the UL TCI state to all PUSCH and PUCCH resources.

### [Unified TCI State MAC-CE]

Hereinafter, a single TCI state indication and activation method based on a unified TCI scheme is described. A PDSCH including a MAC-CE may be scheduled to a UE by a base station, and the UE may interpret each codepoint of a TCI state field in DCI format 1_1 or 1_2, based on information in the MAC-CE received from the base station, after 3 slots from transmission of a HARQ-ACK for the PDSCH to the base station. For example, the UE may activate each entry of the MAC-CE received from the base station in each codepoint of the TCI state field in DCI format 1_1 or 1_2.

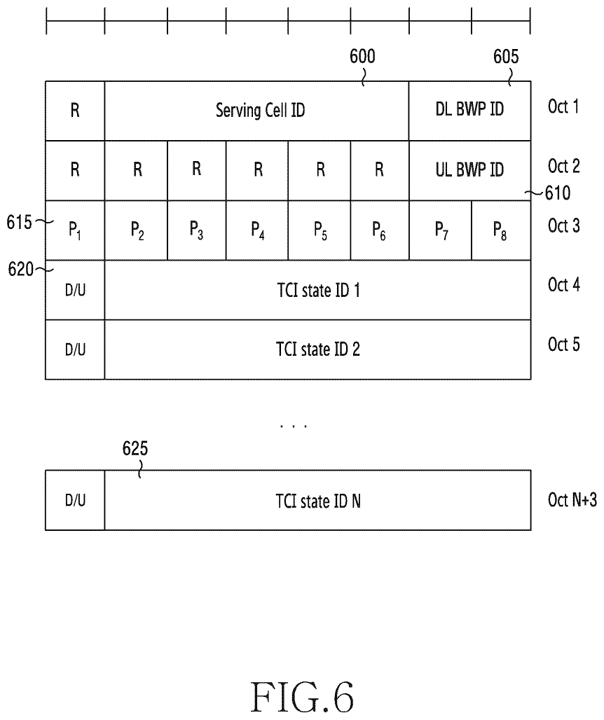

FIG. 6 is a diagram illustrating a MAC-CE structure for activation and indication of a joint TCI state or a separate DL or UL TCI state in a wireless communication system according to an embodiment of the disclosure.

Referring to FIG. 6, each field in the MAC-CE structure may have the following meaning.
Serving Cell ID 600: A serving cell ID field may indicate a serving cell to which a MAC-CE is to be applied. The length of the serving cell ID field may be 5 bits. If a serving cell indicated by the serving cell ID field may be included in at least one of the higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to all serving cells included in at least one list among simultaneousU-TCI-UpdateList1, simultaneousU-TCI-UpdateList2, simultaneousU-TCI-UpdateList3, or simultaneousU-TCI-UpdateList4, in which the serving cell indicated by the serving cell ID field is included.
DL BWP ID 605: A DL BWP ID field may indicate a DL BWP to which a MAC-CE is to be applied. The meaning of each codepoint of the DL BWP ID field may correspond to each codepoint of a bandwidth part indicator in DCI. The length of the DL BWP ID field may be 2 bits.
UL BWP ID 610: A UL BWP ID field may indicate a UL BWP to which a corresponding MAC-CE is to be applied. The meaning of each codepoint of the UL BWP ID field may correspond to each codepoint of a bandwidth part indicator in DCI. The length of the UL BWP ID field may be 2 bits.
P_i 615: A P_i field may indicate whether each codepoint of a TCI state field in DCI format 1_1 or 1_2 has multiple TCI states or one TCI state. If the value of P_i is 1, this may indicate that the i-th codepoint has multiple TCI states. In addition, if the value of P_i is 1, this may imply that the i-th codepoint may include a separate DL TCI state and a separate UL TCI state. If the value of P_i is 0, this may indicate that the i-th codepoint has a single TCI state. If the value of P_i is 0, this may imply that the i-th codepoint may include one type among a joint TCI state, a separate DL TCI state, or a separate UL TCI state.
D/U 620: A D/U field may indicate whether a TCI state ID field in the same octet is a joint TCI state, a separate DL TCI state, or a separate UL TCI state. If the D/U field is 1, the TCI state ID field in the same octet is a joint TCI state or a separate DL TCI state. In addition, if the D/U field is 0, the TCI state ID field in the same octet is a separate UL TCI state.
TCI state ID 625: A TCI state ID field may indicate a TCI state identifiable by the higher layer signaling TCI-StateId. If the D/U field is configured to be 1, the TCI state ID field may be used to represent TCI-StateId expressible by 7 bits. If the D/U field is configured to be 0, a most significant bit (MSB) of the TCI state ID field may be considered as a reserved bit, and the remaining 6 bits may be used to represent the higher layer signaling UL-TCIState-Id. The number of maximally activatable TCI states may be 8 in a case of joint TCI states, and may be 16 in a case of separate DL or UL TCI states.
R: R means a reserved bit and may be configured to be 0.

With respect to the MAC-CE structure of FIG. 6, a UE may include, in the MAC-CE structure, a third octet including P_1, P_2, . . . , and P_8 fields in FIG. 6 regardless of unifiedTCI-StateType-r17 in MIMOparam-r17 in the higher layer signaling ServingCellConfig being configured to be joint or separate. In this case, the UE may perform TCI state activation by using a fixed MAC-CE structure regardless of higher layer signaling configured by a base station. For example, with respect to the MAC-CE structure of FIG. 6, the UE may omit the third octet including P1, P2, . . . , and P8 fields in FIG. 6, in a case where unifiedTCI-StateType-r17 in MIMOparam-r17 in the higher layer signaling ServingCellConfig is configured to be joint. In this case, the UE may save the payload of the MAC-CE by a maximum of 8 bits according to higher layer signaling configured by the base station. In addition, the UE may consider or determine that all D/U fields positioned on the first bits in octets starting from a fourth octet in FIG. 6 are R fields, and all the R fields may be configured as 0 bits.

### [CSI Resource Configuration]

In NR, the base station may have a channel state information (CSI) framework for indicating a UE's CSI measurement and reporting. The NR's CSI framework may be configured by at least two elements including a resource setting and a report setting, and the report setting may refer to at least one ID of the resource setting, thereby having a mutually connected relationship.

According to an embodiment of the disclosure, the resource setting may include information related to a reference signal (RS) for a UE to measure channel state information. The base station may configure at least one resource setting for the UE. For example, the base station and the UE may exchange signaling information as in Table 4 in order to transfer information regarding the resource setting. Obviously, the examples given below are not limiting.

```
TABLE 4
-- ASN1START
-- TAG-CSI-RESOURCECONFIG-START
CSI-ResourceConfig ::= SEQUENCE {
  csi-ResourceConfigId CSI-ResourceConfigId,
  csi-RS-ResourceSetList CHOICE {
    nzp-CSI-RS-SSB SEQUENCE {
      nzp-CSI-RS-ResourceSetList SEQUENCE (SIZE (1..maxNrofNZP-CSI-
RS-ResourceSetsPerConfig)) OF NZP-CSI-RS-ResourceSetId
```

OPTIONAL,

-- Need R
csi-SSB-ResourceSetList SEQUENCE (SIZE (1..maxNrofCSI-SSB-
ResourceSetsPerConfig)) OF CSI-SSB-ResourceSetId

OPTIONAL

```
-- Need R
    },
    csi-IM-ResourceSetList SEQUENCE (SIZE (1..maxNrofCSI-IM-
ResourceSetsPerConfig)) OF CSI-IM-ResourceSetId
  },
  bwp-Id BWP-Id,
  resourceType ENUMERATED { aperiodic, semiPersistent, periodic },
  ...
}
-- TAG-CSI-RESOURCECONFIG-STOP
-- ASN1STOP
```

In Table 4, signal information CSI-ResourceConfig may include information regarding each resource setting. According to the signaling information in Table 4, each resource setting may include a resource setting index (csi-ResourceConfigld), a BWP index (bwp-ID), a time domain transmission configuration (resourceType) of a resource, or a resource set list (csi-RS-ResourceSetList) including at least one resource set. The time domain transmission configuration of a resource may be configured as at least one of aperiodic transmission, semi-persistent transmission, or periodic transmission. A resource set list may be a set including resource sets for channel measurement or a set including resource sets for interference measurement. In case that the resource set list is a set including resource sets for channel measurement, each resource set may include at least one resource, and the at least one resource may be an index of a CSI reference signal (CSI-RS) resource or a synchronization/broadcast channel block (SS/PBCH block (SSB)). In case that the resource set list is a set including resource sets for interference measurement, each resource set may include at least one CSI interference measurement (CSI-IM) resource.

For example, in case that a resource set includes a CSI-RS, the base station and the UE may exchange signaling information as in Table 5 to transfer information regarding the resource set. Obviously, the following example is not limiting.

TABLE 5
-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

OPTIONAL, -- Need R
...
}
-- TAG-NZP-CSI-RS-RESOURCESET-STOP
-- ASN1STOP

In Table 5, signaling information NZP-CSI-RS-ResourceSet may include information regarding each resource set. According to the signaling information, each resource set may include at least information regarding a resource set index (nzp-CSI-ResourceSetId) or an index set (nzp-CSI-RS-Resources) of the CSI-RS included therein. In addition, each resource set may include a part of information (repetition) regarding the spatial domain transmission filter of the CSI-RS resource included therein, or whether the CSI-RS resource included therein is used for tracking (trs-Info).

The CSI-RS may be the most representative reference signal included in a resource set. The base station and the UE may exchange signaling information as in Table 6 in order to transfer information regarding a CSI-RS resource. Obviously, the following example is not limiting.

TABLE 6

| -- ASN1START | | |
|---|---|---|
| -- TAG-NZP-CSI-RS-RESOURCE-START | | |
| NZP-CSI-RS-Resource ::= | SEQUENCE { | |
| nzp-CSI-RS-ResourceId | NZP-CSI-RS-ResourceId, | |
| resourceMapping | CSI-RS-ResourceMapping, | |
| powerControlOffset | INTEGER (−8..15), | |
| powerControlOffsetSS | ENUMERATED{db−3, db0, db3, db6} | |
| OPTIONAL, -- Need R | | |
| scramblingID | ScramblingId, | |
| periodicityAndOffset | CSI-ResourcePeriodicityAndOffset | |
| OPTIONAL, -- Cond PeriodicOrSemiPersistent | | |
| qcl-InfoPeriodicCSI-RS | TCI-StateId | OPTIONAL, |

-- Cond Periodic
...
}
-- TAG-NZP-CSI-RS-RESOURCE-STOP
-- ASN1STOP

In Table 6, signaling information NZP-CSI-RS-Resource may include information regarding each CSI-RS. The information included in the signaling information NZP-CSI-RS-Resource may have the following meanings. Obviously, the examples below are not limiting.
nzp-CSI-RS-Resourceld: CSI-RS resource index
resourceMapping: resource mapping information of a CSI-RS resource
powerControlOffset: the ratio between PDSCH energy per RE (EPRE) and CSI-RS EPRE
powerControlOffsetSS: the ratio between SS/PBCH block EPRE and CSI-RS EPRE
scramblingID: the scrambling index of a CSI-RS sequence
periodicityAndOffset: the transmission periodicity and slot offset of a CSI-RS resource
qcl-InfoPeriodicCSI-RS: TCI-state information in case that the CSI-RS is a periodic CSI-RS

The resourceMapping included in signaling information NZP-CSI-RS-Resource may indicate resource mapping information of a CSI-RS resource, and may include at least one of a frequency resource's resource element (RE) mapping, the number of ports, symbol mapping, CDM type, frequency resource density, or frequency band mapping information. The number of ports configurable through resourceMapping, the frequency resource density, the CDM type, and the time-frequency domain RE mapping may have a value determined by one of the rows in Table 7 below. Obviously, the following example is not limiting.

TABLE 7

| | Ports | Density | | | CDM group | | |
|---|---|---|---|---|---|---|---|
| Row | X | ρ | cdm-Type | (k̅, l̅) | index ^{j} | k′ | l′ |
| 1 | 1 | 3 | No | (k₀, l₀), (k₀ + 4, l₀), (k₀ + 8, l₀) | 0, 0, 0 | 0 | 0 |
| | | | CDM | | | | |
| 2 | 1 | 1, 0.5 | No | (k₀, l₀) | 0 | 0 | 0 |
| | | | CDM | | | | |
| 3 | 2 | 1, 0.5 | FD- | (k₀, l₀) | 0 | 0, 1 | 0 |
| | | | CDM2 | | | | |
| 4 | 4 | 1 | FD- | (k₀, l₀), (k₀ + 2, l₀) | 0, 1 | 0, 1 | 0 |
| | | | CDM2 | | | | |
| 5 | 4 | 1 | FD- | (k₀, l₀), (k₀, l₀ + 1) | 0, 1 | 0, 1 | 0 |
| | | | CDM2 | | | | |
| 6 | 8 | 1 | FD- | (k₀, l₀), (k₁, l₀), (k₂, l₀), (k₃, l₀) | 0, 1, 2, 3 | 0, 1 | 0 |
| | | | CDM2 | | | | |
| 7 | 8 | 1 | FD- | (k₀, l₀), (k₁, l₀), (k₀, l₀ + 1), (k₁, l₀ + 1) | 0, 1, 2, 3 | 0, 1 | 0 |
| | | | CDM2 | | | | |
| 8 | 8 | 1 | CDM4 | (k₀, l₀), (k₁, l₀) | 0, 1 | 0, 1 | 0, 1 |
| | | | (FD2, TD2) | | | | |
| 9 | 12 | 1 | FD- | (k₀, l₀), (k₁, l₀), (k₂, l₀), (k₃, l₀), (k₄, l₀) [symbol] | 0, 1, 2, 3, 4, 5 | 0, 1 | 0 |
| | | | CDM2 | | | | |
| 10 | 12 | 1 | CDM4 | (k₀, l₀), (k₁, l₀), (k₂, l₀) | 0, 1, 2 | 0, 1 | 0, 1 |
| | | | (FD2, TD2) | | | | |
| 11 | 16 | 1, 0.5 | FD- | (k₀, l₀), (k₁, l₀), (k₂, l₀), (k₃, l₀) | 0, 1, 2, 3, | 0, 1 | 0 |
| | | | CDM2 | (k₀, l₀ + 1) (k₁, l₀ + 1), (k₂, l₀ + 1), (k₃, l [symbol] | 4, 5, 6, 7 | | |
| 12 | 16 | 1, 0.5 | CDM4 | (k₀, l₀), (k₁, l₀), (k₂, l₀), (k₃, l₀) | 0, 1, 2, 3 | 0, 1 | 0, 1 |
| | | | (FD2, TD2) | | | | |
| 13 | 24 | 1, 0.5 | FD- | (k₀, l₀), (k₁, l₀), (k₂, l₀), (k₀, l₀ + 1), (k₁, [symbol] | 0, 1, 2, 3, 4, 5, | 0, 1 | 0 |
| | | | CDM2 | (k₀, l₁), (k₁, l₁), (k₂, l₁), (k₀, l₁+ 1), (k₁, l₁ [symbol] | 6, 7, 8, 9, 10, 11 | | |
| 14 | 24 | 1, 0.5 | CDM4 | (k₀, l₀), (k₁, l₀), (k₂, l₀), (k₀, l₁), (k₁, l₁), [symbol] | 0, 1, 2, 3, 4, 5 | 0, 1 | 0, 1 |
| | | | (FD2, TD2) | | | | |
| 15 | 24 | 1, 0.5 | CDM8 | (k₀, l₀), (k₁, l₀), (k₂, l₀) | 0, 1, 2 | 0, 1 | 0, 1, |
| | | | (FD2, TD4) | | | | 2, 3 |
| 16 | 32 | 1, 0.5 | FD- | (k₀, l₀), (k₁, l₀), (k₂, l₀), (k₃, l₀) | 0, 1, 2, 3, | 0, 1 | 0 |
| | | | CDM2 | (k₀, l₀ + 1), (k₁, l₀ +1), (k₂, l₀ + 1), (k₃, l [symbol] | 4, 5, 6, 7, | | |
| | | | | (k₀, l₁), (k₁, l₁), (k₂, l₀), (k₃, l₁), | 8, 9, 10, 11, | | |
| | | | | (k₀, l₁ + 1), (k₁, l₁ + 1), (k₂, l₁ + 1), (k₃, l₁ [symbol] | 12, 13, 14, 15 | | |
| 17 | 32 | 1, 0.5 | CDM4 | (k₀, l₀),(k₁, l₀), (k₂, l₀), (k₃, l₀), (k₀, l₁) [symbol] | 0, 1, 2, 3, 4, 5, 6, | 0, 1 | 0, 1 |
| | | | (FD2, TD2) | | 7 | | |
| 18 | 32 | 1, 0.5 | CDM8 | (k₀, l₀), (k₁, l₀), (k₂, l₀), (k₃, l₀) | 0, 1, 2, 3 | 0, 1 | 0, 1, |
| | | | (FD2, TD4) | | | | 2, 3 |

[symbol]

indicates data missing or illegible when filed

Table 7 include a frequency resource density configurable according to the number X of CSI-RS ports, a CDM type, the frequency-axis and time-axis starting positions of a CSI-RS component RE pattern, and the frequency-axis RE number k′ and time-axis RE number l′ of the CSI-RS component RE pattern. The CSI-RS component RE pattern described above may be a basic unit that constitutes a CSI-RS resource. Through Y=l+max(k′) REs in the frequency domain and Z=l+max(l′) REs in the time domain, the CSI-RS component RE pattern may be configured by as many REs as YZ. In case that the number of CSI-RS ports is one, the CSI-RS RE position may be specified without no limitation on subcarriers inside a physical resource block (PRB), and the CSI-RS RE position may be specified by a 12-bit bitmap. In case that the number of CSI-RS ports is {2, 4, 8, 12, 16, 24, 32} and Y=2, the CSI-RS RE position may be specified for every two subcarriers in the PRB, and the CSI-RS RE position may be specified by a 6-bit bitmap. In case that the number of CSI-RS ports is 4 and Y=4, the CSI-RS RE position may be designated for every four subcarriers within the PRB, and the CSI-RS RE position may be designated by a 3-bit bitmap. Similarly, the time-axis RE position may be designated by a bitmap including a total of 14 bits.

### [CSI Report Configuration]

According to an embodiment of the disclosure, a report setting may refer to one or more ID of resource setting, thereby having a mutually connected relationship. The resource setting(s) having a connection relation with the report setting may provide configuration information including information on a reference signal for channel information measurement. In case that the resource setting (s) having a connection relation with the report setting are used for channel information measurement, the measured channel information may be used for channel information reporting according to the reporting method configured in the report setting having the connection relation.

According to an embodiment of the disclosure, the report setting may include configuration information related to a CSI reporting method. For example, the base station and the UE may exchange signaling information such as Table 8 in order to transfer information regarding the report setting. Obviously, the following example is not limiting.

TABLE 8
-- ASN1START
-- TAG-CSI-REPORTCONFIG-START

| CSI-ReportConfig ::= | SEQUENCE { | |
|---|---|---|
| reportConfigId | CSI-ReportConfigId, | |
| carrier | ServCellIndex | OPTIONAL, -- Need S |

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUSCH | SEQUENCE { |
| reportSlotConfig | ENUMERATED {sl5, sl10, sl20, sl40, sl80, |

sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL- |

```
Allocations)) OF INTEGER(0..32)
    }
  },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, |
| subbandCQI } | OPTIONAL, -- Need R |
| pmi-FormatIndicator | ENUMERATED { widebandPMI, |
| subbandPMI } | OPTIONAL, -- Need R |
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| | |
|---|---|
| } | OPTIONAL, |

-- Need R

| | |
|---|---|
| timeRestrictionForChannelMeasurements | ENUMERATED {configured, |

notConfigured},

| | |
|---|---|
| timeRestrictionForInterferenceMeasurements | ENUMERATED {configured, |

notConfigured},

| | |
|---|---|
| codebookConfig | CodebookConfig |

OPTIONAL, -- Need R

| | |
|---|---|
| dummy | ENUMERATED {n1, n2} |

OPTIONAL, -- Need R

| | |
|---|---|
| groupBasedBeamReporting | CHOICE { |
| enabled | NULL, |
| disabled | SEQUENCE { |
| nrofReportedRS | ENUMERATED {n1, n2, n3, n4} |

```
OPTIONAL -- Need S
    }
  },
```

| | |
|---|---|
| cqi-Table | ENUMERATED {table1, table2, table3, spare1} |

OPTIONAL, -- Need R

| | |
|---|---|
| subbandSize | ENUMERATED {value1, value2}, |
| non-PMI-PortIndication | SEQUENCE (SIZE (1..maxNrofNZP-CSI-RS- |

```
ResourcesPerConfig)) OF PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {sl4, sl8, sl16} |

| | |
|---|---|
| } | OPTIONAL |

-- Need R
]]
}

In Table 8, signal information CSI-ReportConfig may include information regarding each report setting. The information included in the signaling information CSI-ReportConfig may have the following meaning. Obviously, the example given below is not limiting.
reportConfigId: a report setting index
carrier: a serving cell index
resourcesForChannelMeasurement: a resource setting index for channel measurement having a connection relationship with the report setting
csi-IM-ResourcesForInterference: a resource setting index having a CSI-IM resource for interference measurement having a connection relationship with the report setting
nzp-CSI-RS-ResourcesForInterference: a resource setting index having a CSI-RS resource for interference measurement having a connection relationship with the report setting
reportConfigType: indicates channel reporting's time domain transmission configuration and transmission channel, and may have an aperiodic transmission or semi-persistent physical uplink control channel (PUCCH) transmission or semi-persistent PUSCH transmission or periodic transmission configuration
reportQuantity: indicates the type of channel information to be reported, and may have the type of channel information in case that no channel report is transmitted (“none”) and in case that a channel report is transmitted (“cri-RI-PMI-CQI”, “cri-RI-i1”, “cri-RI-i1-CQI”, “cri-RI-CQI”, “cri-RSRP”, “ssb-Index-RSRP”, “cri-RI-LI-PMI-CQI”). Elements included in the type of channel information refer to a channel quality indicator (CQI), a precoding matrix indicator (PMI), a CSI-RS resource indicator (CRI), an SS/PBCH block resource indicator (SSBRI), a layer indicator (LI), a rank indicator (RI), and/or reference signal received power (L1-RSRP).
reportFreqConfiguration: indicates whether the reported channel information includes only information regarding the entire bandwidth (wideband) or includes information regarding each subband. In case of including information regarding each subband is included, the channel information may have configuration information regarding the included subband
timeRestrictionForChannelMeasurements: indicates whether there is a time domain restriction regarding a reference signal for channel measurement among reference signals to which the reported channel information refers
timeRestrictionForInterferenceMeasurements: indicates whether there is a time domain restriction regarding a reference signal for interference measurement among reference signals to which the reported channel information refers
codebookConfig: codebook information to which the reported channel information refers
groupBasedBeamReporting: indicates whether or not to beam-group the channel report
cqi-Table: a CQI table index to which the reported channel information refers
subbandSize: an index indicating the subband size of channel information
non-PMI-PortIndication: port mapping information to be referenced when reporting non-PMI channel information

In case that the base station indicates channel information reporting through upper layer signaling or L1 signaling, the UE may perform channel information reporting by referring to the above-described configuration information included in the indicated report setting.

The base station may instruct the UE to report channel state information (CSI) through upper layer signaling including radio resource control (RRC) signaling or medium access control (MAC) control element (CE) signaling, or L1 signaling (for example, common DCI, group-common DCI, or UE-specific DCI).

For example, the base station may indicate aperiodic channel information reporting (CSI report) to the UE through upper layer signaling or DCI using DCI format 0_1. The base station may configure a parameter for an aperiodic CSI report of the UE, or multiple CSI report trigger states including a parameter for a CSI report, through upper layer signaling. The parameter for a CSI report or the CSI report trigger states may include at least one of a slot interval between a PDCCH including DCI and a PUSCH including a CSI report, a set including possible slot intervals, a reference signal ID for channel state measurement, or the type of channel information included therein. If the base station indicates some of the multiple CSI report trigger states to the UE through DCI, the UE may report channel information according to the CSI report configuration of the report setting configured for the indicated CSI report trigger states. Channel information reporting may be performed through a PUSCH scheduled by DCI format 0_1. Time domain resource allocation of a PUSCH including the UE's CSI report may be performed by indicating at least one of the slot interval from the PDCCH indicated through DCI, or the starting symbol within the slot for time domain resource allocation of the PUSCH, and the symbol length. For example, the position of a slot in which a PUSCH including the UE's CSI report is transmitted may be indicated through the slot interval from the PDCCH indicated through DCI, and the starting symbol within the slot and the symbol length may be indicated through the above-described DCI's time domain resource assignment field.

For example, the base station may indicate a semi-persistent CSI report transmitted through a PUSCH to the UE through DCI using DCI format 0_1. The base station may activate or deactivate a semi-persistent CSI report transmitted through a PUSCH through DCI scrambled by an SP-CSI-RNTI. If a semi-persistent CSI report is activated, the UE may periodically report channel information according to the configured slot interval. If the semi-persistent CSI report is deactivated, the UE may stop the periodic channel information report that has been activated. The base station may configure, through upper layer signaling, a parameter for the UE's semi-persistent CSI report, or multiple CSI report trigger states including the parameter for the semi-persistent CSI report. The parameter for a CSI report or the CSI report trigger states may include at least one of a set including the slot interval between a PDCCH including DCI indicating a CSI report and a PUSCH including the CSI report or possible slot intervals, the slot interval between a slot in which upper layer signaling indicating the CSI report is activated and the PUSCH including the CSI report, the slot interval periodicity of the CSI report, or the type of channel information included therein. If the base station activates, for the UE, some of multiple CSI report trigger states or some of multiple report settings through upper layer signaling or DCI, the UE may report channel information according to the CSI report configuration configured in the report setting included in the indicated CSI report trigger state or the activated report setting. Channel information reporting may be performed through a PUSCH semi-persistently scheduled by DCI format 0_1 scrambled by an SP-CSI-RNTI. Time domain resource allocation of a PUSCH including the UE's CSI report may be performed by indicating at least one of the slot interval periodicity of the CSI report, the slot interval from the slot in which the upper layer signaling is activated, or the slot interval from the PDCCH indicated through DCI, or the starting symbol within the slot for time domain resource allocation of the PUSCH, and the symbol length. For example, the position of a slot in which a PUSCH including the UE's CSI report is transmitted may be indicated through the slot interval from the PDCCH indicated through DCI. The starting symbol within the slot and the symbol length may be indicated through the time domain resource assignment field of DCI format 0_1 described above.

For example, the base station may indicate, to the UE, a semi-persistent CSI report transmitted through a PUCCH through upper layer signaling, such as a MAC-CE. The base station may activate or deactivate a semi-persistent CSI report transmitted through the PUCCH through MAC-CE signaling. If a semi-persistent CSI report is activated, the UE may periodically report channel information according to the configured slot interval. If the semi-persistent CSI report is deactivated, the UE may stop the periodic channel information reporting which has been activated. The base station may configure parameters for the UE's semi-persistent CSI report through upper layer signaling. Parameters for the CSI report may include at least one of a PUCCH resource in which the CSI report is transmitted, the slot interval periodicity of the CSI report, or the type of channel information included therein. The UE may transmit a CSI report through a PUCCH. Alternatively, in case that a PUCCH for a CSI report overlaps a PUSCH, the UE may transmit the CSI report through the PUSCH. The position of the PUCCH transmission slot including a CSI report may be indicated through the slot interval periodicity of the CSI report configured through upper layer signaling, and/or the slot interval between the slot in which upper layer signaling is activated and the PUCCH including the CSI report. The starting symbol inside the slot and the symbol length may be indicated through the starting symbol to which a PUCCH resource configured through upper layer signaling is assigned, and the symbol length.

For example, the base station may indicate a periodic CSI report to the UE through upper layer signaling. The base station may activate or deactivate a periodic CSI report through upper layer signaling including RRC signaling. If a periodic CSI report is activated, the UE may periodically report channel information according to the configured slot interval. If the periodic CSI report is deactivated, the UE may stop the periodic channel information reporting that has been activated. The base station may configure a report setting including parameters for the UE's periodic CSI report through upper layer signaling. The parameters for the CSI report may include at least one of a PUCCH resource configuration for the CSI report, the slot interval between a slot in which upper layer signaling indicating the CSI report is activated and a PUCCH including the CSI report, a slot interval periodicity of the CSI report, a reference signal ID for channel state measurement, and the type of channel information included therein. The UE may transmit the CSI report through a PUCCH. Alternatively, in case that the PUCCH for the CSI report overlaps with the PUSCH, the UE may transmit the CSI report through the PUSCH. The position of a slot in which a PUCCH including a CSI report is transmitted may be indicated through the slot interval periodicity of the CSI report configured through upper layer signaling, and/or the slot interval between the slot in which upper layer signaling is activated and the PUCCH including the CSI report. The starting symbol within the slot and the symbol length may be indicated through the starting symbol to which a PUCCH resource configured through upper layer signaling is assigned, and the symbol length.

With regard to the aforementioned CSI report configurations (CSI-ReportConfig), each report configuration CSI-ReportConfig may be associated with one downlink (DL) bandwidth part identified by a higher-layer parameter bandwidth part identifier (bwp-id) given by the CSI resource configuration CSI-ResourceConfig associated with the corresponding report configuration. As a time domain reporting operation for each report configuration CSI-ReportConfig, “aperiodic”, “semi-persistent”, and “periodic” schemes may be supported, and these schemes may be configured for the UE by the base station via a reportConfigType parameter configured from a higher layer. A semi-persistent CSI report method may support a “PUCCH-based semi-persistent (semi-PersistentOnPUCCH)” method and a “PUSCH-based semi-persistent (semi-PersistentOnPUSCH)” method. In the case of the periodic or semi-persistent CSI report method, a PUCCH or PUSCH resource in which CSI is to be transmitted may be configured for the UE by the base station via higher-layer signaling. A periodicity and a slot offset of the PUCCH or PUSCH resource in which CSI is to be transmitted may be given by a numerology of an uplink (UL) bandwidth part configured for CSI report transmission. In the case of the aperiodic CSI report method, a PUSCH resource in which CSI is to be transmitted may be scheduled for the UE by the base station via L1 signaling (aforementioned DCI format 01).

With regard to the aforementioned CSI resource configurations (CSI-ResourceConfig), each CSI resource configuration CSI-ReportConfig may include S(>1) CSI resource sets (e.g., given via a higher-layer parameter of csi-RS-ResourceSetList). A CSI resource set list may include a non-zero power (NZP) CSI-RS resource set and an SS/PBCH block set or may include a CSI-interference measurement (CSI-IM) resource set. Each CSI resource setting may be positioned in a downlink (DL) bandwidth part identified by higher-layer parameter bwp-id and may be connected to CSI report setting in the same downlink bandwidth part. A time domain operation of a CSI-RS resource in the CSI resource configuration may be configured to be one of “aperiodic”, “periodic”, or “semi-persistent” from the higher-layer parameter resourceType. With regard to the periodic or semi-persistent CSI resource configuration, the number of CSI-RS resource sets may be limited to S=1, and the configured periodicity and slot offset may be given based on a numerology of the downlink bandwidth part identified by bwp-id. One or more CSI resource configurations for channel or interference measurement may be configured for the UE by the base station via higher-layer signaling. For example, the CSI resource configurations configured by the base station may include the following CSI resources.
CSI-IM resource for interference measurement
NZP CSI-RS resource for interference measurement
NZP CSI-RS resource for channel measurement

With regard to CSI-RS resource sets associated with a resource configuration in which the higher-layer parameter of resourceType is configured to be “aperiodic”, “periodic”, or “semi-persistent”, a trigger state of CSI report configuration having reportType configured to be “aperiodic”, and a resource configuration for channel or interference measurement on one or multiple component cells (CCs) may be configured via the higher-layer parameter of CSI-AperiodicTriggerStateList.

The aperiodic CSI report of the UE may use a PUSCH. The periodic CSI report of the UE may use a PUCCH. The semi-persistent CSI report of the UE may use a PUSCH if triggered or activated by DCI, and may use a PUCCH after activated by an MAC control element (MAC CE). As described above, CSI resource configurations may also be configured to be aperiodic, periodic, or semi-persistent. A combination of CSI reporting configurations and CSI resource configurations may be supported based on Table 9 below. Obviously, the examples given below are not limiting.

TABLE 9
Triggering/Activation of CSI Reporting
for the possible CSI-RS Configurations

| CSI-RS | Periodic CSI | Semi-Persistent | Aperiodic CSI |
|---|---|---|---|
| Configuration | Reporting | CSI Reporting | Reporting |
| Periodic | No dynamic | For reporting on | Triggered by |
| CSI-RS | triggering/ | PUCCH, the UE | DCI; |
| | activation | receives an | additionally, |
| | | activation | activation |
| | | command [10, | command [10, |
| | | TS 38.3211; for | TS 38.321] |
| | | reporting on | possible as |
| | | PUSCH, the UE | defined in |
| | | receives | Subclause |
| | | triggering on | 5.2.1.5.1. |
| | | DCI | |
| Semi- | Not Supported | For reporting on | Triggered by |
| Persistent | | PUCCH, the UE | DCI; |
| CSI-RS | | receives an | additionally, |
| | | activation | activation |
| | | command [10, | command [10, |
| | | TS 38.321]; for | TS 38.321] |
| | | reporting on | possible as |
| | | PUSCH, the UE | defined in |
| | | receives | Subclause |
| | | triggering on | 5.2.1.5.1. |
| | | DCI | |
| Aperiodic | Not Supported | Not Supported | Triggered by |
| CSI-RS | | | DCI; |
| | | | additionally, |
| | | | activation |
| | | | command [10, |
| | | | TS 38.321] |
| | | | possible as |
| | | | defined in |
| | | | Subclause |
| | | | 5.2.1.5.1. |

The aperiodic CSI report may be triggered by a “CSU request” field in DCI format 0_1 which corresponds to scheduling DCI for a PUSCH. The UE may monitor a PDCCH, may acquire DCI format 0_1, and may acquire scheduling information of a PUSCH and a CSI request indicator. The CSI request indicator may be configured to have NTS(=0, 1, 2, 3, 4, 5, or 6) bits, and may be determined by higher-layer signaling (reportTriggerSize). One trigger state among one or multiple aperiodic CSI report trigger states which may be configured via higher-layer signaling (CSI-AperiodicTriggerStateList) may be triggered by the CSI request indicator. Obviously, the examples given below are not limiting.
If all bits in the CSI request field are 0, the CSI request field may indicate that CSI reporting is not requested.
   If the number M of configured CSI trigger states in CSI-AperiodicTriggerStateList is greater than 2NTs−1, M CSI trigger states may be mapped to 2NTs−1 trigger states according to a predefined mapping relation, and one trigger state among the 2NTs−1 trigger states may be indicated by the CSI request field.
   If the number M of configured CSI trigger states in CSI-AperiodicTriggerStateLite is less than or equal to 2NTs−1, one of the M CSI trigger states may be indicated by the CSI request field.

Table 10 below shows an example of a relationship between a CSI request indicator and a CSI trigger state that may be indicated by a corresponding indicator. Obviously, the examples given below are not limiting.

TABLE 10

| CSI request | CSI trigger | CSI- | CSI- |
|---|---|---|---|
| field | state | ReportConfigId | ResourceConfigId |
| 00 | no CSI request | N/A | N/A |
| 01 | CSI trigger | CSI report#1 | CSI resource#1, |
| | state#1 | CSI report#2 | CSI resource#2 |
| 10 | CSI trigger | CSI report#3 | CSI resource#3 |
| | state#2 | | |
| 11 | CSI trigger | CSI report#4 | CSI resource#4 |
| | state#3 | | |

The UE may measure a CSI resource in a CSI trigger state triggered via the CSI request field, and then generate CSI (including, for example, at least one of the CQI, PMI, CRI, SSBRI, LI, RI, or L1-RSRP described above) from the measurement result. The UE may transmit the acquired CSI by using the PUSCH scheduled via DCI format 0_1. If one bit corresponding to an uplink data indicator (UL-SCH indicator) in DCI format 0_1 indicates “1”, the UE may multiplex uplink data (UL-SCH) and the acquired CSI on the PUSCH resource scheduled by DCI format 0_1 and then transmit the same. If one bit corresponding to the uplink data indicator (UL-SCH indicator) in DCI format 0_1 indicates “0”, the UE may map only CSI, without uplink data (UL-SCH), to the PUSCH resource scheduled by DCI format 0_1 and then transmit the same.

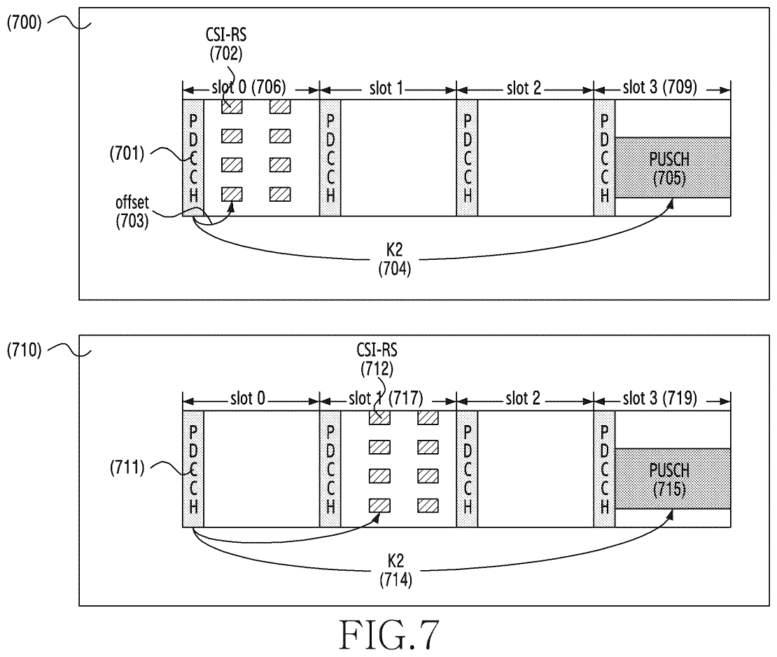

FIG. 7 illustrates an example of an aperiodic CSI reporting method according to an embodiment of the disclosure.

In an example 700 of FIG. 7, a UE may acquire DCI format 01 by monitoring a PDCCH 701, and may acquire scheduling information and CSI request information for a PUSCH 705 from DCI format 0_1. The UE may acquire, from a received CSI request indicator, resource information of a CSI-RS 712 to be measured, The UE may determine at which time point the UE needs to measure a transmitted CSI-RS resource 702, based on a time point at which DCI format 0_1 is received, and a parameter for an offset (e.g., aperiodicTriggeringOffset) in a CSI resource set configuration (e.g., an NZP CSI-RS resource set configuration (NZP-CSI-RS-ResourceSet)). More specifically, the UE may be configured with an offset value X of the parameter, aperiodicTriggeringOffset, in the NZP-CSI-RS resource set configuration from a base station via higher-layer signaling, and the configured offset value X may refer to an offset between a slot in which DCI triggering aperiodic CSI reporting is received, and a slot in which the CSI-RS resource is transmitted. For example, aperiodicTriggeringOffset parameter values and offset values X may have mapping relationships as given in Table 11 below. Obviously, the examples given below are not limiting.

TABLE 11

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

The example 700 of FIG. 7 shows an example in which aforementioned offset value X is configured to be 0 (X=0). In this case, the UE may receive the CSI-RS 702 in a slot (corresponding to slot 0 706 of FIG. 7) in which DCI format 0_1 triggering aperiodic CSI reporting is received. Also, the UE may report CSI information, which is measured based on the received CSI-RS, to the base station via the PUSCH 705. The UE may acquire, from DCI format 0_1, scheduling information (information corresponding to each field of DCI format 0_1 described above) on the PUSCH 705 for CSI reporting. For example, in DCI format 0_1, the UE may acquire information on a slot in which the PUSCH 705 is to be transmitted, from time domain resource allocation information for the PUSCH 705 described above. In the example 700 of FIG. 7, the UE acquires 3 as a K2 value 704 corresponding to a slot offset value for PDCCH-to-PUSCH, and accordingly, the PUSCH 705 may be transmitted in slot 3 709, which is spaced 3 slots apart from slot 0 706, i.e., a time point at which the PDCCH 701 has been received.

In an example 710 of FIG. 7, the UE may acquire DCI format 01 by monitoring a PDCCH 711, and may acquire scheduling information and CSI request information for a PUSCH 715 from DCI format 0_1. The UE may acquire, from a received CSI request indicator, resource information of a CSI-RS 712 to be measured, The example 710 of FIG. 7 shows an example in which the offset value X for CSI-RS described above is configured to be 1 (X=1). In this case, the UE may receive the CSI-RS 712 in slot 0 717. In the example 710 of FIG. 7, the UE acquires 3 as a K2 value 714 corresponding to a slot offset value for PDCCH-to-PUSCH, and CSI information measured via the received CSI-RS may be reported to the base station in slot 3 719 through the PUSCH 715.

The aperiodic CSI report may include at least one of or both CSI part 1 and CSI part 2, and when the aperiodic CSI report is transmitted via the PUSCH, the aperiodic CSI report may be multiplexed on a transport block. After a CRC is inserted into an input bit of aperiodic CSI for multiplexing, encoding and rate matching may be performed, and then transmission may be performed by mapping to resource elements within the PUSCH in a specific pattern. The CRC insertion may be omitted depending on a coding method or a length of the input bit. The number of modulation symbols, which is calculated for rate matching during multiplexing of CSI part 1 or CSI part 2 included in the aperiodic CSI report, may be calculated as given in Table 12 below. Obviously, the examples given below are not limiting.

TABLE 12
For CSI part 1 transmission on PUSCH not using repetition type B with UL-
SCH, the number of coded modulation symbols per layer for CSI part 1
$transmission , denoted as {Q}_{CSI - part 1}^{′} , is determined as follows :$
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$
. . .
For CSI part 1 transmission on an actual repetition of a PUSCH with
repetition Type B with UL-SCH, the number of coded modulation symbols
$per layer for CSI part 1 transmission , denoted as {Q}_{CSI - part 1}^{′} , is determined as$
follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} , {\sum }_{l = 0}^{{N}_{symb , actual}^{PUSCH} - 1} {M}_{sc , actual}^{UCI} ( l ) - {Q}_{ACK / CG - UCI}^{′} \}$
. . .
For CSI part 1 transmission on PUSCH without UL-SCH, the number of
coded modulation symbols per layer for CSI part 1 transmission, denoted as
${Q}_{CSI - part 1}^{′} , is determined as follows :$
if there is CSI part 2 to be transmitted on the PUSCH,
${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$
else
${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
end if
. . .
For CSI part 2 transmission on PUSCH not using repetition type B with UL-
SCH, the number of coded modulation symbols per layer for CSI part 2
$transmission , denoted as {Q}_{CSI - part 2}^{′} , is determined as follows :$
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$
For CSI part 2 transmission on an actual repetition of a PUSCH with
repetition Type B with UL-SCH, the number of coded modulation symbols
$per layer for CSI part 2 transmission , denoted as {Q}_{CSI - part 2}^{′} , is determined as$
follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} , {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$
. . .
For CSI part 2 transmission on PUSCH without UL-SCH, the number of
coded modulation symbols per layer for CSI part 2 transmission, denoted as
${Q}_{CSI - part 2}^{′} , is determined as follows :$
${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$

Specifically, for PUSCH repetition type A and B transmissions, the UE may multiplex the aperiodic CSI report only on the first repetition transmission among repetition PUSCH transmissions, so as to transmit the same. In the above-described transmission method, information on the multiplexed aperiodic CSI report may be encoded by a polar code scheme, and in this case, in order to be multiplexed on multiple PUSCH repetitions, each PUSCH repetition may need to have the same frequency and time resource allocation. In particular, for PUSCH repetition type B, each actual repetition may have a different OFDM symbol length, so that the aperiodic CSI report may be multiplexed only in the first PUS CH repetition so as to be transmitted.

In addition, for PUSCH repetition type B transmission, if the UE receives DCI for activation of semi-persistent CSI reporting or scheduling of aperiodic CSI reporting without scheduling for a transport block, the UE may assume that a value of nominal repetition is 1 even if the number of PUSCH repetition transmissions, which is configured via higher-layer signaling, is greater than 1. In addition, if the aperiodic or semi-persistent CSI reporting is scheduled or activated without scheduling for a transport block, based on PUSCH repetition type B transmission, the UE may expect that a first nominal repetition is identical to the first actual repetition. With regard to the PUSCH transmitted while including semi-persistent CSI, based on repeated PUSCH transmission scheme B, without scheduling for DCI after the semi-persistent CSI reporting has been activated via the DCI, if the first nominal repetition is different from the first actual repetition, transmission for the first nominal repetition may be ignored.

### [CSI Computation Time]

In case that the base station indicates an aperiodic CSI report or a semi-persistent CSI report to the UE through DCI, it may be determined whether the UE is able to perform a valid channel report through the indicated CSI report in consideration of the channel computation time required for the CSI report. With regard to an aperiodic CSI report or a semi-persistent CSI report indicated through DCI, the UE may perform a valid CSI report, starting from an uplink symbol after Z symbols, after the last symbol including a PDCCH including DCI indicating the CSI report is ended. The Z symbols described above may vary according to the numerology of a downlink bandwidth part corresponding to a PDCCH including DCI indicating a CSI report, the numerology of an uplink bandwidth part corresponding to a PUSCH for transmitting the CSI report, and the type or characteristics (for example, report quantity, frequency band granularity, the number of ports of a reference signal, codebook type, etc.) of channel information reported in the CSI report. In other words, in order for a CSI report to be determined as a valid CSI report (e.g., for the CSI report to be a valid CSI report), the CSI report's uplink transmission should not be performed before the Zref symbol, including the timing advance. The Zref symbol is an uplink symbol that starts a cyclic prefix (CP) after time T_{proc,CSI}=(Z)(2048+144)·κ2^{-μ}·T_{C} from the moment at which the last symbol of the triggering PDCCH ends. The detailed value of Z follows the following description, T_{c}=1/(Δfₘₐₓ·N_{f}), Δfₘₐₓ=480·10³ Hz, N_{f}=4096, κ=64, and μ is numerology. In this regard, may be preconfigured to maximize the T_{proc,CSI} value among (μ_{PDCCH}, μ_{CSI-RS}, μ_{L}), μ_{PDCCH} may refer to a subcarrier spacing used for PDCCH transmission, μ_{CSI-RS} may refer to a subcarrier spacing used for CSI-RS transmission, and μ_{UL} may refer to the subcarrier spacing of an uplink channel used for uplink control information (UCI) transmission for CSI reporting. As another example, may be preconfigured to maximize the T_{proc,CSI} value among (μ_{PDCCH}, μ_{L}). The above description is referenced regarding definitions of μ_{PDCCH} and μ_{UL}. For convenience of subsequent description, it may be assumed that, if the above condition is satisfied, CSI reporting validity condition 1 is satisfied.

In addition, in case that a reference signal for channel measurement regarding aperiodic CSI report indicated to the UE through DCI is an aperiodic reference signal, the UE may perform a valid CSI report starting from the uplink symbol after Z′ symbols, after the last symbol including the reference signal is ended. The Z′ symbols may vary according to the numerology of the downlink bandwidth part corresponding to the PDCCH including DCI for indicating a CSI report, the numerology of the bandwidth corresponding to the reference signal for channel measurement regarding the CSI report, the numerology of the uplink bandwidth part corresponding to the PUSCH for transmitting the CSI report, or the type or characteristics (e.g., report quantity, frequency band granularity, the number of ports of the reference signal, or codebook type) of the channel information reported in the CSI report. In other words, in order for a CSI report to be determined as a valid CSI report (e.g., for the CSI report to be a valid CSI report), the CSI report's uplink transmission may not be supposed to be performed before the Zref symbol, including a timing advance. In this regard, the Zref′ symbol may be an uplink symbol that starts a cyclic prefix (CP) after time T′_{proc,CSI}=(Z′)(2048+144)·κ2^{-μ}·T_{C} from the moment the last symbol of the aperiodic CSI-RS or aperiodic CSI-IM triggered by the triggering PDCCH ends. The detailed value of Z′ follows the following description, T_{c}=1/(Δfₘₐₓ·N_{f}), Δfₘₐₓ=480·10³ Hz, N_{f}=4096, κ=64, and p may be numerology. In this regard, p may be preconfigured to maximize the T_{proc,CSI} value among (μ_{PDCCH}, μ_{CSI-RS}, μ_{UL}) μ_{PDCCH} may refer to a subcarrier spacing used for triggering PDCCH transmission, μ_{CSI-RS} may refer to a subcarrier spacing used for CSI-RS transmission, and μ_{UL} may refer to the subcarrier spacing of an uplink channel used for uplink control information (UCI) transmission for CSI reporting. As an example, may be preconfigured to maximize the T_{proc,CSI} value among (μ_{PDCCH}, μ_{L}). The above description is referenced regarding definitions of μ_{PDCCH} and μ_{UL}. For convenience of subsequent description, it may be assumed that, if the above condition is satisfied, CSI reporting validity condition 2 is satisfied.

In case that the base station indicates an aperiodic CSI report regarding an aperiodic reference signal to the UE through DCI, the UE may perform a valid CSI report starting from the first uplink symbol that satisfies both the timepoint after Z symbols after the last symbol included in the PDCCH including DCI indicating a CSI report is ended, and the timepoint after Z′ symbols after the last symbol including the reference signal is ended. For example, in case of aperiodic CSI reporting based on an aperiodic reference signal, CSI a CSI report may be deemed to be valid only if the same satisfies both CSI reporting validity conditions 1 and 2.

In case that the CSI report timepoint indicated by the base station does not satisfy the CSI computation time requirement, the UE may determine that the CSI report which does not satisfy the CSI computation time requirement is invalid, and may not consider updating the channel information state for the CSI report.

The Z and Z′ symbols for calculating the CSI computation time described above may follow Table 13 and Table 14 below. For example, in case that the channel information reported in the CSI report includes only wideband information, the number of ports of the reference signal is 4 or less, one reference signal resource is configured, and the codebook type is “typel-SinglePanel” or the type (report quantity) of the reported channel information is “cri-RI-CQI”, the Z and Z′ symbols may follow Z₁,

$${Z}_{1}^{′}$$

values in Table 14. The above-described condition may be referred to as delay requirement 2. In addition, in case that a PUSCH including a CSI report does not include a TB or HARQ-ACK, and the UE's CPU occupation is 0, Z and Z′ symbols may follow Z₁,

$${Z}_{1}^{′}$$

values in Table 13. The above condition may be referred to as delay requirement 1. The above description regarding the CPU occupation may be described in detail below. In addition, in case that the report quantity is “cri-RSRP” or “ssb-Index-RSRP”, Z and Z′ symbols may follow Z₃,

$${Z}_{3}^{′}$$

values in Table 14. In Table 14, X1, X2, X3, and X4 may refer to UE capability regarding a beam reporting time, and KB1 and KB2 in Table 14 may refer to UE capability regarding a beam change time. Z and Z′ symbols may follow Z₂,

$${Z}_{2}^{′}$$

values in Table 14 in case that the same do not corresponding to the type or characteristic of channel information reported in the CSI report described above. Obviously, the following example is not limiting.

TABLE 13

| | Z₁ [symbols] | |
|---|---|---|
| μ | Z₁ | ${Z}_{1}^{′}$ |
| 0 | 10 | 8 |
| 1 | 13 | 11 |
| 2 | 25 | 21 |
| 3 | 43 | 36 |

TABLE 14

| | Z₁ [symbols] | | Z₂ [symbols] | | Z₃ [symbols] | |
|---|---|---|---|---|---|---|
| μ | Z₁ | ${Z}_{1}^{′}$ | Z₂ | ${Z}_{2}^{′}$ | Z₃ | ${Z}_{3}^{′}$ |
| 0 | 22 | 16 | 40 | 37 | 22 | X₁ |
| 1 | 33 | 30 | 72 | 69 | 33 | X₂ |
| 2 | 44 | 42 | 141 | 140 | min(44, X₃ + KB₁) | X₃ |
| 3 | 97 | 85 | 152 | 140 | min(97, X₄ + KB₂) | X₄ |

### [CSI Reference Resource]

When indicating an aperiodic/semi-persistent/periodic CSI report to the UE, the base station may configure a CSI reference resource to determine the reference time and frequency regarding a channel to be reported in the CSI report. The frequency of the CSI reference resource may be carrier and subband information for measuring CSI, indicated in a CSI report configuration. The carrier and subband information for measuring CSI may correspond to carrier and reportFreqConfiguration in CSI-ReportConfig (upper layer signaling). The time of the CSI reference resource may be defined with reference to the time at which the CSI report is transmitted. For example, in case that CSI report #X is indicated to be transmitted in uplink slot n′ of the carrier and BWP in which the CSI report is to be transmitted, the time of the CSI reference resource of CSI report #X may be defined as a downlink slot n-nCSI-ref of the carrier and BWP in which CSI is measured. Downlink slot n may be calculated as n=└n′·2^{μ}^{_{DL}}/2^{μ}^{_{UL}}┘ assuming that the numerology of the carrier and BWP in which CSI is measured is referred to as μDL, and the numerology of the carrier and BWP in which CSI report #X is transmitted is referred to as μUL. In case that CSI report #X transmitted in uplink slot n′ is a semi-persistent or periodic CSI report, the slot interval (nCSI-ref) between downlink slot n and the CSI reference signal may follow n_{CSI-ref}=4·2^{μ}^{_{DL}} in case that a single CSI-RS/SSB resource is connected to the CSI report according to the number of CSI-RS/SSB resources for channel measurement, and may follow n_{CSI-ref}=5·2^{μ}^{_{DL}} in case that multiple CSI-RS/SSB resources are connected to the CSI report. In case that CSI report #X transmitted in uplink slot n′ is an aperiodic CSI report,

$${n}_{CSI - ref} = ⌊ {Z}^{′} / {N}_{s y m b}^{s l o t} ⌋$$

may be calculated in consideration of the CSI computation time Z′ for channel measurement. The above-described

$${N}_{s y m b}^{s l o t}$$

is the number of symbols included in one slot, and in NR,

$${N}_{s y m b}^{s l o t} = 14$$

may be assumed.

In case that the base station instructs the UE to transmit a specific CSI report in uplink slot n′ through upper layer signaling or DCI, the UE may report CSI by performing channel measurement or interference measurement with regard to CSI-RS resources, CSI-IM resources, or SSB resources transmitted not later than the CSI reference resource slot of the CSI report transmitted in uplink slot n′, among CSI-RS resources, CSI-IM resources, or SSB resources associated with the CSI report instructed to be transmitted by the base station. As used herein, CSI-RS resources, CSI-IM resources, or SSB resources associated with the CSI report instructed to be transmitted by the base station may be CSI-RS resources, CSI-IM resources, or SSB resources included in a resource set configured in a resource setting referenced by the report setting for the UE's CSI report configured through upper layer. Alternatively, CSI-RS resources, CSI-IM resources, or SSB resources associated with the CSI report instructed to be transmitted by the base station may refer to CSI-RS resources, CSI-IM resources, or SSB resources referenced by a CSI report trigger state including parameters for the CSI report, or CSI-RS resources, CSI-IM resources, or SSB resources indicated by the ID of the reference signal (RS) set.

In embodiments of the disclosure, a CSI-RS/CSI-IM/SSB occasion may refer to a transmission timepoint of CSI-RS/CSI-IM/SSB resource(s) determined by upper layer configurations or a combination of upper layer configurations and DCI triggering. For example, a semi-persistent or periodic CSI-RS resource may be configured such that the transmission slot is determined according to the slot periodicity and slot offset configured by upper layer signaling, and the transmission symbol(s) inside the slot may be determined according to resource mapping information (resourceMapping). For example, an aperiodic CSI-RS resource may be configured such that the transmission slot is determined according to the slot offset from a PDCCH including DCI indicating a channel report configured by upper layer signaling, and transmission symbol (s) in the slot may be determined according to resource mapping information (resourceMapping).

The CSI-RS occasion described above may be determined by considering the transmission timepoint of each CSI-RS resource independently, or by considering the transmission timepoint of one or more CSI-RS resources included in a resource set in a comprehensive manner. In accordance with the above-described consideration method, the following two interpretations may be possible with regard to a CSI-RS occasion based on each resource set configuration. Obviously, the following examples are not limiting.
Interpretation 1-1: from the starting timepoint of the earliest symbol used to transmit a specific resource among one or more CSI-RS resources included in resource set(s) configured in the resource setting referenced by the report setting configured for the CSI report, to the ending timepoint of the latest symbol
Interpretation 1-2: from the starting timepoint of the earliest symbol used to transmit a CSI-RS resource that is transmitted at the earliest timepoint among all CSI-RS resources included in resource set(s) configured in the resource setting referred to by the report setting configured for the CSI report, to the ending timepoint of the latest symbol used to transmit a CSI-RS resource that is transmitted at the latest timepoint

In the following embodiments of the disclosure, both interpretations regarding the CSI-RS occasion may be considered and applied individually. In addition, although it is possible to consider the two interpretations with regard to the CSI-IM occasion and SSB occasion, as in the CSI-RS occasion, the principle is similar to the above description, and repeated descriptions thereof will accordingly be omitted hereinafter.

In embodiments of the disclosure, a “CSI-RS/CSI-IM/SSB occasion for CSI report #X transmitted in uplink slot n” may refer to a set of at least one of a CSI-RS occasion, a CSI-IM occasion, or an SSB occasion which is not later than the CSI reference resource of CSI report #X transmitted in uplink slot n′ among CSI-RS occasions, CSI-IM occasions, and SSB occasions of CSI-RS resources, CSI-IM resources, and SSB resources included in a resource set configured in a resource setting referenced by a report setting configured for CSI report #X.

In embodiments of the disclosure, “the latest CSI-RS/CSI-IM/SSB occasion among CSI-RS/CSI-IM/SSB occasions for CSI report #X transmitted in uplink slot n” may be interpreted in two ways as follows. Obviously, the following examples are not limiting.
Interpretation 2-1: a set of occasions including the latest CSI-RS occasion among CSI-RS occasions for CSI report #X transmitted in uplink slot n′, the latest CSI-IM occasion among CSI-IM occasions for CSI report #X to be transmitted in uplink slot n′, and the latest SSB occasion among SSB occasions for CSI report #0 to be transmitted in uplink slot n′.
Interpretation 2-2: the latest occasion among all CSI-RS occasions, CSI-IM occasions, and SSB occasions for CSI report #X transmitted in uplink slot n′

In the following embodiments of the disclosure, two interpretations of the “latest CSI-RS/CSI-IM/SSB occasion among CSI-RS/CSI-IM/SSB occasions for CSI report #X transmitted in uplink slot n′” may be considered and applied separately. In addition, when the two interpretations (interpretation 1-1 and interpretation 1-2) described above regarding CSI-RS occasions, CSI-IM occasions, and SSB occasions are considered, the “latest CSI-RS/CSI-IM/SSB occasion among CSI-RS/CSI-IM/SSB occasions for CSI report #X transmitted in uplink slot n′” in the embodiments of the disclosure may be applied individually in consideration of all four different interpretations (e.g., applying interpretation 1-1 and interpretation 2-1, applying interpretation 1-1 and interpretation 2-2, applying interpretation 1-2 and interpretation 2-1, and applying interpretation 1-2 and interpretation 2-2).

The base station may indicate a CSI report in consideration of the amount of channel information that the UE can simultaneously calculate for the CSI report (for example, the number of CSI processing units (CPUs) of the UE). Assuming that the number of channel information calculation units that the UE can calculate simultaneously is N_{CPU}, the UE may not expect a CSI report indication from the base station that requires more channel information calculations than N_{CPU}, or may not consider the update of channel information that requires more channel information calculations N_{CPU}. The N_{CPU} may be reported to the base station by the UE through upper layer signaling or configured by the base station through upper layer signaling.

The CSI report indicated by the base station to the UE may be assumed to occupy part or all of the CPUs for channel information calculation, among the total number N_{CPU} of channel information that the UE can calculate simultaneously. Assuming that, with regard to each CSI report, the number of channel information calculation units required for a CSI report n (n=0, 1, . . . , N−1), for example,

$${O}_{CPU}^{( n )} ,$$

the number of channel information calculation units required for the total N CSI reports may be

$${\sum }_{n = 0}^{N - 1} {O}_{CPU}^{( n )} .$$

The channel information calculation unit required for each reportQuantity configured in a CSI report may be configured as in Table 15. Obviously, the following example is not limiting.

TABLE 15
$‐ {O}_{CPU}^{( n )} = 0 : in case that reportQuantity is configured in a CSI report as “ none ” , and$
trs-Info is configured in a CSI-RS resource set connected to the CSI report
$‐ {O}_{CPU}^{( n )} = 1 : in case that reportQuantity is configured in a CSI report as “ none ” ,$
“cri-RSRP”, “ssb-Index-RSRP”, and trs-Info is not configured in a CSI-RS resource
set connected to the CSI report
- in case that reportQuantity is configured in a CSI report as “cri-RI-PMI-CQI”,
“cri-RI-il”, “cri-RI-i1-CQI”, “cri-RI-CQI”, or “cri-RI-LI-PMI-CQI”
$≫ {O}_{CPU}^{( n )} = {N}_{CPU} : in case that an aperiodic CSI report is triggered , and the CSI$
report is not multiplexed with one or all of TB/HARQ-ACK. In case that the CSI
report is a wideband CSI, corresponds to a maximum of 4 CSI-RS ports,
corresponds to a single resource having no CRI report, and codebookType
corresponds to “typeI-SinglePanel” or reportQuantity corresponds to “cri-RI-CQI”
(corresponding cases may be regarded as corresponding to above-described delay
requirement 1, wherein the UE quickly calculates CSI by using all available CPUs
and reports the same)
$≫ {O}_{CPU}^{( n )} = {K}_{s} : remaining cases other than above cases . {K}_{s} indicates the number of$
CSI-RS resources in the CSI-RS resource set for channel measurement

In case that the number of channel information calculations required by the UE for multiple CSI reports at a particular timepoint is greater than the number N_{CPU} of channel information calculation units that the UE can calculate simultaneously, the UE may not consider updating channel information for some CSI reports. Among the multiple indicated CSI reports, CSI reports regarding which channel information update is not considered may be determined by considering at least the time during which channel information calculation required for the CSI reports occupies CPUs and the priority of reported channel information. For example, in connection with calculating channel information required for CSI reports, channel information update may not be considered regarding CSI reports having the CPU occupancy time started at the latest timepoint, and channel information update may not be considered preferentially regarding CSI reports having low channel information priority.

The channel information priority may be determined with reference to Table 16. Obviously, the example below is not limiting.

TABLE 16
CSI priority value Pri_{iCSI}(y,k,c,s) = 2 · N_{cells} · Mₛ · y + N_{cells} · Mₛ · k + Mₛ · c +
s,
- in the case of an aperiodic CSI report transmitted through y = 0 PUSCH, in the
case of a semi-persistent CSI report transmitted through y = 1 PUSCH, in the case
of a semi-persistent CSI report transmitted through y = 2 PUCCH, in the case of a
periodic CSI report transmitted through y = 3 PUCCH;
- in case that k = 0 CSI report includes L1-RSRP, in case that k = 1 CSI report
does not include L1-RSRP;
- c : serving cell index, N_{cells} : the maximum number of serving cells configured by
upper layer signaling (maxNrofServingCells);
- s : CSI report configuration index (reportConfigID), Mₛ: the maximum number of
CSI report configurations configured by upper layer signaling (maxNrofCSI-
ReportConfigurations).

The CSI priority regarding CSI reports may be determined through the priority value Pri_{iCSI}(y, k, c, s) in Table 16. Referring to Table 16, the CSI priority value may be determined by at least one of the type of channel information included in a CSI report, time domain reporting characteristics (aperiodic, semi-persistent, periodic) of the CSI report, the channel (PUSCH, PUCCH) in which the CSI report is transmitted, the serving cell index, or the CSI report configuration index. The CSI priority regarding CSI reports may be determined such that, by comparing the priority value Pri_{iCSI}(y, k, c, s), CSI reports having small priority values have higher priorities.

Assuming that the time of occupancy of CPUs for calculate channel information necessary for the CSI report indicated to the UE by the base station is CPU occupation time, the CPU occupation time may be determined by considering at least one of the type (report quantity) of channel information included in the CSI report, the time axis characteristics (aperiodic, semi-persistent, periodic) of the CSI report, slots or symbols occupied by upper layer signaling or DCI indicating the CSI report, or part or all of slots or symbols occupied by reference signals for channel state measurement.

### [PDCCH: Regarding DCI]

Next, downlink control information (DCI) in a 5G communication system will be described in detail.

In a wireless communication system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include at least some of the following pieces of information given in Table 17 below, for example.

TABLE 17
- Identifier for DCI formats - [1] bit
$‐ Frequency domain resource assignment - [ ⌈ {log}_{2} ( {N}_{RB}^{UL , BWP} ( {N}_{RB}^{UL , BWP} + 1 ) / 2 ) ⌉ ] bits$
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- TPC command for scheduled PUSCH - [2] bits
- UL/SUL indicator - 0 or 1 bit

DCI format 0_1 may be used as non-fallback DCI for scheduling a PUSCH, and in this case, the CRC may be scrambled by a C-RNTI. DCI format 0_1 in which the CRC is scrambled by a C-RNTI may include at least some of the following pieces of information given in Table 18 below, for example.

TABLE 18
- Carrier indicator - 0 or 3 bits
- UL/SUL indicator - 0 or 1 bit
- Identifier for DCI formats - [1] bits
- Bandwidth part indicator - 0, 1 or 2 bits
- Frequency domain resource assignment
$For resource allocation type 0 , ⌈ {N}_{RB}^{UL , BWP} / P ⌉ bits$
$For resource allocation type 1 , ⌈ {log}_{2} ( {N}_{RB}^{UL , BWP} ( {N}_{RB}^{UL , BWP} + 1 ) / 2 ) ⌉ bits$
- Time domain resource assignment - 1, 2, 3, or 4 bits
- VRB-to-PRB mapping - 0 or 1 bit, only for resource allocation type 1.
0 bit if only resource allocation type 0 is configured;
1 bit otherwise.
- Frequency hopping flag - 0 or 1 bit, only for resource allocation type
1.
0 bit if only resource allocation type 0 is configured;
1 bit otherwise.
- Modulation and coding scheme - 5 bits
- New data indicator - 1 bit
- Redundancy version - 2 bits
- HARQ process number - 4 bits
- 1st downlink assignment index - 1 or 2 bits
1 bit for semi-static HARQ-ACK codebook;
2 bits for dynamic HARQ-ACK codebook with single HARQ-ACK
codebook.
- 2nd downlink assignment index - 0 or 2 bits
2 bits for dynamic HARQ-ACK codebook with two HARQ-ACK sub-
codebooks;
0 bit otherwise.
- TPC command for scheduled PUSCH - 2 bits
- sounding reference signal (SRS) resource indicator -
$⌈ {log}_{2} ( {\sum }_{k = 1}^{{L}_{max} \sum } ( \begin{matrix}{N}_{SRS} \\ k\end{matrix} ) ( ) ) □□ ⌉ or ⌈ {log}_{2} ( {N}_{SRS} ) ⌉ bits$
$⌈ {log}_{2} ( {\sum }_{k = 1}^{{L}_{max} \sum } ( \begin{matrix}{N}_{SRS} \\ k\end{matrix} ) ( ) ) □□ ⌉ bits for non - codebook based PUSCH$
transmission;
┌log₂(N_{SRS})┐ bits for codebook based PUSCH transmission.
- Precoding information and number of layers -up to 6 bits
- Antenna ports - up to 5 bits
- SRS request - 2 bits
- CSI request - 0, 1, 2, 3, 4, 5, or 6 bits
- CBG transmission information - 0, 2, 4, 6, or 8 bits
- PTRS-DMRS association - 0 or 2 bits.
- beta offset indicator - 0 or 2 bits
- DMRS sequence initialization - 0 or 1 bit

DCI format 1_0 may be used as fallback Do for scheduling a PDSCH, and in this case, the CRC may be scrambled by a C-RNTI. DCI format 1_0 in which the CRC is scrambled by a C-RNTI may include at least some of the following pieces of information given in Table 19 below, for example.

TABLE 19
- Identifier for DCI formats - [1] bit
$‐ Frequency domain resource assignment - [ ⌈ {log}_{2} ( {N}_{RB}^{DL , BWP} ( {N}_{RB}^{DL , BWP} + 1 ) / 2 ) ⌉ ] bits$
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- PUCCH resource indicator - 3 bits
- PDSCH-to-HARQ feedback timing indicator - [3] bits

DCI format 1_1 may be used as non-fallback DCI for scheduling a PDSCH, and in this case, the CRC may be scrambled by a C-RNTI. DCI format 1_1 in which the CRC is scrambled by a C-RNTI may include at least some of the following pieces of information given in Table 20 below, for example.

TABLE 20
- Carrier indicator - 0 or 3 bits
- Identifier for DCI formats - [1] bits
- Bandwidth part indicator - 0, 1 or 2 bits
- Frequency domain resource assignment
$For resource allocation type 0 , ⌈ {N}_{RB}^{DL , BWP} / P ⌉ bits$
$For resource allocation type 1 , ⌈ {log}_{2} ( {N}_{RB}^{DL , BWP} ( {N}_{RB}^{DL , BWP} + 1 ) / 2 ) ⌉ bits$
- Time domain resource assignment - 1, 2, 3, or 4 bits
- VRB-to-PRB mapping - 0 or 1 bit, only for resource allocation type 1.
0 bit if only resource allocation type 0 is configured;
1 bit otherwise.
- PRB bundling size indicator - 0 or 1 bit
- Rate matching indicator - 0, 1, or 2 bits
- ZP CSI-RS trigger - 0, 1, or 2 bits
For transport block 1:
- Modulation and coding scheme - 5 bits
- New data indicator - 1 bit
- Redundancy version - 2 bits
For transport block 2:
- Modulation and coding scheme - 5 bits
- New data indicator - 1 bit
- Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5 or 6 bits
- Transmission configuration indication - 0 or 3 bits
- SRS request - 2 bits
- CBG transmission information - 0, 2, 4, 6, or 8 bits
- CBG flushing out information - 0 or 1 bit
- DMRS sequence initialization - 1 bit

### [PDCCH: CORESET, Resource Element Group (REG), Control Channel Element (CCE), and Search Space]

Hereinafter, a downlink control channel in a 5G communication system will be described in more detail with reference to the accompanying drawings.

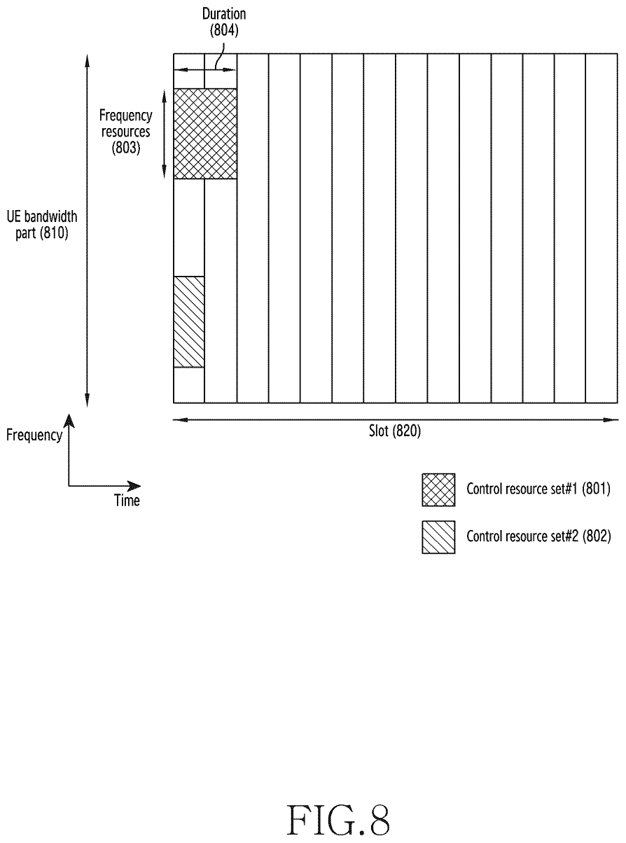

FIG. 8 illustrates an example of a configuration of a control resource set (CORESET) used to transmit a downlink control channel in a wireless communication system according to an embodiment of the disclosure. FIG. 8 illustrates an example in which a UE bandwidth part 810 is configured along the frequency axis, and two control resource sets (control resource set #1 801 and control resource set #2 802) are configured within one slot 820 along the time axis. The control resource sets 801 and 802 may be configured in a specific frequency resource 803 within the entire UE bandwidth part 610 along the frequency axis. One or multiple OFDM symbols may be configured along the time axis, and this may be defined as a control resource set duration 804. Referring to the example illustrated in FIG. 8, control resource set #1 801 is configured to have a control resource set duration corresponding to two symbols, and control resource set #2 802 is configured to have a control resource set duration corresponding to one symbol.

A control resource set in the 5G communication system described above may be configured for a UE by a base station through upper layer signaling (for example, system information, master information block (MIB), radio resource control (RRC) signaling). The description that a control resource set is configured for a UE may mean that at least one piece of information among the identity, frequency location, and symbol duration of a control resource set is provided. For example, the configuration information may include the following pieces of information given in Table 21.

TABLE 21

| | |
|---|---|
| ControlResourceSet ::= | SEQUENCE { |

```
    -- Corresponds to L1 parameter 'CORESET-ID'
    controlResourceSetId
    ControlResourceSetId,
```

| | |
|---|---|
| frequencyDomainResources | BIT STRING (SIZE |

(45)),

| | |
|---|---|
| duration | INTEGER |

```
(1..maxCoReSetDuration),
    cce-REG-MappingType
    CHOICE {
      interleaved
    SEQUENCE {
        reg-BundleSize
    ENUMERATED {n2, n3, n6},
        precoderGranularity
    ENUMERATED {sameAsREG-bundle, allContiguousRBs},
        interleaverSize
    ENUMERATED {n2, n3, n6}
        shiftIndex
    INTEGER(0..maxNrofPhysicalResourceBlocks−1)
            OPTIONAL
  },
```

| | |
|---|---|
| nonInterleaved | NULL |

```
    },
    tci-StatesPDCCH
    SEQUENCE(SIZE (1..maxNrofTCI-StatesPDCCH)) OF TCI-StateId
          OPTIONAL,
```

| | |
|---|---|
| tci-PresentInDCI | ENUMERATED |

{enabled}
OPTIONAL, -- Need S
}

In Table 21, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set.

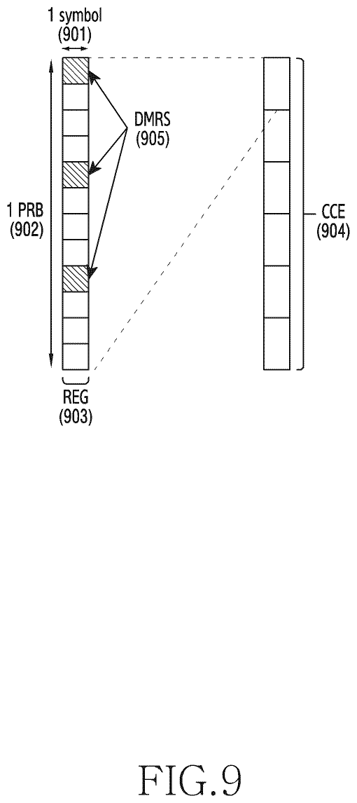

FIG. 9 illustrates a structure of a downlink control channel in a wireless communication system according to an embodiment of the disclosure.

Referring to FIG. 9, FIG. 9 illustrates an example of a basic unit of time and frequency resources constituting a downlink control channel available in 5G. According to FIG. 9, the basic unit of time and frequency resources constituting a control channel may be referred to as a resource element group (REG) 903, and the REG 903 may be defined by one OFDM symbol 901 along the time axis and one physical resource block (PRB) 902 (that is, 12 subcarriers) along the frequency axis. The base station may configure a downlink control channel allocation unit by concatenating the REGs 903.

Provided that the basic unit of downlink control channel allocation in 5G is a CCE 904 as illustrated in FIG. 9, one CCE 904 may include multiple REGs 903. To describe the REG 903 illustrated in FIG. 9, for example, the REG 903 may include 12 REs, and if one CCE 804 includes six REGs 903, one CCE 904 may then include 72 REs. A downlink control resource set, once configured, may include multiple CCEs 904, and a specific downlink control channel may be mapped to one or multiple CCEs 904 and then transmitted according to the aggregation level (AL) in the control resource set. The CCEs 904 in the control resource set are distinguished by numbers, and the numbers of CCEs 904 may be allocated according to a logical mapping scheme.

The basic unit of the downlink control channel illustrated in FIG. 9, that is, the REG 903 may include both REs to which DCI is mapped, and an area to which a reference signal (DMRS 905) for decoding the same is mapped. As in FIG. 7, three DRMSs 905 may be transmitted inside one REG 903. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the information configured for the UE may include at least some of the following pieces of information given in Table 22 below.

TABLE 22

| | |
|---|---|
| SearchSpace ::= | SEQUENCE { |

```
    -- Identity of the search space. SearchSpaceId = 0 identifies the SearchSpace
configured via PBCH (MIB) or ServingCellConfigCommon.
    searchSpaceId
    SearchSpaceId,
    controlResourceSetId
    ControlResourceSetId,
```

| | |
|---|---|
| monitoringSlotPeriodicityAndOffset | CHOICE { |

```
      sl1
    NULL,
      sl2
    INTEGER (0..1),
      sl4
    INTEGER (0..3),
      sl5
    INTEGER (0..4),
      sl8
    INTEGER (0..7),
      sl10
    INTEGER (0..9),
      sl16
    INTEGER (0..15),
      sl20
    INTEGER (0..19)
    }
```

| | |
|---|---|
| | OPTIONAL, |
| duration | INTEGER (2..2559) |
| monitoringSymbolsWithinSlot | BIT STRING |

(SIZE (14))
OPTIONAL,

| | |
|---|---|
| nrofCandidates | SEQUENCE { |

```
      aggregationLevel1
    ENUMERATED {n0, n1, n2, n3, n4, n5, n6, n8},
      aggregationLevel2
    ENUMERATED {n0, n1, n2, n3, n4, n5, n6, n8},
      aggregationLevel4
    ENUMERATED {n0, n1, n2, n3, n4, n5, n6, n8},
      aggregationLevel8
    ENUMERATED {n0, n1, n2, n3, n4, n5, n6, n8},
      aggregationLevel16
    ENUMERATED {n0, n1, n2, n3, n4, n5, n6, n8}
    },
```

| | |
|---|---|
| searchSpaceType | CHOICE { |

```
      -- Configures this search space as common search space (CSS) and
DCI formats to monitor.
      common
    SEQUENCE {
  }
      ue-Specific
    SEQUENCE {
        -- Indicates whether the UE monitors in this USS for DCI
formats 0-0 and 1-0 or for formats 0-1 and 1-1.
        formats
    ENUMERATED {formats0-0-And-1-0, formats0-1-And-1-1},
        ...
}
```

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.
DCI format 0_0/1_0 with CRC scrambled by C-RNTI, CS-RNTI, SP-CSI-RNTI, RA-RNTI, T_{C}-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the examples given below are not limiting.
DCI format 0_0/1_0 with CRC scrambled by C-RNTI, CS-RNTI, T_{C}-RNTI
DCI format 1_0/1_1 with CRC scrambled by C-RNTI, CS-RNTI, T_{C}-RNTI

Enumerated RNTIs may follow the definition and usage given below.
Cell RNTI (C-RNTI): used to schedule a UE-specific PDSCH
Temporary cell RNTI (T_{C}-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated above may follow the definitions given in Table 23 below.

TABLE 23

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and |
| | PUSCH |
| 2_3 | Transmission of a group of TPC commands for SRS |
| | transmissions by one or more UEs |

In a 5G system, the search space at aggregation level L in connection with control resource set p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{C C E , p}}{L \cdot {M}_{s , max}^{( L )}} ⌋ + {n}_{CI} ) mod ⌊ \frac{{N}_{C C E , p}}{L} ⌋ \} + i \qquad Equation 1$$

L: aggregation level
n_{CI}: carrier index
NC_{CCE,p}: total number of CCEs existing in control resource set p

$${n}_{s , f}^{μ} :$$

slot index

$${M}_{s , max}^{( L )} :$$

number of PDCCH candidates at aggregation level L

$${m}_{s , {n}_{CI}} = 0 , … , {M}_{s , max}^{( L )} - 1 :$$

PDCCH candidate index at aggregation level L

$$i = 0 , … , L - 1$$

$${Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 ,$$

$${A}_{p} = 39827 for p mod 3 = 0 , {A}_{p} = 39829 for p mod 3 = 1 ,$$

$${A}_{p} = 39839 for p mod 3 = 2 , D = 65537$$

n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

In a 5G system, multiple search space sets may be configured by different parameters (for example, parameters in Table 22), and the group of search space sets monitored by the UE at each time point may differ accordingly. For example, if search space set #1 is configured at X-slot periodicity, if search space set #2 is configured at Y-slot periodicity, and if X and Y are different, the UE may monitor search space set #1 and search space set #2 both in a specific slot, and may monitor one of search space set #1 and search space set #2 both in another specific slot.

### [PUCCH: Regarding Transmission]

In a 5G system, a UE may transmit control information (UCI) to a base station through a PUCCH. The control information may include at least one of a HARQ-ACK indicating whether the UE has succeeded in demodulating/decoding a transport block (TB) having been received through a PDSCH, a scheduling request (SR) through which the UE requests a PUSCH base station to allocate resources for uplink data transmission, and channel state information (CSI) that is information for reporting a channel state of the UE.

PUCCH resources may be generally classified as for a long PUCCH and a short PUCCH according to the length of allocated symbols. In a 5G system, a long PUCCH has a length of 4 or more symbols in a slot, and a short PUCCH has a length of 2 or less symbols in a slot.

To describe the long PUCCH in more detail, the long PUCCH may be used for the purpose of enhancing uplink cell coverage. Therefore, the long PUCCH may be transmitted in a DFT-S-OFDN scheme that is single carrier transmission, rather than OFDM transmission. The long PUCCH may support transmission formats, such as PUCCH format 1, PUCCH format 3, and PUCCH format 4, according to the number of supportable control information bits and whether UE multiplexing through pre-DFT OCC support at an IFFT front end is supported or not.

First, PUCCH format 1 is a DFT-S-OFDM-based long PUCCH format capable of supporting control information up to 2 bits, and may use as many frequency resources as 1 RB. The control information may be configured by a HARQ-ACK, an SR, or a combination thereof. PUCCH format 1 may have a structure in which an OFDM symbol including a demodulation reference signal (DMRS) that is a demodulation reference signal (or reference signal) and an OFDM symbol including UCI are repeated.

For example, if the number of transmission symbols of PUCCH format 1 is 8, the 8 symbols may be configured by a DMRS symbol, a UCI symbol, a DMRS symbol, a UCI symbol, a DMRS symbol, a UCI symbol, a DMRS symbol, and a UCI symbol sequentially starting from the first starting symbol. DMRS symbols may be spread using an orthogonal code (or orthogonal sequence or spreading code,) on the time axis for a sequence corresponding to the length of 1 RB on the frequency axis in one OFDM symbol, may be subject to IFFT, and then be transmitted.

With regard to UCI symbols, the UE may perform binary phase-shift keying (BPSK) modulation of 1-bit control information or quadrature phase-shift keying (QPSK) modulation of 2-bit control information to generate d(% n), multiply the generated d(% n) by a sequence corresponding to the length of 1 RB on the frequency axis to scramble same, spread the scrambled sequence by using an orthogonal code (or orthogonal sequence or spreading code,) on the time axis, perform IFFT of the spread sequence, and then transmit same.

The UE may generate a sequence, based on a group hopping or sequence hopping configuration and a configured ID configured by the base station through higher layer signaling. Also, the UE may perform a cyclic shift of the generated sequence by using an initial cyclic shift (CS) value configured through a higher signal to generate a sequence corresponding to the length of 1 RB.

wᵢ(m) may be determined as

$${w}_{i} ( m ) = {e}^{\frac{j 2 π ϕ ( m )}{{N}_{S F}}}$$

if the length (NSF) of a spreading code is given and, specifically, is given as in Table 24 below. i may denote the index of the spreading code itself, and m may denote the index of each element of the spreading code. Here, the numbers in the square brackets [ ] in Table 25 may denote φ(m). For example, if the length of a spreading code is 2 and the configured index i of the spreading code is 0 (i=0), the spreading code wᵢ(m) may be w₁(0)=e^{j2π·0/N}^{_{SF}} and wᵢ(1)=e^{j2π·0/N}^{_{SF}}, and thus may be equal to [1 1](wᵢ(m)=[1 1]).

TABLE 24
Spreading code for PUCCH format 1 wᵢ(m)=e^{j2πφ(m)/N}_{SF}

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

Next, PUCCH format 3 is a DFT-S-OFDM-based long PUCCH format capable of supporting control information greater than 2 bits, and the number of used RBs is configurable through a higher layer. The control information may be configured by a combination or each of a HARQ-ACK, an SR, and CSI. DMRS symbol positions in PUCCH format 3 are present in Table 25 below according to whether there is frequency hopping in a slot, and whether an additional DMRS symbol is configured.

TABLE 25

| | DMRS location in PUCCH format 3/4 transmission | | | |
|---|---|---|---|---|
| PUCCH | Additional DMRS is not configured | | Additional DMRS is configured | |
| format 3/4 | frequency | frequency | frequency | frequency |
| transmission | hopping is not | hopping is | hopping is not | hopping is |
| length | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

If the number of transmission symbols of PUCCH format 3 is 8, a DMRS is transmitted on a first symbol and a fifth symbol when the O-th symbol is used as the first staffing symbol of the 8 symbols. Table 25 is also applied to DMRS symbol locations of PUCCH format 4 in the same way.

Next, PUCCH format 4 is a DFT-S-OFDM-based long PUCCH format capable of supporting control information greater than 2 bits, and may use as many frequency resources as 1 RB. The control information may be configured by a combination or each of a HARQ-ACK, an SR, and CSI. PUCCH format 4 may be different from PUCCH format 3 in that PUCCH formats 4 of several UEs are multiplexable in one RB. It is possible to multiplex PUCCH formats 4 of multiple UEs through pre-DFT orthogonal cover code (OCC) application to control information at an IFFT front end. However, the number of control information symbols transmittable by one UE may be reduced according to the number of multiplexed UEs. The number of multiplexable UEs (e.g., the number of available different OCCs) may be 2 or 4, and the number of OCCs and OCC indexes to be applied may be configured through a higher layer.

Next, a short PUCCH will be described. The short PUCCH may be transmitted on both a downlink-centric slot and an uplink-centric slot. In general, the short PUCCH may be transmitted on the last symbol of a slot or an OFDM symbol positioned in a rear part (e.g., the last OFDM symbol, the second last OFDM symbol, or the last two OFDM symbols). It may also be possible for a short PUCCH to be transmitted on a random position in a slot. The short PUCCH may also be transmitted using one OFDM symbol or two OFDM symbols. The short PUCCH may be used to shorten a delay time, compared to a long PUCCH, in a situation where uplink cell coverage is good, and may be transmitted in a CP-OFDM scheme.

The short PUCCH may support transmission formats, such as PUCCH format 0 and PUCCH format 2, according to the number of supportable control information bits. First, PUCCH format 0 is a short PUCCH format capable of supporting control information up to 2 bits, and may use as many frequency resources as 1 RB. The control information may be configured by a HARQ-ACK, an SR, or a combination thereof. PUCCH format 0 may have a structure of not transmitting a DMRS and transmitting only a sequence mapped to 12 subcarriers on the frequency axis in one OFDM symbol. The UE may generate a sequence, based on a group hopping or sequence hopping configuration and a configured ID configured by the base station through a higher signal. Also, the UE may perform a cyclic shift (CS) of the generated sequence by using a final CS value obtained by adding, to an indicated initial CS value, a CS value varying according to an ACK or NACK, map the sequence to 12 subcarriers, and transmit the mapped sequence

For example, if a HARQ-ACK has 1 bit, as shown in Table 26 below, if the HARQ-ACK is an ACK, the UE may generate the final CS by adding 6 to the initial CS value, and if the HARQ-ACK is a NACK, the UE may generate the final CS by adding 0 to the initial CS. The value of 0 that is a CS value for NACK and the value of 6 that is a CS value for ACK are defined in a specification, and the UE may generate PUCCH format 0 according to the values defined in the specification to transmit a 1-bit HARQ-ACK.

TABLE 26

| 1-bit HARQ-ACK | NACK | ACK |
|---|---|---|
| final CS | (initial CS + 0) | (initial CS + 0) |
| | mod 12 = initial CS | mod 12 |

For example, if a HARQ-ACK has 2 bits, as shown in Table 27 below, the UE may add 0 to the initial CS value if the HARQ-ACK is (NACK, NACK), add 3 to the initial CS value if the HARQ-ACK is (NACK, ACK), add 6 to the initial CS value if the HARQ-ACK is (ACK, ACK), and add 9 to the initial CS value if the HARQ-ACK is (ACK, NACK). The value of 0 that is a CS value for (NACK, NACK), the value of 3 that is a CS value for (NACK, ACK), the value of 6 that is a CS value for (ACK, ACK), and the value of 9 that is a CS value for (ACK, NACK) may be defined in a specification. The UE may generate PUCCH format 0 according to the values defined in the specification to transmit a 2-bit HARQ-ACK If the final CS value exceeds 12 due to the CS value added to the initial CS value according to an ACK or NACK, since length of the sequence is 12, modulo 12 may be applied to the final CS value.

TABLE 27

| 2-bit | | | | |
|---|---|---|---|---|
| HARQ-ACK | NACK, NACK | NACK, ACK | ACK, ACK | ACK, NACK |
| final CS | (initial CS + 0) | (initial CS + 3) | (initial CS + 6) | (initial CS + 9) |
| | mod 12 = initial | mod 12 | mod 12 | mod 12 |
| | CS | | | |

Next, PUCCH format 2 is a short PUCCH format supporting control information greater than 2 bits, and the number of used RBs may be configured through a higher layer. The control information may be configured by a combination or each of a HARQ-ACK, an SR, and CSI. If the index of a first subcarrier is #0, PUCCH format 2 may be fixed to subcarriers having indexes of #1, #4, #7, and #10 as the positions of subcarriers on which a DMRS is transmitted in one OFDM symbol. The control information may undergo channel coding and then a modulation process to be mapped to the remaining subcarriers except the subcarriers on which the DMRS is positioned.

In summary, configurable values for each PUCCH format described above and the ranges thereof may be organized as given in Table 28 below. In Table 28 below, a case where there is no need to configure a value may be marked as “N.A.”.

TABLE 28

| | | PUCCH | PUCCH | PUCCH | PUCCH | PUCCH |
|---|---|---|---|---|---|---|
| | | Format 0 | Format 1 | Format 2 | Format 3 | Format 4 |
| Starting symbol | Configurability | √ | √ | √ | √ | √ |
| | Value range | 0-13 | 0-10 | 1-13 | 0-10 | 0-10 |
| Number of | Configurability | √ | √ | √ | √ | √ |
| symbols in a slot | Value range | 1, 2 | 4-14 | 1, 2 | 4-14 | 4-14 |
| Index for | Configurability | √ | √ | √ | √ | √ |
| identifying | Value range | 0-274 | 0-274 | 0-274 | 0-274 | 0-274 |
| starting PRB | | | | | | |
| Number of PRBs | Configurability | N.A. | N.A. | √ | √ | N.A. |
| | Value range | N.A. | N.A. | 1-16 | 1-6, 8-10, | N.A. |
| | | (Default is 1) | (Default is 1) | | 12, 15, 16 | (Default is 1) |
| Enabling | Configurability | √ | √ | √ | √ | √ |
| frequency | Value range | On/Off (only | On/Off | On/Off (only | On/Off | On/Off |
| hopping | | for 2 | | for 2 | | |
| (intra-slot) | | symbol) | | symbol) | | |
| Freq.cy resource | Configurability | √ | √ | √ | √ | √ |
| of 2^{nd} hop if | Value range | 0-274 | 0-274 | 0-274 | 0-274 | 0-274 |
| intra-slot | | | | | | |
| frequency | | | | | | |
| hopping is | | | | | | |
| enabled | | | | | | |
| Index of initial | Configurability | √ | √ | N.A. | N.A. | N.A. |
| cyclic shift | Value range | 0-11 | 0-11 | N.A. | N.A. | N.A. |
| Index of | Configurability | N.A. | √ | N.A. | N.A. | N.A. |
| time-domain | Value range | N.A. | 0-6 | N.A. | N.A. | N.A. |
| OCC | | | | | | |
| Length of | Configurability | N.A. | N.A. | N.A. | N.A. | √ |
| Pre-DFT OCC | Value range | N.A. | N.A. | N.A. | N.A. | 2, 4 |
| Index of Pre-DFT | Configurability | N.A. | N.A. | N.A. | N.A. | √ |
| OCC | Value range | N.A. | N.A. | N.A. | N.A. | 0, 1, 2, 3 |

For uplink coverage improvement, multi-slot repeated transmission may be supported for PUCCH formats 1, 3, and 4, and PUCCH repeated transmission may be configured for each PUCCH format. The UE may perform repeated transmission of a PUCCH including UCI as many times as the number of slots configured through the higher layer signaling nrofSlots. For PUCCH repetition transmission, a PUCCH transmission on each slot may be performed using the same number of consecutive symbols. The number of consecutive symbols may be configured through nrofSymbols in higher layer signaling PUCCH-format 1, PUCCH-format 3, or PUCCH-format 4. For PUCCH repetition transmission, a PUCCH transmission on each slot may be performed using the same starting symbol. The starting symbol may be configured through startingSymbolIndex in higher layer signaling PUCCH-format 1, PUCCH-format 3, or PUCCH-format 4. For PUCCH repetition transmission, single PUCCH-spatialRelationInfo may be configured for a single PUCCH resource. For PUCCH repetition transmission, if the UE is configured to perform frequency hopping between PUCCH transmissions on different slots, the UE may perform frequency hopping in units of slots. In addition, if the UE is configured to perform frequency hopping between PUCCH transmissions on different slots, the UE may start a PUCCH transmission on an even-numbered slot at a first PRB index configured through higher layer signaling startingPRB, and start a PUCCH transmission on an odd-numbered slot at a second PRB index configured through higher layer signaling secondHopPRB. Additionally, if the UE is configured to perform frequency hopping between PUCCH transmissions on different slots, the index of a slot indicated for the UE to perform a first PUCCH transmission thereon is 0, and through a configured entire PUCCH repeated transmission count, a PUCCH repeated transmission count value may be increased independently of whether PUCCH transmission is performed on each slot. If the UE is configured to perform frequency hopping between PUCCH transmissions on different slots, the UE does not expect that frequency hopping in a slot at the time of PUCCH transmission is configured. If performing frequency hopping between PUCCH transmissions on different slots is not configured for the UE and frequency hopping in a slot is configured, the first and second PRB indexes may also be identically applied in the slot. If the number of uplink symbols on which PUCCH transmission is possible is smaller than a number indicated by nrofSymbols configured through higher layer signaling, the UE may not transmit a PUCCH. Even if the UE has failed PUCCH transmission on a slot for a reason during PUCCH repeated transmission, the UE may increase the PUCCH repeated transmission count.

In NR Release 17, the number of slots for repeated transmission of each PUCCH resource in PUCCH-ResourceExt that is an expansion of the higher layer signaling PUCCH-Resource for PUCCH resources may be configured through the higher layer signaling pucch-RepetitionNrofSlots-r17. If higher layer signaling pucch-RepetitionNrofSlots-r17 is configured, a corresponding PUCCH may be scheduled. If higher layer signaling nrofSlots is also configured, the UE may determine the number of slots on which the corresponding PUCCH is repetitively transmitted though pucch-RepetitionNrofSlots-r17, and disregard higher layer signaling nrofSlots

### [PUCCH: PUCCH Resource Configuration]

Next, a PUCCH resource configuration of a base station or a UE is described. The base station may be able to configure a PUCCH resource for each BWP for a particular UE though a higher layer. The PUCCH resource configurations may be as given in Table 29 below.

TABLE 29

| | |
|---|---|
| PUCCH-Config ::= | SEQUENCE { |
| resourceSetToAddModList | SEQUENCE (SIZE (1..maxNrofPUCCH- |
| ResourceSets)) OF PUCCH-ResourceSet | OPTIONAL, -- Need N |
| resourceSetToReleaseList | SEQUENCE (SIZE (1..maxNrofPUCCH- |

ResourceSets)) OF PUCCH-ResourceSetId OPTIONAL, -- Need N

| | |
|---|---|
| resourceToAddModList | SEQUENCE (SIZE (1..maxNrofPUCCH- |
| Resources)) OF PUCCH-Resource | OPTIONAL, -- Need N |
| resourceToReleaseList | SEQUENCE (SIZE (1..maxNrofPUCCH- |
| Resources)) OF PUCCH-ResourceId | OPTIONAL, -- Need N |
| format1 | SetupRelease { PUCCH-FormatConfig } |

OPTIONAL, -- Need M

| | |
|---|---|
| format2 | SetupRelease { PUCCH-FormatConfig } |

OPTIONAL, -- Need M

| | |
|---|---|
| format3 | SetupRelease { PUCCH-FormatConfig } |

OPTIONAL, -- Need M

| | |
|---|---|
| format4 | SetupRelease { PUCCH-FormatConfig } |

OPTIONAL, -- Need M

| | |
|---|---|
| schedulingRequestResourceToAddModList | SEQUENCE (SIZE |

(1..maxNrofSR-Resources)) OF SchedulingRequestResourceConfig
OPTIONAL, -- Need N
schedulingRequestResourceToReleaseList SEQUENCE (SIZE (1..maxNrofSR-
Resources)) OF SchedulingRequestResourceId
OPTIONAL, -- Need N

| | |
|---|---|
| multi-CSI-PUCCH-ResourceList | SEQUENCE (SIZE (1..2)) OF PUCCH- |

ResourceId OPTIONAL, -- Need M

| | |
|---|---|
| dl-DataToUL-ACK | SEQUENCE (SIZE (1..8)) OF INTEGER (0..15) |

OPTIONAL, -- Need M

| | |
|---|---|
| spatialRelationInfoToAddModList | SEQUENCE (SIZE |

(1..maxNrofSpatialRelationInfos)) OF PUCCH-SpatialRelationInfo
OPTIONAL, -- Need N

| | |
|---|---|
| spatialRelationInfoToReleaseList | SEQUENCE (SIZE |

(1..maxNrofSpatialRelationInfos)) OF PUCCH-SpatialRelationInfoId
OPTIONAL, -- Need N

| | |
|---|---|
| pucch-PowerControl | PUCCH-PowerControl |

```
OPTIONAL, -- Need M
  ...,
  [[
```

| | |
|---|---|
| resourceToAddModListExt-r16 | SEQUENCE (SIZE (1..maxNrofPUCCH- |

Resources)) OF PUCCH-ResourceExt-r16 OPTIONAL, -- Need N

| | |
|---|---|
| dl-DataToUL-ACK-r16 | SetupRelease { DL-DataToUL-ACK-r16 } |

OPTIONAL, -- Need M
ul-AccessConfigListDCI-1-1-r16 SetupRelease { UL-AccessConfigListDCI-1-
1-r16 } OPTIONAL, -- Need M

| | |
|---|---|
| subslotLengthForPUCCH-r16 | CHOICE { |
| normalCP-r16 | ENUMERATED {n2,n7}, |
| extendedCP-r16 | ENUMERATED {n2,n6} |
| } | OPTIONAL, -- Need R |

```
  dl-DataToUL-ACK-DCI-1-2-r16 SetupRelease { DL-DataToUL-ACK-DCI-1-
2-r16} OPTIONAL, -- Need M
  numberOfBitsForPUCCH-ResourceIndicatorDCI-1-2-r16 INTEGER (0..3)
OPTIONAL, -- Need R
  dmrs-UplinkTransformPrecodingPUCCH-r16 ENUMERATED {enabled}
OPTIONAL, -- Cond PI2-BPSK
  spatialRelationInfoToAddModListSizeExt-v1610 SEQUENCE (SIZE
(1..maxNrofSpatialRelationInfosDiff-r16)) OF PUCCH-SpatialRelationInfo
OPTIONAL, -- Need N
  spatialRelationInfoToReleaseListSizeExt-v1610  SEQUENCE (SIZE
(1..maxNrofSpatialRelationInfosDiff-r16)) OF PUCCH-SpatialRelationInfoId
OPTIONAL, -- Need N
  spatialRelationInfoToAddModListExt-v1610 SEQUENCE (SIZE
(1..maxNrofSpatialRelationInfos-r16)) OF PUCCH-SpatialRelationInfoExt-r16
OPTIONAL, -- Need N
  spatialRelationInfoToReleaseListExt-v1610  SEQUENCE (SIZE
(1..maxNrofSpatialRelationInfos-r16)) OF PUCCH-SpatialRelationInfoId-r16
OPTIONAL, -- Need N
```

| | |
|---|---|
| resourceGroupToAddModList-r16 | SEQUENCE (SIZE |

(1..maxNrofPUCCH-ResourceGroups-r16)) OF PUCCH-ResourceGroup-r16
OPTIONAL, -- Need N

| | |
|---|---|
| resourceGroupToReleaseList-r16 | SEQUENCE (SIZE (1..maxNrofPUCCH- |

ResourceGroups-r16)) OF PUCCH-ResourceGroupId-r16
OPTIONAL, -- Need N

| | |
|---|---|
| sps-PUCCH-AN-List-r16 | SetupRelease { SPS-PUCCH-AN-List-r16 } |

OPTIONAL, -- Need M

| | |
|---|---|
| schedulingRequestResourceToAddModListExt-v1610 | SEQUENCE (SIZE |

(1..maxNrofSR-Resources)) OF SchedulingRequestResourceConfigExt-v1610
OPTIONAL -- Need N
]]
}

According to Table 29, one or multiple PUCCH resource sets may be configured in a PUCCH resource configuration for a particular BWP, and a maximum payload value for UCI transmission may be configured for some of the PUCCH resource sets. One or multiple PUCCH resources may belong to each PUCCH resource set, and each PUCCH resource may belong to one of the PUCCH formats described above.

With regard to the PUCCH resource sets, a maximum payload value of the first PUCCH resource set may be fixed to 2 bits. Accordingly, the maximum payload value may not be separately configured through a higher layer. If the other PUCCH resource sets are configured, the index of a corresponding PUCCH resource set may be configured in an ascending order according to the maximum payload value, and no maximum payload value may be configured for the last PUCCH resource set. A higher layer configuration for a PUCCH resource set may be as given in Table 30 below.

TABLE 30

| PUCCH-ResourceSet ::= | SEQUENCE |
|---|---|
| pucch-ResourceSetId | PUCCH-ResourceSetId, |
| resourceList | SEQUENCE (SIZE |
| (1..maxNrofPUCCH-ResourcesPerSet)) OF PUCCH-ResourceId, | |
| maxPayloadSize | INTEGER (4..256) |

OPTIONAL -- Need R
}

The parameter resourceList in Table 30 may include IDs of PUCCH resources belonging to a PUCCH resource set.

At the time of initial access, or if a PUCCH resource set is not configured, a PUCCH resource set, as given in Table 31 below, configured by multiple PUCCH resources which are cell-specific in an initial BWP, may be used. A PUCCH resource to be used for initial access in the PUCCH resource set as given in Table 31 may be indicated through SIB1.

TABLE 31

| | | | | PRB offset | |
|---|---|---|---|---|---|
| Index | POCCH format | First symbol | Number of symbols | ${RB}_{BWP}^{offset}$ | Set of initial CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9) |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9) |
| 10 | 1 | 4 | 10 | 4 | {0, 3, 6, 9} |
| 11 | | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ {N}_{BWP}^{size} / 4 ⌋$ | (0, 3, 6, 9} |

A maximum payload of each of PUCCH resources included in the PUCCH resource set may be 2 bits in the case of PUCCH format 0 or 1, and may be determined according to a symbol length, the number of PRBs, and a maximum code rate in the case of the remaining formats. The symbol length and the number of PRBs may be configured for each PUCCH resource, and the maximum code rate may be configured for each PUCCH format.

Next, PUCCH resource selection for UCI transmission is described. In the case of SR transmission, a PUCCH resource for an SR corresponding to schedulingRequestID as shown in Table 32 below may be configured through a higher layer. The PUCCH resource may be a resource belonging to PUCCH format 0 or PUCCH format 1.

TABLE 32
SEQUENCE

| | |
|---|---|
| SchedulingRequestResourceConfig ::= | SEQUENCE |
| schedulingRequestResourceId | SchedulingRequestResourceId, |
| schedulingRequestID | SchedulingRequestId, |
| periodicityAndOffset | CHOICE { |
| sym2 | NULL, |
| sym6or7 | NULL, |
| sl1 | NULL, -- Recurs in every slot |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |
| } | OPTIONAL, -- Need M |
| resource | PUCCH-ResourceId OPTIONAL -- Need |

M
}

A transmission period and an offset of the configured PUCCH resource may be configured through the parameter periodicityAndOffset in Table 32. If there is uplink data to be transmitted by the UE at a time point corresponding to the configured period and offset, the PUCCH resource may be transmitted, and otherwise, the PUCCH resource may not be transmitted.

In the case of CSI transmission, a PUCCH resource on which a periodic CSI report or a semi-persistent CSI report through a PUCCH is to be transmitted may be configured in the parameter pucch-CSI-ResourceList as given in Table 33 below. The parameter pucch-CSI-ResourceList may include a list of PUCCH resources for each BWP for a cell or CC on which the CSI report is to be transmitted. The PUCCH resource may be a resource belonging to PUCCH format 2, PUCCH format 3, or PUCCH format 4. A transmission periodicity and an offset of the PUCCH resource may be configured through reportSlotConfig in Table 33.

TABLE 33

| CSI-ReportConfig ::= | SEQUENCE { | |
|---|---|---|
| reportConfigId | CSI-ReportConfigId, | |
| carrier | ServCellIndex | OPTIONAL, -- Need S |

...

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |
| reportSlotConfig | ENUMERATED {sl5, sl10, sl20, sl40, sl80, |

sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL- |

```
Allocations)) OF INTEGER(0..32)
    }
  },
  ...
}
```

In the case of HARQ-ACK transmission, a resource set of PUCCH resources to be transmitted may be first selected according to a payload of UCI including the HARQ-ACK. For example, a PUCCH resource set having a minimum payload not smaller than the payload of the UCI may be selected. Next, a PUCCH resource in the PUCCH resource set may be selected through a PUCCH resource indicator (PRI) in DCI which schedules a TB corresponding to the relevant HARQ-ACK. The PRI may be the PUCCH resource indicator enumerated in Table 19 or 20. The relationship between a PRI and a PUCCH resource selected form the PUCCH resource set may be as given in Table 34 below.

TABLE 34

| PUCCH | |
|---|---|
| resource | |
| indicator | PUCCH resource |
| ‘000’ | 1^{st} PUCCH resource provided by pucch-ResourceId |
| | obtained from the 1^{st} value of resourceList |
| ‘001’ | 2^{nd} PUCCH resource provided by pucch-ResourceId |
| | obtained from the 2^{nd} value of resourceList |
| ‘010’ | 3^{rd} PUCCH resource provided by pucch-ResourceId |
| | obtained from the 3^{rd} value of resourceList |
| ‘011’ | 4^{th} PUCCH resource provided by pucch-ResourceId |
| | obtained from the 4^{th} value of resourceList |
| ‘100’ | 5^{th} PUCCH resource provided by pucch-ResourceId |
| | obtained from the 5^{th} value of resourceList |
| ‘101’ | 6^{th} PUCCH resource provided by pucch-ResourceId |
| | obtained from the 6^{th} value of resourceList |
| ‘110’ | 7^{th} PUCCH resource provided by pucch-ResourceId |
| | obtained from the 7^{th} value of resourceList |
| ‘111’ | 8^{th} PUCCH resource provided by pucch-ResourceId |
| | obtained from the 8^{th} value of resourceList |

If the number of PUCCH resources in a selected PUCCH resource set is greater than 8, a PUCCH resource may be selected by Equation 2 below.

$${r}_{PUCCH} = \{ \begin{matrix}\begin{matrix}⌊ \frac{{n}_{CCE , p} \cdot ⌈ {R}_{PUCCH} / 8 ⌉}{{N}_{CCE , p}} ⌋ + \\ {Δ}_{PRI} \cdot ⌈ \frac{{R}_{PUCCH}}{8} ⌉\end{matrix} & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot \\ ⌊ \frac{{R}_{PUCCH}}{8} ⌋ + {R}_{PUCCH} mod 8\end{matrix} & if {Δ}_{PRI} \geq {R}_{PUCCH} mod 8\end{matrix} \} \qquad Equation 2$$

In Equation 2, r_{PUCCH} denotes the index of the selected PUCCH resource in the PUCCH resource set, R_{PUCCH} denotes the number of the PUCCH resources belonging to the PUCCH resource set, Δ_{PRI} denotes a PRI value, N_{CCE,p} denotes a total number of CCEs of CORESET p to which reception DCI belongs, and n_{CCE,p} denotes the index of a first CCE for the reception DCI.

A time point at which the PUCCH resource is transmitted is a time point after K₁ slots after transmission of a TB corresponding to the HARQ-ACK. A candidate of the K₁ value is configured through a higher layer and, more specifically, may be configured in the parameter dl-DataToUL-ACK in PUCCH-Config specified in Table 29. One K₁ value among these candidates may be selected by a PDSCH-to-HARQ feedback timing indicator in DCI scheduling a TB, and the value may be a value specified in Table 18 or Table 19. The unit of the K₁ value may be a unit of a slot or a unit of a subslot. Here, a subslot is a length unit smaller than a slot, and one subslot may be configured by one or multiple symbols.

Next, a case where two or more PUCCH resources are positioned in one slot will be described. A UE may transmit UCI through one or two PUCCH resources in one slot or subslot, and when UCI is transmitted through two PUCCH resources in one slot/subslot, i) each PUCCH resource does not overlap in a unit of a symbol, and ii) at least one PUCCH resource may be a short PUCCH. The UE may not expect to transmit

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 17 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 35 though higher signaling. If PUSCH transmission is operated by a configured grant, parameters applied to the PUSCH transmission are applied through configuredGrantConfig (upper signaling) in Table 35 except for dataScramblingldentityPUSCH, txConfig, codebookSubset, maxRank, and scaling of UCI-OnPUSCH, which are provided by pusch-Config (upper signaling) in Table 36. If provided with transformPrecoder inside configuredGrantConfig (upper signaling) in Table 35, the UE applies tp-pi2BPSK inside pusch-Config in Table 25 to PUSCH transmission operated by a configured grant.

TABLE 35

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, |
| qam64LowSE} | OPTIONAL, -- Need S |
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |

```
      sym2, sym7, sym1x14, sym2x14, sym4x14,
sym5x14, sym8x14, sym10x14, sym16x14, sym20x14,
      sym32x14, sym40x14, sym64x14, sym80x14,
sym128x14, sym160x14, sym256x14, sym320x14, sym512x14,
      sym640x14, sym1024x14, sym1280x14,
sym2560x14, sym5120x14,
      sym6, sym1x12, sym2x12, sym4x12, sym5x12,
sym8x12, sym10x12, sym16x12, sym20x12, sym32x12,
      sym40x12, sym64x12, sym80x12, sym128x12,
sym160x12, sym256x12, sym320x12, sym512x12, sym640x12,
      sym1280x12, sym2560x12
  },
```

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks−1) | OPTIONAL, -- Need R |
| pathlossReferenceIndex | INTEGER (0..maxNrofPUSCH- |

```
PathlossReferenceRSs−1),
    ...
  }
OPTIONAL, -- Need R
  ...
}
```

Next, a PUSCH transmission method will be described. PUSCH transmission may follow a codebook-based transmission method and a non-codebook-based transmission method according to whether the value of txConfig inside pusch-Config in Table 36, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE may perform beam configuration for PUSCH transmission by using pucch-spatialRelationInfoID corresponding to a UE-specific PUCCH resource corresponding to the minimum ID inside an activated uplink BWP inside a serving cell, and the PUSCH transmission may be based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 36, the UE may not expect scheduling through DCI format 0_1.

TABLE 36

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF |

INTEGER (1.. maxNrofPhysicalResourceBlocks−1)
OPTIONAL, -- Need M

| | |
|---|---|
| resourceAllocation | ENUMERATED |

{ resourceAllocationType0, resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, |
| qam64LowSE} | OPTIONAL, -- Need S |
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}

OPTIONAL, --

Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI may refer to the SRS resource corresponding to the SRI, among SRS resources transmitted prior to the PDCCH including the corresponding SRI. The TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (higher signaling) and TPMI. The codebookSubset inside pusch-Config (upper signaling) may be configured to be one of “fullyAndPartialAndNonCoherent”, “partialAndNonCoherent”, or “nonCoherent”, based on UE capability reported by the UE to the base station. If the UE reported “partialAndNonCoherent” as UE capability, the UE may not expect that the value of codebookSubset (upper signaling) will be configured as “fullyAndPartialAndNonCoherent”. In addition, if the UE reported “nonCoherent” as UE capability, UE may not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may selects one from the SRS resources transmitted by the UE and instructs the UE to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be semi-statically operated by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE may not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 11) is not “00”. The corresponding DCI may not indicate cross carrier or cross BWP scheduling. In addition, if the value of SRS request indicates the existence of a NZP CSI-RS, the NZP CSI-RS may be located in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associated CSI-RS inside SRS-ResourceSet (upper signaling). With regard to non-codebook-based transmission, the UE may not expect that spatialRelationInfo which is upper signaling regarding the SRS resource and associated CSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”, and the base station may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

### [Regarding UE Capability Report]

In LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to a UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. For example, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA—NR dual connectivity (EN-DC). The UE capability enquiry message may be transmitted initially after the UE is connected to the base station, in general, but may be requested in any condition if needed by the base station.

According to an embodiment, upon receiving the UE capability report request from the base station, the UE may configure UE capability according to band information and RAT type requested by the base station. The method in which the UE configures UE capability in an NR system is summarized below:
1. If the UE receives a list regarding LTE and/or NR bands from the base station at a UE capability request, the UE constructs band combinations (BCs) regarding EN-DC and NR standalone(SA). That is, the UE may configure a candidate list of BCs regarding EN-DC and NR SA, based on bands received from the base station at a request through FreqBandList. In addition, bands may have priority in the order described in FreqBandList.
2. If the base station has set “eutra-nr-only” flag or “eutra” flag and requested a UE capability report, the UE may remove everything related to NR SA BCs from the configured BC candidate list. Such an operation may occur only if an LTE base station (eNB) requests “eutra” capability.
3. The UE may then remove fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same can be omitted. This step may be applied in MR-DC as well, for example, LTE bands may also be applied. BCs remaining after the above step may constitute the final “candidate BC list”.
4. The UE may select BCs appropriate for the requested RAT type from the final “candidate BC list” and select BCs to report. In this step, the UE may configure supportedBandCombinationList in a determined order. That is, the UE may configure BCs and UE capability to report according to a preconfigured rat-Type order. (nr->eutra-nr->eutra). In addition, the UE may configure featureSetCombination regarding the configured supportedBandCombinationList, and configure a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.
5. If the requested RAT type is eutra-nr and has an influence, featureSetCombinations may be included on both containers of UE-MRDC-Capabilities and UE-NR-Capabilities. However, the feature set of NR may be included only in UE-NR-Capabilities.

After the UE capability is configured, the UE may transfer a UE capability information message including the UE capability to the base station. The base station may perform scheduling and transmission/reception management appropriate for the UE, based on the UE capability received from the UE.

In an embodiment of the disclosure, the UE's L1-RSRP measurement and reporting method will be described.

In order to calculate the L1-RSRP, the following items may be considered.
The UE may have one or more CSI-RS resources configured therefor, may have one or more SSB resources configured therefor, or may have both CSI-RS resources and SSB resources having a QCL relationship in QCL-TypeC and QCL-TypeD between resources, configured therefor. In addition, the CSI-RS resources and the SSB resources may be included in different resource sets.
The UE may have a maximum of 64 CSI-RS resources configured therefor in one CSI-RS resource set.
The UE may have a maximum of 16 CSI-RS resource sets configured therefor.
The UE may have a maximum number of 128 different CSI-RS resources configured therefor across all CSI-RS resource sets.

For L1-RSRP reporting, in case that the UE has nrofReportedRS inside CSI-ReportConfig (upper layer signaling) configured as “1”, the reported L1-RSRP value may be quantized with 7 bits, and the range of the value may be defined at an interval of 1 dB from −140 dBm to −44 dBm. In case that the UE has nrofReportedRS in CSI-ReportConfig (upper layer signaling) configured to be larger than 1, or in case that the UE has groupBasedBeamReporting (upper layer signaling) configured as “enabled”, the UE may quantize the largest value among the measured L1-RSRP with 7 bits, and the range of the corresponding value may be defined at an interval of 1 dB from −140 dBm to −44 dBm. Alternatively, the differential L1-RSRP, which may indicate a relative RSRP value from the largest L1-RSRP value, may be quantized with 4 bits, and the corresponding value's interval may be defined as 2 dB. In this regard, the differential L1-RSRP may be reported together with the largest L1-RSRP value.

In case that timeRestrictionForChannelMeasurements (upper layer signaling configured inside CSI-ReportConfig) is configured as “notConfigured” for the UE, the UE may calculate the L1-RSRP value to be reported in uplink slot n, based on the CSI-RS or SSB in a CSI resource that may be defined on time resources, or in a CSI resource setting connected to the previously received L1-RSRP report.

In case that timeRestrictionForChannelMeasurements (upper layer signaling configured inside CSI-ReportConfig) is configured as “Configured” for the UE, the UE may calculate the L1-RSRP value to be reported in uplink slot n, based only on the most recent reception location of the CSI-RS or SSB in a CSI resource that may be defined on time resources, or in a CSI resource setting connected to the previously received L1-RSRP report.

Table 37 below indicates the order of arrangement of information when reporting L1-RSRP. The bit length of the CRI and SSBRI may be defined as the number of bits that may express the number of CSI-RS resources in the CSI-RS resource set

$$( e . g . , ⌈ {log}_{2} ( {K}_{S}^{CSI - RS} ) ⌉ ) ,$$

or the number of bits that may express the number of SSB resources in the SSB resource set

$$( e . g . , ⌈ {log}_{2} ( {K}_{S}^{S S B} ) ⌉ ) .$$

In this regard,

$${K}_{S}^{CSI - RS} and {K}_{S}^{S S B}$$

may indicate the number of CSI-RS resources in the CSI-RS resource set and the number of SSB resources in the SSB resource set, respectively. As described above, the RSRP and the differential RSRP may be expressed with 7 bits and 4 bits, respectively.

TABLE 37

| CSI report number | CSI fields |
|---|---|
| CSI report #n | CRI or SSBRI #1 |
| | CRI or SSBRI #1 |
| | CRI or SSBRI #1 |
| | CRI or SSBRI #1 |
| | RSRP #1 |
| | Differential RSRP #2 |
| | Differential RSRP #3 |
| | Differential RSRP #4 |

In an embodiment of the disclosure, a method for configuring resources for L1-SINR measurement and reporting will be described. Table 37 above relates to CSI-ReportConfig configured through upper layer signaling related to CSI reporting, and may be used for following description of L1-SINR measurement.

In case that one resource setting is configured in CSI-ReportConfig (upper layer signaling) for L1-SINR measurement, the configured resource setting (e.g., resourcesForChannelMeasurement (upper layer signaling)) may be an NZP CSI-RS for channel and interference measurement. The UE may assume that a NZP CSI-RS having one port and a density value of 3 REs/RB is used for channel and interference measurement.

In case that two resource settings are configured in CSI-ReportConfig (upper layer signaling) for L1-SINR measurement, the first configured resource setting (e.g., resourcesForChannelMeasurement (upper layer signaling)) may be an SSB or NZP CSI-RS for channel measurement, and the second configured resource setting (e.g., csi-IM-ResourcesForInterference or nzp-CSI-RS-ResourcesForInterference (upper layer signaling)) may be a CSI-IM for interference measurement, or an NZP CSI-RS having one port and a density value of 3 REs/RB. The SSB or NZP CSI-RS for channel measurement may be connected to one CSI-IM resource or one NZP CSI-RS for interference measurement within the same resource set. The number of SSBs or NZP CSI-RSs for channel measurement may be identical to the number of CSI-IMs or NZP CSI-RSs for interference measurement.
When the UE determines a reference RS regarding QCL-TypeD of an NZP CSI-RS for interference measurement, or a CSI-IM connected to an NZP CSI-RS or SSB for channel measurement, the UE may use a reference RS regarding QCL-TypeD of an NZP CSI-RS for channel measurement, or an SSB for channel measurement.
In addition, the UE may expect that a NZP CSI-RS resource set for channel measurement and a NZP CSI-RS resource set for interference measurement will have repetition (upper layer signaling) configured therefor. For example, an NZP CSI-RS resource set for channel measurement and an NZP CSI-RS resource set for interference measurement may both be used for beam management purposes.

With regard to L1-SINR measurement based on a specific interference measurement resource, the UE may assume that the total power received from a specific NZP CSI-RS resource for interference measurement or a specific CSI-IM resource for interference measurement corresponds to interference and noise.

To calculate L1-SINR, a UE may have a NZP CSI-RS resource and/or SSB resource for channel measurement configured therefor, and may have a NZP CSI-RS or CSI-IM resource for interference measurement configured therefor. For channel measurement, the UE may have a maximum of 16 CSI resource sets configured therefor, and may have a maximum of 64 CSI-RSs or 64 SSB resources configured therefor across all the resource sets.
In case that one or two resource settings described above are configured for L1-SINR measurement, the UE may consider a time restriction for channel measurement or interference measurement described below.
In case that timeRestrictionForChannelMeasurements in CSI-ReportConfig (upper layer signaling) is configured as “notConfigured”, the UE may have to derive channel measurement for L1-SINR calculation to be reported in the nth uplink slot, based on SSB or NZP CSI-RS that may be received earlier than CSI reference resources connected to one or two resource settings described above.

In case that timeRestrictionForChannelMeasurements in CSI-ReportConfig (upper layer signaling) is configured as “configured”, the UE may have to derive channel measurement for L1-SINR calculation to be reported in the nth uplink slot, based on the latest SSB or NZP CSI-RS that may be received earlier than CSI reference resources connected to one or two resource settings described above.

In case that timeRestrictionForChannelMeasurements in CSI-ReportConfig (upper layer signaling) is configured as “notConfigured”, the UE may have to derive interference measurement for L1-SINR calculation to be reported in the nth uplink slot, based on an NZP CSI-RS for interference measurement or a CSI-IM that may be received earlier than CSI reference resources connected to one or two resource settings described above.

In case that timeRestrictionForChannelMeasurements in CSI-ReportConfig (upper layer signaling) is configured as “configured”, the UE may have to derive interference measurement for L1-SINR calculation to be reported in the nth uplink slot, based on the latest NZP CSI-RS for interference measurement or CSI-IM that may be received earlier than CSI reference resources connected to one or two resource settings described above.

The UE's L1-SINR reporting method will be described.

During L1-SINR reporting, the UE may configure UCI by using a specific quantization level according to the following condition, and may report the configured UCI to the base station.
In case that nrofReportedRS in CSI-ReportConfig (upper layer signaling) is configured as “1”, the L1-SINR value may be quantized with 7 bits with a step size of 0.5 dB with regard to a value in the range of [−23, 40]dB, and then reported.
In case that nrofReportedRS in CSI-ReportConfig (upper layer signaling) is greater than 1, or in case that groupBasedBeamReporting (upper layer signaling) is configured as “enabled”, the UE may use differential L1-SINR reporting. The maximum L1-SINR value may be quantized with 7 bits by using a step size of 0.5 dB with regard to a value in the range of [−23, 40]dB, and the differential L1-SINR value may be quantized with 4 bits by using a step size of 1 dB with regard to a difference from the maximum L1-SINR reported together with the differential L1-SINR. In case that the NZP CSI-RS is configured for channel measurement and/or interference measurement, the UE may expect that the reported L1-SINR value will not be compensated by the power offset as powerControlOffsetSS or powerControlOffset (upper layer signaling).

In case that the UE has reportQuantity in CSI-ReportConfig (upper layer signaling) configured as “cri-SINR” or “ssb-Index-SINR”, the UE may consider the following operations related to group-based beam reporting.
In case that the UE has groupBasedBeamReporting (upper layer signaling) configured as “disabled”, the UE may include as many different CRI or SSBRI as nrofReportedRS, configured through upper layer signaling, in one report and may report the same to the base station.
In case that the UE has groupBasedBeamReporting (upper layer signaling) configured as “enabled”, the UE may include two different CRI or SSBRI in one report and may report the same to the base station. The CSI-RS and/or SSB indicated by the CRIs or SSBRIs may be those simultaneously received from the UE.

In case that the UE has reportQuantity in CSI-ReportConfig (upper layer signaling) configured as “ssb-Index-SINR”, the UE may need to derive the L1-SINR, based on the SSBRI reported to the base station. SSBRIk (k>0) may correspond to the (k+1)^{th} entry among csi-SSB-ResourceList within CSI-SSB-ResourceSet for channel measurement, and may be connected to the (k+1)th entry among csi-IM-Resource within csi-IM-ResourceSet within csi-IM-ResourceSet, or the (k+1)th entry among nzp-CSI-RS-Resources within NZP-CSI-RS-ResourceSet for interference measurement.

In case that the UE has reportQuantity in CSI-ReportConfig (upper layer signaling) configured as “cri-RSRP”, “cri-SINR”, or “none”, and in case that CSI-ReportConfig is connected to a resource setting having resourceType (upper layer signaling) configured as “aperiodic”, the UE may not expect that more than 16 CSI-RS resources will be configured in the CSI-RS resource set included in the corresponding resource setting.

The equation regarding priority rules described above may be considered like PriiCSI (y, k, c, s)=2·Ncells·Ms·y+Ncells·Ms·k+Ms·c+s, and in the case of a CSI report including an L1-SINR report, k=0 may be considered.

The Table 38 below shows the order of arrangement of information during L1-SINR reporting. The bit length of CRI and SSBRI may be defined as a bit number that may express the number of CSI-RS resources in a CSI-RS resource set

$$( e . g . , ⌈ {log}_{2} ( {K}_{S}^{CSI - RS} ) ⌉ ) ,$$

or a bit number that may express the number of SSB resources in an SSB resource set

$$( e . g . , ⌈ {log}_{2} ( {K}_{S}^{S S B} ) ⌉ ) .$$

In this regard,

$${K}_{S}^{CSI - RS} and {K}_{S}^{S S B}$$

may refer to the number of CSI-RS resources within a CSI-RS resource set and the number of SSB resources within an SSB resource set, respectively. As described above, the SINR and the differential SINR may be expressed with 7 bits and 4 bits, respectively.

TABLE 38

| CSI report number | CSI fields |
|---|---|
| CSI report #n | CRI or SSBRI #1 |
| | CRI or SSBRI #1 |
| | CRI or SSBRI #1 |
| | CRI or SSBRI #1 |
| | SINR #1 |
| | Differential SINR #2 |
| | Differential SINR #3 |
| | Differential SINR #4 |

In an embodiment of the disclosure, a CSI reporting event started by the UE and reported information will be described. This embodiment may operate in combination with other embodiments.

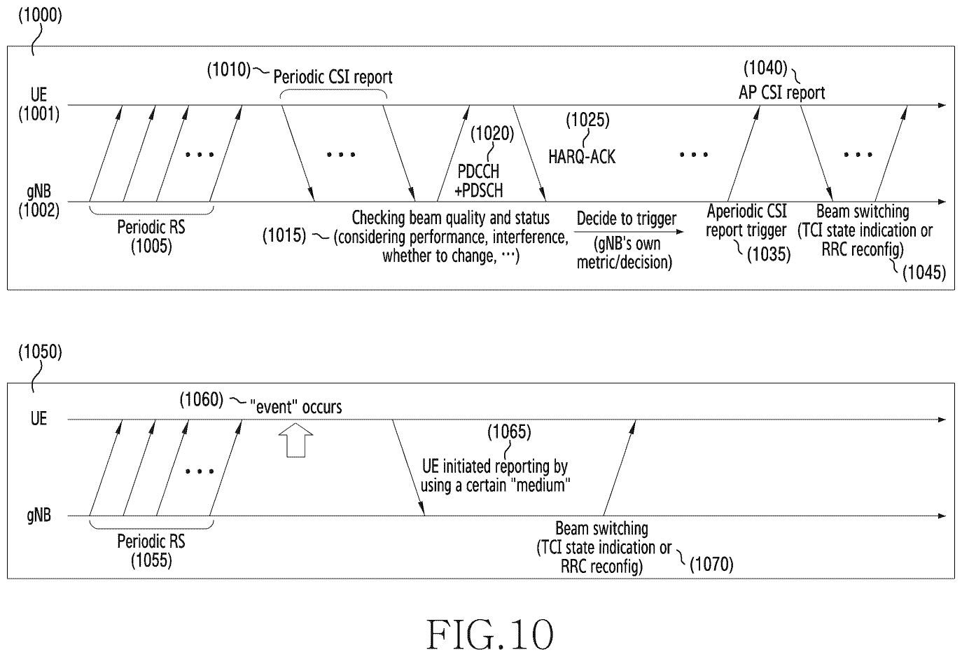

FIG. 10 illustrates a channel measurement and channel state reporting scheme according to a base station's configurations and instructions in a wireless communication system according to an embodiment of the disclosure.

Referring to FIG. 10, process 1000 may describe a scheme for securing and managing the performance of downlink beams between a UE and a base station, according to a scheme regarding the UE's periodic reference signal reception and periodic channel state information reporting, or/and the base station's non-periodic channel state information reporting trigger and the UE's non-periodic channel state information reporting.

The base station 1002 may notify the UE 1001 of configuration information regarding periodic reference signal reception and periodic channel state information reporting corresponding thereto, through upper layer signaling. Accordingly, the UE may receive a periodic reference signal transmitted from the base station (1005), and may report periodic channel state information corresponding thereto (1010). The periodic channel state information reported by the UE may include the performance of a downlink reception beam calculated by the UE. The base station may identify the UE's downlink reception beam performance, based on the UE's periodic reference signal measurement and periodic channel state information reporting. The shorter the periodicity of reference signal reception and measurement, and channel state information reporting, the more accurately the UE's downlink reception beam performance may be identified, but a large amount of signaling overhead may be consumed regarding reference signal transmission and/or reception between the UE and the base station, and channel state information report transmission and/or reception. On the other hand, if the periodicity of reference signal reception and measurement and channel state information reporting is long, the base station may relatively inaccurately identify the UE's reception beam performance. Therefore, the base station may trigger aperiodic channel state information reporting to identify the reception beam performance of the UE in the middle of the long periodicity (1035). Thereafter, the UE may perform aperiodic channel state information reporting corresponding to aperiodic channel state information reporting triggering by the base station (1040), and the base station may aggregate pieces of information included in the aperiodic channel state information report, and if the beam performance of the UE's downlink reception beam is insufficient and thus requires a change to another beam, the base station may notify the UE of beam switching (1045). In addition, beam switching may be performed by a method such as RRC reconfigurations for changing the TCI state indicated to the UE, or changing configurations regarding the source RS inside the TCI state.

In order to trigger aperiodic channel state information reporting to the UE, the base station may acquire implicit information from the UE in order to determine that the UE should report aperiodic channel state information, through base station implementation. The implicit information may be information regarding the channel state, and for example, the implicit information may include a PDCCH transmitted by the base station to the UE and a PDSCH received, which may be scheduled through the PDCCH (1020), or a PUCCH transmitted from the UE, which includes HARQ-ACK information indicating whether the PDSCH has been successfully received (1025). The base station may determine whether the UE needs to change the downlink reception beam or, if not, whether the current reception beam may be maintained, based on information included in the periodic channel state information report that may be received from the UE (1010), the PUCCH 1025 including HARQ-ACK information corresponding to the PDSCH scheduled for the UE, and the like (1015). However, the information received from the UE may be implicit information or, even in the case of explicit information, may not be information that the base station can obtain as desired. Therefore, the information acquired by the base station regarding the downlink reception beam performance of the UE may be insufficient in terms of absolute amount, or may be past information.

In FIG. 10, process 1050 relates to a scheme regarding transmission and/or reception between the UE and the base station, beam performance assurance and management according to a channel state information reporting scheme initiated from the UE according to a specific event occurring in the UE.

In order to solve the problems in the above-described process 1000, the base station may notify the UE of configuration information regarding a channel state information reporting scheme initiated by the UE, based on a combination of at least one of upper layer signaling, MAC-CE signaling, and Li signaling. Based on configuration information received from the base station, the UE may receive a combination of at least one of a periodic reference signal, a semi-persistent reference signal, and an aperiodic reference signal (1055). As a specific event defined by the UE occurs (1060), the UE may perform channel state information reporting started by the UE (or initiated by the UE) (1065). Thereafter, the base station may indicate beam switching to the UE, based on the information transferred from the UE (1070).

According to such a channel state information reporting scheme started by the UE, the transfers the UE's downlink reception beam performance in a self-determined manner (for example, without the base station's channel state information reporting triggered), unlike the base station triggering aperiodic channel state information reporting based on implicitly information, or notifying of beam switching. According to this scheme, even if the base station does not trigger (channel state information reporting or beam switching), in case that the UE's downlink reception beam performance is changed by a specific event defined by the UE, the base station may immediately identify the change in downlink reception beam performance, and may take a corresponding action (for example, triggering aperiodic channel state information reporting or indicating beam switching). According to the channel state information report started by the UE, the base station may immediately respond to a case in which the downlink reception beam needs to be changed, thereby reducing the delay time regarding beam management. In addition, by reducing the periodicity of periodic reference signal reception and periodic channel state information reporting between the UE and the base station, the signaling overhead regarding reference signal and channel state information reporting may be significantly reduced, unlike methods in which the base station may quickly identify the UE's downlink reception beam performance without channel state information reporting started by the UE.

For the above-described channel state information reporting scheme started by the UE, in case that the UE has defined a specific event 1060, and in case that the event occurs, the UE needs to inform the base station that the performance of the UE's downlink reception beam has changed. The UE may define a specific event for performing channel state information reporting started by the UE as described above. As the specific event for initiating the UE's channel state information reporting, any one of the following items, or a combination of at least two thereof may be considered. Obviously, the following example is not limiting.

### [Event 1]

In case that a new reception beam having a performance indicator higher than the current reception beam's performance by a specific reference value or more, the UE may perform channel state information reporting started by the UE, which includes new reception beam information. With regard to corresponding [event 1], the new reception beam and the current reception beam may be defined as follows.
With regard to [event 1], the new reception beam may be configured for the UE through upper layer signaling.
   As used herein, configuring a new reception beam for the UE through upper layer signaling may mean that a reference signal corresponding to the new reception beam is configured for the UE through upper layer signaling.
   Therefore, in the following description, a new reception beam configured may be understood as a reference signal corresponding to the new reception beam being configured. In addition, the UE's measuring a new reception beam may be understood as the UE's measuring a reference signal corresponding to the new reception beam. The UE may consider a CSI-RS or SSB as a reference signal for a new reception beam.
   In case that the UE has a new reception beam configured through upper layer signaling, a set of reference signals, including one or more reference signals that may indicate the new reception beam may be configured in upper layer signaling (for example, CSI-ReportConfig) related to the above-described channel state information reporting started by the UE.
   For example, in case that the UE and the base station consider a CSI-RS as a reference signal for a new reception beam, the UE may have a CSI-RS resource set including one or more CSI-RS resources configured as a set of new reception beams.
   In addition, in case that the UE and the base station consider the SSB as a reference signal for a new reception beam, the UE may have an SSB resource set including one or more SSB resources configured as a set of new reception beams.
With regard to [event 1], the current reception beam may be determined by considering the following items.
   [Current reception beam determination scheme 1] The UE may define the current reception beam as a reference signal configured as a QCL source in an integrated TCI state indicated and applied to the UE.
   [Current reception beam determination scheme 2] The UE may define the current reception beam as an SSB having a QCL relationship with the reference signal configured as the QCL source.
   The description that the current reception beam is defined as a specific reference signal may be understood as meaning that the UE may determine parameters to be used as a reception beam or a reception filter corresponding to the current reception beam, based on the specific reference signal received. Alternatively, the description that the current reception beam is defined as a specific reference signal may be interpreted as meaning that, when the UE measures and determines the performance of the current reception beam, the UE will measure the performance of a specific reference signal that the UE can receive, and will determine the performance of the current reception beam, based on the measured performance. The specific method for determining the current reception beam may correspond to one of the following methods or a combination of two or more thereof.
   In case that only one reference signal is configured as a QCL source in the integrated TCI state indicated and applied to the UE, that is, in case that a QCL source regarding QCL-TypeA, B, or C is configured in the corresponding TCI state, and no QCL source regarding QCL-TypeD is configured, the UE may use the reference signal configured as the QCL source regarding QCL-TypeA, B, or C when determining the current reception beam.
   In case that multiple reference signals are configured as a QCL source in the integrated TCI state indicated and applied to the UE, for example, in case that sQCL sources regarding not only QCL-TypeA, B, or C, but also QCL-TypeD are configured in the TCI state, the UE may use a reference signal configured as a QCL source regarding QCL-TypeD instead of a reference signal configured as a QCL source regarding QCL-TypeA, B, or C when determining the current reception beam. For example, in case that TCI states indicated to and applied to the UE have a reference signal configured as a QCL source regarding QCL-TypeA and a reference signal configured as a QCL source regarding QCL-TypeD, respectively, (e.g., in case that two reference signals are configured as QCL sources regarding QCL-TypeA and QCL-TypeD, respectively), the description that the UE identifies the performance of a reference signal configured as a QCL source regarding the TCI state indicated to and applied thereto may mean that the UE identifies the performance of the reference signal configured as a QCL source regarding QCL-TypeD.
   The UE may consider a CSI-RS as a reference signal that may be configured as the QCL source. The CSI-RS considered as the reference signal by the UE may be a tracking reference signal (TRS) having trs-info (upper layer signaling) configured therefor, a CSI-RS for beam management having repetition (upper layer signaling) configured as on or off, or a CSI-RS for CSI having neither of trs-info and repetition (upper layer signaling) configured therefor. In addition, the UE may consider only a TRS as a reference signal that may be configured as the QCL source, may consider only a CSI-RS for beam management, or may consider both a TRS and a CSI-RS for beam management. In addition, in case that a CSI-RS which is a reference signal configured as a QCL source is defined as a specific CSI-RS resource, the CSI-RS resource may be included in a CSI-RS resource set having trs-info (upper layer signaling) configured as “true”, and/or the CSI-RS resource may be configured in a CSI-RS resource set having repetition (upper layer signaling) configured therefor.

With regard to [event 1], the UE may expect that the type of the current reception beam and that of the new reception beam will be maintained identical. The UE may have the new reception beam configured through upper layer signaling as described above. According to the configuration, in case that the type of the new reception beam is a CSI-RS, the UE may use the above-described [current reception beam determination scheme 1] in determining the current reception beam. In addition, in case that the type of the new reception beam is an SSB, the UE may use the above-described [current reception beam determination scheme 2] in determining the current reception beam.
With regard to [event 1], a specific reference value used to compare the performance of the new reception beam and the current reception beam may be reported to the base station by the UE as UE capability, or may be configured for the UE by the base station through upper layer signaling. Alternatively, the base station may select one from one or more values reported to the base station as UE capability and may configure the same for the UE through upper layer signaling. Alternatively, the specific reference value may be a value fixedly defined in specifications.
In connection with determining whether [event 1] occurs or not, the UE may consider single-event-based determination and multiple-event-based determination. The UE may report, through UE capability, a single-event-based determination scheme as the basic determination scheme regarding [event 1], and the multi-event-based determination scheme may be used as the determination scheme regarding [event 1] only when the UE reports additional UE capability. In the case of single-event-based determination, the UE may determine the performance of the new reception beam and the current reception beam by receiving a reference signal corresponding to the new reception beam and a reference signal corresponding to the current reception beam only once. During single event-based determination, the UE may determine whether [event 1] has occurred or not at each reception location of a new reception beam existing thereafter, in a state in which the performance of the current reception beam is known.
With regard to [event 1], for multi-event-based determination, the UE may introduce a specific time interval and a counter in order to determine that the performance of the new reception beam is higher than the reception performance of the current reception beam by a specific reference value or more. By using a time interval starting based on a timepoint at which information regarding the current reception beam is identified, the UE may determine whether [event 1] occurs or not at a timepoint within the time interval. The timepoint at which information regarding the current reception beam is identified may be a timepoint at which the currently indicated TCI state is applied, or a timepoint at which a reference signal (which is a CSI-RS or SSB according to the above description) corresponding to the current reception beam is received after the timepoint at which the currently indicated TCI state is applied. The length of the time interval may correspond to a frame, subframe, slot, symbol, or absolute time (e.g., msec) having the periodicity value of the reference signal corresponding to the current reception beam, or a real number value which is shorter or longer than the same. The length of the time interval may be configured for the UE through upper layer signaling from the base station. The UE may reset the corresponding time interval whenever a reference signal corresponding to the current reception beam is received, or at a timepoint at which the time interval is terminated. Within the corresponding time interval, the UE may receive a reference signal (e.g., CSI-RS or SSB) corresponding to each of one or more new reception beams. In case that [event 1] occurs a specific number of times or more with regard to a specific new reception beam within the corresponding time interval, the UE may report the reception beam performance to the base station. In addition, the UE may store the number of times [event 1] continuously occurs in the time interval, from the starting point of the time interval, in the above-described counter. Upon confirming that the value of the corresponding counter is larger than a specific number of times, the UE may report the reception beam performance to the base station. The number of times [event 1] continuously occurs may mean a case in which the performance of a specific new reception beam is higher than that of the current reception beam by a specific reference value or more. For example, in case that respective performances of two different new reception beams are higher than that of the current reception beam by a specific reference value or more, the UE may consider that [event 1] has occurred once for each new reception beam. The UE may identify whether [event 1] occurs or not at each periodicity of the current reception beam, in the corresponding time interval. In case that [event 1] has continuously occurred within the time interval, but has not yet occurred more than a specific number of times, and in case that [event 1] does not occur at a specific periodicity of the current reception beam, and the number of times [event 1] has continuously occurred accordingly fails to exceed the specific number of times, the UE may reset the last timepoint of the specific periodicity regarding the current reception beam to the starting point of the time interval. In this manner, the UE may identify the number of times [event 1] continuously occurs during a specific time interval, and may report the reception beam performance started by the UE to the base station. In an embodiment, the specific number of times may be 1 by default, and the UE may have X (a specific natural number greater than 1) configured therefor by the base station. In an embodiment, the UE may report, to the base station, UE capability meaning that the UE regards the specific number of times as 1 or as X (a specific natural number greater than 1). Thereafter, the base station may configure a specific number of times for the UE, based on the UE capability received from the UE. In response, the UE may finally determine a specific number of times, based on configurations received from the base station. In another embodiment, the UE may report, to the base station, UE capability meaning that the UE regards the specific number of times as 1 or as X (a specific natural number greater than 1). In addition, upon receiving the UE capability, the base station may determine or use the same value reported by the UE through UE capability as the specific number of times, without additional upper layer signaling configuration for the corresponding UE.
With regard to [event 1], in case that the UE reports reception beam performance started from the UE, the UE may include at least one of the following items in the report to the base station.
   The UE may include the index of the new reception beam and/or the performance of the new reception beam in the report to the base station. The UE may have the number of new reception beams, the performance of which is to be reported to the base station, configured by the base station through upper layer signaling. For example, the UE may have the number of new reception beams to be reported by the UE, configured by the base station. The number of new reception beams to be reported may be N, which is a natural number greater than or equal to 1. More specifically, N may be 1, 2, 3, or 4, or a natural number equal to or less than 64. The number of new reception beams to be reported by the UE may follow the above-described upper layer signaling. In addition, in case that the reception beam performance report started from the UE includes the index of each of N new reception beams, the index of each new reception beam may be expressed by ceil(log 2(K)) bits, ceil(.) and log 2(.) may represent a ceiling function and a logarithmic function with a base of 2, respectively, and M may represent the number of new reception beams configured in the new reception beam set. In case that the type of a new reception beam is CSI-RS, K may refer to the number of CSI-RS resources configured in a CSI-RS resource set, and in case that the type of a new reception beam is SSB, K may refer to the number of SSB resources configured in an SSB resource set.
   In case of reporting the N new reception beams, the UE may expect that at least one of the N new reception beams will satisfy [event 1] above. For example, the UE may assume that the performance of some of the N new reception beams is higher than the performance of the current reception beam by a specific reference value or more. In addition, the UE may assume that the performance of remaining new reception beams other than some new reception beams having a performance higher than the performance of the current reception beam by a specific reference value or more is not higher than the performance of the current reception beam by a specific reference value or more.
   The UE may report the L1-RSRP value of the best performing new reception beam among the N new reception beams by quantizing the value of 1 dB unit from −140 dBm to −44 dBm with a total of 7 bits. In addition, the UE may express the performance of the remaining (N−1) new reception beams as a difference value from the performance of the new reception beam having the largest L1-RSRP value (which may refer to a differential L1-RSRP value, for example), and may quantize the differential L1-RSRP value of 2 dB unit by a total of 4 bits.
   The UE may include the index of the current reception beam and/or the performance of the current reception beam in the report to the base station. As used herein, the current reception beam's index may be the CSI-RS resource index in case that the current reception beam is a CSI-RS, as described above, or may be the SSB index in case that the current reception beam is an SSB. The UE may be configured by the base station through upper layer signaling regarding whether to include the index of the current reception beam and/or the performance of the current reception beam in the report to the base station. For example, in case that the UE has upper layer signaling configured by the base station, the UE may include the index of the current reception beam and/or the performance of the current reception beam in the report of reception beam performance started from the UE. In case that case that the UE has no upper layer signaling configured by the base station, the UE may not include the index of the current reception beam and/or the performance of the current reception beam in the report of reception beam performance started from the UE, which includes only the index of the new reception beam index and/or the performance value of the new reception beam.
In case of including the performance (e.g., L1-RSRP performance) of the current reception beam in the report to the base station, the UE may express the L 1-RSRP performance of the current reception beam as a difference value (e.g., a differential L1-RSRP value) from the performance of the best performing new reception beam, and may quantize the differential L1-RSRP value of 2 dB unit with a total of 4 bits. In addition, the UE may report the L1-RSRP performance of the current reception beam by quantizing the value of 1 dB unit from −140 dBm to −44 dBm with a total of 7 bits. The UE's reporting method described above is only an example, and the disclosure is not limited by the above example.

### [Event 2]

In case that the performance of the current reception beam is equal to or less than a specific reference value, the UE may perform channel state information reporting started by the UE (or initiated by the UE), including current reception beam information.
With regard to [event 2], the new reception beam may be configured for the UE through upper layer signaling.
   As used herein, configuring a new reception beam for the UE through upper layer signaling may mean that a reference signal corresponding to the new reception beam is configured for the UE through upper layer signaling.
   Therefore, in the following description, a new reception beam configured may be understood as a reference signal corresponding to the new reception beam being configured. In addition, the UE's measuring a new reception beam may be understood as the UE's measuring a reference signal corresponding to the new reception beam. The UE may consider a CSI-RS or SSB as a reference signal for a new reception beam.
   In case that the UE has a new reception beam configured through upper layer signaling, a set of reference signals, including one or more reference signals that may indicate the new reception beam may be configured in upper layer signaling (for example, CSI-ReportConfig) related to the above-described channel state information reporting started by the UE.
   For example, in case that the UE and the base station consider a CSI-RS as a reference signal for a new reception beam, the UE may have a CSI-RS resource set including one or more CSI-RS resources configured as a set of new reception beams.
   In addition, in case that the UE and the base station consider the SSB as a reference signal for a new reception beam, the UE may have an SSB resource set including one or more SSB resources configured as a set of new reception beams.
With regard to [event 2], the UE may not define a new reception beam. That is, the UE may perform reception beam performance reporting started by the UE related to [event 2], based only on the definition of the current reception beam.
With regard to [event 2], the current reception beam may be determined by one of [current reception beam determination scheme 1] or [current reception beam determination scheme 2], similarly to [event 1] described above.
   In case that the UE has no new reception beam-related upper layer signaling configured regarding [event 2], the UE may determine the type of the current reception beam (one of CSI-RS or SSB) not through new reception beam-related upper layer signaling, but by having individual upper layer signaling configured therefor. For example, the UE may have upper layer signaling configured by the base station, which provides information regarding the type of the current reception beam. For example, the UE may receive configuration information related to the type of current reception beam in CSI-ReportConfig which is upper layer signaling related to reception beam performance reporting started by the UE. The configuration location is only an example and is not limiting. In addition, the above-described configuration information may be configured in upper layer signaling related to the serving cell in which the UE is operating, the bandwidth part, and the serving cell in which the UE reports the reception beam performance started from the UE.
In case that the UE receives a new reception beam-related upper layer signaling configuration regarding [event 2], the UE may expect that the current reception beam and the new reception beam will remain of the same type, according to in which type the new reception beam is configured, similarly to [event 1]. The UE may have the new reception beam configured through upper layer signaling as described above. In addition, according to the new reception beam-related configuration, in case that the type of the new reception beam is CSI-RS, the UE may use the above-described [current reception beam determination scheme 1] in determining the current reception beam. In addition, in case that the type of the new reception beam is SSB, the UE may use the above-described [current reception beam determination scheme 2] in determining the current reception beam.
With regard to [event 2], the specific reference value used to identify the performance of the current reception beam may be reported to the base station by the UE as UE capability, or may be configured for the UE by the base station through upper layer signaling. Alternatively, the base station may select one from one or more values reported to the base station as UE capability and may configure the same for the UE through upper layer signaling. Alternatively, the specific reference value may be a value fixedly defined in specifications. The UE may also define different individual specific reference values according to the type of the current reception beam.
In connection with determining whether [event 2] occurs or not, the UE may consider single-event-based determination and multiple-event-based determination. The UE may report, through UE capability, a single-event-based determination scheme as the basic determination scheme regarding [event 2], and the multi-event-based determination scheme may be used as the determination scheme regarding [event 2] only when the UE reports additional UE capability. In the case of single-event-based determination, the UE may determine the performance of the current reception beam by receiving a reference signal corresponding to the current reception beam only once. During single event-based determination, the UE may determine whether [event 2] has occurred or not at each reception location of the current reception beam. For example, the UE may measure the performance of the current reception beam at each reception location of the current reception beam, and may compare the same with the above-described specific reference value. In addition, in case that the performance of the current reception beam is lower than a specific reference value, the UE may determine that [event 2] has occurred during the single-event based determination, and may then perform reception beam performance reporting started from the UE.
With regard to [event 2], the UE may introduce a specific time interval and a counter in order to determine that the performance of the current reception beam is equal to or less than a specific reference value. By using a time interval starting based on a timepoint at which information regarding the current reception beam is identified, the UE may determine whether [event 2] occurs or not at a timepoint within the time interval. The timepoint at which information regarding the current reception beam is identified may be a timepoint at which the currently indicated TCI state is applied, or a timepoint at which a reference signal (which is a CSI-RS or SSB according to the above description) corresponding to the current reception beam is received after the timepoint at which the currently indicated TCI state is applied. The length of the time interval may correspond to a frame, subframe, slot, symbol, or absolute time (e.g., msec) having the periodicity value of the reference signal corresponding to the current reception beam, or a real number value which is shorter or longer than the same. The length of the time interval may be configured for the UE through upper layer signaling from the base station. The UE may identify the occurrence of [event 2] during the length of the time interval from the starting point of the time interval. The UE may store the number of times [event 2] occurs within the time interval from the starting point of the time interval. Upon confirming that the counter's value is larger than a specific number of times, the UE may report the reception beam performance to the base station. In addition, the UE may store the number of times [event 2] continuously occurs in the time interval, from the starting point of the time interval, in the above-described counter. Upon confirming that the value of the corresponding counter is larger than a specific number of times, the UE may report the reception beam performance to the base station. The UE may identify whether [event 2] occurs or not at each periodicity of the current reception beam, in the corresponding time interval. In case that [event 2] has continuously occurred within the time interval, but has not yet occurred more than a specific number of times, and in case that [event 2] does not occur at a specific periodicity of the current reception beam, and the number of times [event 2] has continuously occurred accordingly fails to exceed the specific number of times, the UE may reset the last timepoint of the specific periodicity of the current reception beam to the starting point of the time interval. In this manner, the UE may identify the number of times [event 2] continuously occurs during a specific time interval, and may report the reception beam performance started by the UE to the base station. The specific number of times may be 1 by default, and the UE may have X (a specific natural number greater than 1) configured therefor by the base station. In an embodiment, the UE may report, to the base station, UE capability meaning that the UE regards the specific number of times as 1 or as X (a specific natural number greater than 1). Thereafter, the base station may configure a specific number of times for the UE, based on the UE capability received from the UE. In response, the UE may finally determine a specific number of times, based on configurations received from the base station. In another embodiment, the UE may report, to the base station, UE capability meaning that the UE regards the specific number of times as 1 or as X (a specific natural number greater than 1). In addition, upon receiving the UE capability, the base station may determine or use the same value reported by the UE through UE capability as the specific number of times, without additional upper layer signaling configuration for the corresponding UE.
In case that [event 2] has occurred, the UE may consider at least one of the following items when reporting the reception beam performance started from the UE to the base station.
   (Alt1) The UE may not report the reception beam performance started from the UE to the base station. That is, the UE may report to the base station that [event 2] has occurred, but may not subsequently report the performance (e.g., L1-RSRP or L1-SINR) of the new reception beam or/and the current reception beam. The base station may recognize the fact that [event 2] has occurred by receiving a PUCCH transmitted by the UE, and the base station may thereby recognize the fact that the performance of the current reception beam of the UE is lower than a specific reference value that is commonly understood by the UE and the base station.
   (Alt2) In another method, the UE may determine whether to perform reception beam performance reporting started from the UE, according to upper layer signaling is configured to instruct the UE to report the index of the current reception beam or/and the performance of the current reception beam performance to the base station.
In case that the UE does not have the above-described upper layer signaling configured therefor, the UE may not perform reception beam performance reporting started from the UE to the base station. That is, the UE may report the occurrence of [event 2] to the base station, but may not subsequently report the performance (e.g., L1-RSRP or L1-SINR) of the new reception beam and/or the current reception beam. The base station may recognize the fact that [event 2] has occurred by receiving a PUCCH transmitted by the UE, and may thereby recognize the fact that the performance of the current reception beam of the UE is lower than a specific reference value commonly understood by the UE and the base station.
In case that the UE has the above-described upper layer signaling configured therefor, the UE the UE may perform reception beam performance reporting started by the UE to the base station, and the reception beam performance reporting started from the UE may include the index of the current reception beam and/or the performance of the current reception beam. The index of the current reception beam may be a CSI-RS resource or an SSB index. The UE may report the L1-RSRP performance of the current reception beam by quantizing the value of 1 dB unit from −140 dBm to −44 dBm with a total of 7 bits. In another method, when reporting the L1-RSRP performance of the current reception beam, the UE may express the same as a difference value (which may refer to a differential L1-RSRP value) from the specific reference value, and may quantize the differential L1-RSRP value of 2 dB unit with a total of 4 bits. In addition, the UE's reporting method described above is only an example, and the disclosure is not limited by the above-described example.
   (Alt3) As another method, when reporting the reception beam performance started from the UE, the UE may include index of the current reception beam index or/and the performance of the current reception beam in the report, according to whether the UE has upper layer signaling configured to instruct the UE to report the index of the current reception beam or/and the performance of the current reception beam performance to the base station. In addition, the UE has upper layer signaling regarding the new reception beam configured with regard to [event 2], the UE may include index of the current reception beam index or/and the performance of the current reception beam in the report. In addition, reporting the reception beam performance started from the UE, the UE may include the number of times the performance of the current reception beam has fallen below the specific reference value within a specific time interval configured for the UE through upper layer signaling.
      In case that the UE has upper layer signaling configured to instruct the UE to report the index of the current reception beam or/and the performance of the current reception beam performance to the base station, the UE may report the L1-RSRP performance of the current reception beam by quantizing the value of 1 dB unit from −140 dBm to −44 dBm with a total of 7 bits. Alternatively, when reporting the L1-RSRP performance of the current reception beam, the UE may express the same as a difference value (which may refer to a differential L1-RSRP value) from the specific reference value, and may quantize the differential L1-RSRP value of 2 dB unit with a total of 4 bits.
      The UE may consider that the performance of the new reception beam, the above-described specific criterion value, and the performance of the current reception beam are irrelevant to each other. In other words, when reporting reception beam performance started from the UE, based on [event 2], the UE may report the performance of as many (e.g., N) new reception beams as the number of best performing new reception beams configured by the base station at the timepoint of reporting, among all new reception beams configured for the UE by the base station. The UE may report the L1-RSRP value of the best-performing new reception beam among the N new reception beams, by quantizing the value in 1 dB unit from −140 dBm to −44 dBm with a total of 7 bits. In addition, the UE may express the performance of the remaining (N−1) new reception beams as a difference value (which may refer to a differential L1-RSRP value) from the performance of the new reception beam having the largest L1-RSRP value, and may quantize the differential L1-RSRP value of 2 dB unit with a total of 4 bits. In addition, when expressing the performance of the N new reception beams, the UE may use a differential L1-RSRP value, which is a difference value from the above-described specific reference value, and may add one bit to express a sign to indicate a performance higher or lower than the specific reference value. For example, a new reception beam which has a performance higher than a specific reference value may have a 1-bit value of 1, and a new reception beam which has a performance lower than the specific reference value may have a 1-bit value of 0. In addition, when expressing the performance of all of the N new reception beams, the UE may use a differential L1-RSRP value which is a difference value from the current reception beam's performance. The UE may add one bit to express a sign to indicate a performance higher or lower than the specific reference value. For example, a new reception beam which has a performance higher than a specific reference value may have a 1-bit value of 1, and a new reception beam which has a performance lower than the specific reference value may have a 1-bit value of 0.

### [Event 3]

In case that the performance of at least one new reception beam is higher than that of the current reception beam by a specific reference value or more, the UE may perform channel state information reporting started by the UE, including new reception beam information. With regard to [event 3], the new reception beam and the current reception beam may be defined as follows:

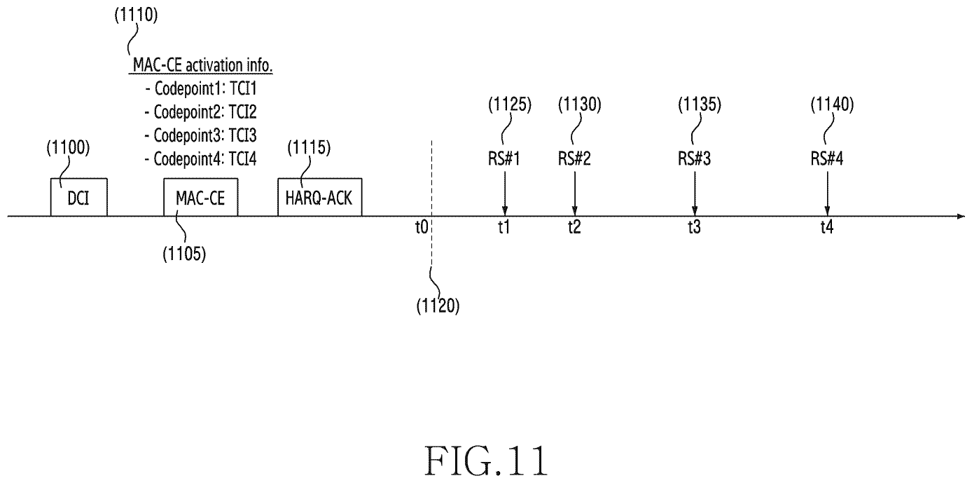

With regard to [event 3], the new reception beam may be configured for the UE through upper layer signaling.
As used herein, configuring the new reception beam for the UE through upper layer signaling may mean that a reference signal corresponding to the new reception beam is configured for the UE through upper layer signaling.
Therefore, in the following description, configuration of a new reception beam may be understood as configuration of a reference signal corresponding to the new reception beam. In addition, the UE's measurement of the new reception beam may be understood as the UE's measurement of a reference signal corresponding to the new reception beam. The UE may consider a CSI-RS or an SSB as a reference signal for a new reception beam.
In case that the UE has a new reception beam configured therefor through upper layer signaling, the UE may have a reference signal set including one or more reference signals, which may indicate the new reception beam, configured in upper layer signaling (e.g., CSI-ReportConfig) related to channel state information reporting started by the UE.
For example, in case that the UE and the base station consider a CSI-RS as a reference signal for a new reception beam, the UE may have a CSI-RS resource set including one or more CSI-RS resources configured therefor as a set of new reception beams.
In addition, in case that the UE and the base station consider an SSB as a reference signal for a new reception beam, the UE may have an SSB resource set including one or more SSB resources configured therefor as a set of new reception beams.
With regard to [event 3], the current reception beam may be determined by considering the following items:
The UE may define the current reception beam such that, among reference signals configured as QCL sources associated with one or more TCI states activated for the UE, the Q^{th} best-performing reference signal is determined as the same. More specifically, the UE may define the current reception beam, based on the following two schemes:
   [Current reception beam determination scheme 3] Among reference signals configured as QCL sources within one or more TCI states activated for the UE, the Qth best-performing reference signal may be determined by the UE as the current reception beam.
   [Current reception beam determination scheme 4] Among SSBs having a QCL relationship with respective reference signals configured as QCL sources within one or more TCI states activated for the UE, the Qth best-performing reference signal may be determined by the UE as the current reception beam.
   The UE may report one Q value to the base station through UE capability, and the base station may otherwise consider that the UE does not support the aforementioned [event 3]. In case that the UE has reported one Q value, the base station may configure the corresponding Q value so that the UE may perform reception beam performance reporting started from the UE, based on [event 3].
The description that the current reception beam is defined as a specific reference signal may be understood as meaning that the UE may determine parameters to be used as a reception beam or a reception filter corresponding to the current reception beam, based on the specific reference signal received. Alternatively, the description that the current reception beam is defined as a specific reference signal may be interpreted as meaning that, when the UE measures and determines the performance of the current reception beam, the UE will measure the performance of a specific reference signal that the UE can receive, and will determine the performance of the current reception beam, based on the measured performance. The specific method for determining the current reception beam may correspond to a combination of one or more of the following methods.
In case that one reference signal is configured as a QCL source in the integrated TCI state indicated and applied to the UE, that is, in case that a QCL source regarding QCL-TypeA, B, or C is configured in the corresponding TCI state, and no QCL source regarding QCL-TypeD is not configured, the UE may use the reference signal configured as the QCL source regarding QCL-TypeA, B, or C when determining the current reception beam.
In case that multiple reference signals are configured as a QCL source in the integrated TCI state indicated and applied to the UE, for example, in case that sQCL sources regarding not only QCL-TypeA, B, or C, but also QCL-TypeD are configured in the TCI state, the UE may use a reference signal configured as a QCL source regarding QCL-TypeD instead of a reference signal configured as a QCL source regarding QCL-TypeA, B, or C when determining the current reception beam. For example, in case that TCI states indicated to and applied to the UE have a reference signal configured as a QCL source regarding QCL-TypeA and a reference signal configured as a QCL source regarding QCL-TypeD, respectively, (e.g., in case that two reference signals are configured as QCL sources regarding QCL-TypeA and QCL-TypeD, respectively), the description that the UE identifies the performance of a reference signal configured as a QCL source regarding the TCI state indicated to and applied thereto may mean that the UE identifies the performance of the reference signal configured as a QCL source regarding QCL-TypeD.
The UE may consider a CSI-RS as a reference signal that may be configured as the QCL source. The CSI-RS may be a TRS having trs-info (upper layer signaling) configured therefor, a CSI-RS for beam management having repetition (upper layer signaling) configured as on or off, or a CSI-RS for CSI having neither of trs-info and repetition (upper layer signaling) configured therefor. In addition, the UE may consider only a TRS as a reference signal that may be configured as the QCL source, may consider only a CSI-RS for beam management, or may consider both a TRS and a CSI-RS for beam management. In addition, in case that a CSI-RS which is a reference signal configured as a QCL source is defined as a specific CSI-RS resource, the CSI-RS resource may be included in a CSI-RS resource set having trs-info (upper layer signaling) configured as “true”, and/or the CSI-RS resource may be configured in a CSI-RS resource set having repetition (upper layer signaling) configured therefor.
With regard to [event 3], the UE may expect that the type of the current reception beam and that of the new reception beam will be maintained identical. The UE may have the new reception beam configured therefor through upper layer signaling as described above. According to the configuration, in case that the type of the new reception beam is a CSI-RS, the UE may use the above-described [current reception beam determination scheme 3] in determining the current reception beam. In addition, in case that the type of the new reception beam is an SSB, the UE may use the above-described [current reception beam determination scheme 4] in determining the current reception beam.
With regard to [event 3], a specific reference value used to compare the performance of the new reception beam and the current reception beam may be reported to the base station by the UE as UE capability, or may be configured for the UE by the base station through upper layer signaling. Alternatively, the base station may select one from one or more values reported to the base station as UE capability and may configure the same for the UE through upper layer signaling. Alternatively, the specific reference value may be a value fixedly defined in specifications.
With regard to [event 3], in case that the UE reports reception beam performance started from the UE, the UE may include at least one of the following items in the report to the base station.
(Alt1 new reception beam) The UE may include the index of the new reception beam and/or the performance of the new reception beam in the report to the base station. The UE may have the number of new reception beams, the performance of which is to be reported to the base station, configured by the base station through upper layer signaling. For example, the UE may have the number of new reception beams to be reported by the UE, configured by the base station. The number of new reception beams to be reported may be N, which is a natural number greater than or equal to 1. More specifically, N may be 1, 2, 3, or 4, or a natural number equal to or less than 64. The number of new reception beams to be reported by the UE may follow the above-described upper layer signaling. In addition, in case that the reception beam performance report started from the UE includes the index of each of N new reception beams, the index of each new reception beam may be expressed by ceil(log 2(K)) bits, ceil(.) and log 2(.) may represent a ceiling function and a logarithmic function with a base of 2, respectively, and M may represent the number of new reception beams configured in the new reception beam set. In case that the type of a new reception beam is CSI-RS, K may refer to the number of CSI-RS resources configured in a CSI-RS resource set, and in case that the type of a new reception beam is SSB, K may refer to the number of SSB resources configured in an SSB resource set.
(Alt1 new reception beam) In case of reporting the N new reception beams, the UE may expect that at least one of the N new reception beams will satisfy [event 3] above. For example, the UE may assume that the performance of some of the N new reception beams is higher than the performance of the current reception beam by a specific reference value or more. In addition, the UE may assume that the performance of remaining new reception beams other than some new reception beams is not higher than the performance of the current reception beam by a specific reference value or more.
(Alt1 new reception beam) The UE may report the L1-RSRP value of the best performing new reception beam among the N new reception beams by quantizing the value of 1 dB unit from −140 dBm to −44 dBm with a total of 7 bits. In addition, the UE may express the performance of the remaining (N−1) new reception beams as a difference value from the performance of the new reception beam having the largest L1-RSRP value (which may refer to a differential L1-RSRP value, for example), and may quantize the differential L1-RSRP value of 2 dB unit by a total of 4 bits.
(Alt1 new reception beam and index) The UE may include the index of the current reception beam and/or the performance of the current reception beam in the report to the base station. As used herein, the current reception beam's index may be the CSI-RS resource index in case that the current reception beam is a CSI-RS, as described above, or may be the SSB index in case that the current reception beam is an SSB. The UE may be configured by the base station through upper layer signaling regarding whether to include the index of the current reception beam and/or the performance of the current reception beam in the report to the base station. For example, in case that the UE has upper layer signaling configured by the base station, the UE may include the index of the current reception beam and/or the performance of the current reception beam in the report of reception beam performance started from the UE. In case that case that the UE has no upper layer signaling configured by the base station, the UE may not include the index of the current reception beam and/or the performance of the current reception beam in the report of reception beam performance started from the UE, which includes only the index of the new reception beam index and/or the performance value of the new reception beam.
(Alt1 only current reception beam reported) In case of including the performance (e.g., L1-RSRP performance) of the current reception beam in the report to the base station, the UE may express the L1-RSRP performance of the current reception beam as a difference value (e.g., a differential L1-RSRP value) from the performance of the best performing new reception beam, and may quantize the differential L1-RSRP value of 2 dB unit with a total of 4 bits. In addition, the UE may report the L1-RSRP performance of the current reception beam by quantizing the value of 1 dB unit from −140 dBm to −44 dBm with a total of 7 bits. The UE's reporting method described above is only an example, and the disclosure is not limited by the above example.
(Current reception beam index reporting method) In case of reporting the index of the current reception beam, the UE may report the index of the reception beam having the Qth best performance according to the above [current reception beam determination scheme 3] or [current reception beam determination scheme 4]. The UE may report the index, based on the bit length of the TCI state field inside DCI. For example, the UE may consider all DCI formats which may be configured for the UE and monitored by the UE in the corresponding cell and in the corresponding activated downlink bandwidth part, among DCI formats 1_1, 1_2, and 1_3. In addition, the UE may determine the bit length to be used when the UE reports the index of the current reception beam in a reception beam performance report started from the UE by using at least one combination of the following methods.
In case that the UE is configured to receive and monitor at least one combination including DCI format 1_1, among DCI formats 1_1, 1_2, and 1_3, the UE may report the index of the current reception beam in a reception beam performance report started by the UE by using the bit length of the TCI state field in DCI format 1_1, and may ignore the bit length of the TCI state field of other DCI formats. For example, the UE may use 3 bits corresponding to the bit length of the TCI state field in DCI format 1_1. Therefore, in case that the UE determines that the Qth best-performing reference signal is associated with the second activated TCI state, the UE may report, for example, “001” by using 3 bits, and “1” may be the least significant bit (LSB) or most significant bit (MSB).
   In case that the UE is configured to receive only DCI format 1_1 and DCI format 13 among DCI formats 1_1, 1_2, and 1_3, the UE may report the index of the current reception beam in a reception beam performance report started from the UE by using the largest bit length among bit lengths of the TCI state field in DCI format 1_1 and 1_3. For example, in case that the bit length of the TCI state field in DCI format 1_1 is 4, and the bit length of the TCI state field in DCI format 1_3 is 4, the UE may use the 4 bits corresponding to the bit length of the TCI state field in DCI format 1_3.
   The UE may report the index of the current reception beam in the reception beam performance report started from the UE by using a bit length capable of expressing the number of TCI states activated in the TCI state field of DCI formats 1_1 and 1_2. For example, in case that, among a total of 8 codepoints that can be expressed by 3 bits of DCI format 1_1, the UE has received a MAC-CE from the base station and has received TCI state information activated with regard to 4 codepoints, the UE may report the index of the current reception beam in a reception beam performance report started by the UE, by considering the value of 4 (the number of activated codepoints) instead of the total 8 codepoints. For example, in the above example, 2 bits may be sufficient, and this may be generated and expressed as follows: assuming that the number of activated codepoints is A, the bit length required to report the index of the current reception beam may be ceil(log 2(A)), wherein ceil(.) and log 2(.) may refer to a ceiling function and a logarithmic function with a base of 2, respectively. Each time the UE receives a TCI state activation MAC-CE transmitted by the base station, the bit length for expressing the index of the current reception beam in the reception beam performance report started from the UE may differ. The UE and the base station have the same recognition regarding the MAC-CE activation timepoint, and the bit length for expressing the index of the current reception beam may thus be changed from the activation timepoint. The UE may determine the bit length of the index of the current reception beam in the reception beam report started from the UE, according to the number of TCI states included in a MAC-CE which activates the largest number of TCI states among one or more MAC-CEs transmitted by the base station. For example, after an activation timepoint after the UE receives a first MAC-CE indicating that a total of 4 TCI states are to be activated, the UE may determine the index of the current reception beam by using a total of 2 bits. Thereafter, after an activation timepoint after the UE receives a second MAC-CE indicating that a total of 8 TCI states are to be activated, the UE may determine the index of the current reception beam by using a total of 3 bits. Thereafter, after an activation timepoint after the UE receives a third MAC-CE indicating that a total of 4 TCI states are to be activated, the UE may still determine the index of the current reception beam by using a total of 3 bits.
In case that [event 3] is configured, the UE may expect that the bit length of the TCI state field in at least one of DCI format 1_1, 1_2, or 1_3 is not 0. For example, the UE may not expect that the bit length of the TCI state field in DCI format 1_1, 1_2, or 1_3 is all 0. In connection with upper layer signaling regarding this, the UE may not expect that tci-PresentInDCI inside ControlResourceSet (upper layer signaling) which determines whether the TCI state field is present in DCI format 1_1 or not, tci-PresentDCI-1-2-r16 inside ControlResourceSet (upper layer signaling) which determines whether the TCI state field is present in DCI format 1_2 or not and, if present, determines the bit length, and tci-ListDCI-1-3-r18 inside MC-DCI-SetOfCells-r18 (upper layer signaling) which determines whether the TCI state field is present in DCI format 1_3 or not and if present, determines the bit length, are all configured as 0. In addition, the UE may expect that at least one of the above-described parameters is configured.
(Method for reporting the performance of the current reception beam and beams with better performance than the Qth) The UE may report information (e.g., index or/and reception performance (e.g., L1-RSRP)) regarding not only the Qth best-performing reception beam among the reference signals associated with QCL sources configured for respective activated TCI states determined based on [current reception beam determination scheme 3] or [current reception beam determination scheme 4]described above, but also reception beams with better performance than the Qth. The UE's additional reporting operation may be determined by upper layer signaling configuration that may be received from the base station. For example, in case that the UE has specific upper layer signaling configured therefor by the base station to instruct reception beams with better performance than the current reception beam, in addition to the above-described upper layer signaling configurations regarding reporting of the current reception beam index or/and the current reception beam performance, the UE may also report information regarding reception beams having better performance than the Qth. For example, in case that the UE has reported UE capability as Q=2, the UE has Q=2 configured by the base station, the UE has upper layer signaling configured for reporting the current reception beam index and/or the current reception beam performance, and the UE has additional upper layer signaling configured for reporting the index and/or performance of reception beams better than the Qth one, the UE may report not only the index and/or performance of the reference signal associated with the QCL source in the activated TCI state having the (Q=2)th best reception performance (for example, L1-RSRP), but also the index and/or performance of the reference signal associated with the QCL source in the activated TCI state having the (Q−1)th (e.g., first) best reception performance (for example, L1-RSRP). The UE may report the performance of the reference signal associated with the QCL source in the activated TCI state having the Qth best reception performance (for example, L1-RSRP), based on the above-described differential L1-RSRP, which may express the difference value from the L1-RSRP of the new reception beam having the best performance, at 2 dB intervals with a total of 4 bits. In addition, with regard to the performance of the reference signal associated with the QCL source inside the activated TCI state having the Qth best reception performance, the UE may report the same based on the above-described differential L1-RSRP which may express the difference value from the L1-RSRP of the best-performing new reception beam at 2 dB intervals with a total of 4 bits (in case that the reception beam performance is better than the L1-RSRP of the best-performing new reception beam, the UE may include 1 bit capable of expressing a sign included in the report as 1 value, and in case that the reception beam performance is worse than the L1-RSRP of the best-performing new reception beam, the UE may include 1 bit capable of expressing a sign included in the report as 0 value), or the UE may report the L1-RSRP performance of each reception beam by quantizing the value of 1 dB unit from −140 dBm to −44 dBm with a total of 7 bits. Accordingly, the base station may acquire not only information regarding the Qth best-performing TCI state currently activated for the UE, but also TCI states having better performance than the Qth one. Therefore, the base station may continuously manage the performance of as many upper TCI states as Q by changing or updating as many upper TCI states as Q, or by changing and updating lower TCI states other than as many upper TCI states as Q.
In another method, the UE may measure the performance of reference signals associated with QCL sources configured in a total of A activated TCI states, and may then determine activated TCI states ranging from the activated TCI state associated with the reference signal having the best performance to the activated TCI state associated with the reference signal having Ath best performance. Thereafter, after [Event 3] has occurred, in case that information regarding new reception beams is included in a reception beam performance report started by the UE, the UE may additionally report that the performance of each new reception beam is better than that of the TCI state associated with a specific X^{th} best-performing reference signal. Such additional reporting may be performed based on upper layer signaling receivable from the base station. For example, when the UE performs reception beam reporting started by the UE after [event 3] has occurred, the UE may include the performance of two new reception beams in the report. In addition, in case that a total of 8 TCI states are activated for the corresponding UE, the UE may report the number 3 in addition to the performance of new reception beams so as to indicate that the best-performing new reception beam, for example, the third best-performing reference signal has a better reception performance than the TCI state associated with the QCL source. In addition, the UE may report the number 2 in addition to the performance of new reception beams so as to indicate that the second best-performing new reception beam (e.g., the second best-performing reference signal) has a better reception performance the TCI state associated with the QCL source In order to express the number additionally reported for the new reception beam, the bit length used to express the index of the current reception beam described above may be used.
In another method, the UE may additionally report, to the base station, the number of times at least one new reception beam in a specific time interval has a higher performance than the current reception beam (above-described in [current reception beam determination scheme 3] or [current reception beam determination scheme 4]) by a specific reference value or more. For example, the UE may additionally report that, in a specific time interval, the first new reception beam has a higher performance than the current reception beam by a specific reference value or more two times, and the second new reception beam has a higher performance than the current reception beam by a specific reference value or more once. The maximum value of the number of times may be predefined, and the maximum value may be used to determine the bit length capable of expressing information regarding the number of times in the reception beam report started by the UE. For example, if the maximum value of the number of times is X, the bit length capable of expressing this may be determined to be ceil(log 2(X)), and ceil(.) and log 2(.) may be a ceiling function and a logarithm function with a base of 2, respectively. Such additional reporting may be enabled as the UE receives specific upper layer signaling from the base station.
(P8, Current reception beam determination method) with regard to [event 3], the UE may determine the method for determining the Qth best-performing reference signal among reference signals configured as QCL sources in one or more TCI states activated for the current reception beam, through at least one combination of the following items (for example, the embodiment of FIG. 11).

FIG. 11 is a diagram illustrating a method for determining the current reception beam in the case of [event 3] in a wireless communication system according to an embodiment of the disclosure.
The UE may receive DCI from the base station (1100).
The UE may have MAC-CE reception scheduled by the base station through DCI, and the MAC-CE may be included in a PDSCH (1105). The MAC-CE may activate a total of four code points of the TCI state field in DCI (1110). The first codepoint may be TCI #1 having reference signal RS #1 configured as a QCL source, the second codepoint may be TCI #2 having reference signal RS #2 configured as a QCL source, the third codepoint may be TCI #3 having reference signal RS #3 configured as a QCL source, and the fourth codepoint may be TCI #4 having reference signal RS #4 configured as a QCL source.
The UE may transmit a PUCCH including HARQ-ACK information (1115) regarding PDSCH reception including a MAC-CE to the base station.
3 ms after the HARQ-ACK transmission timepoint (for example, from timepoint t0 1120), the UE may apply the MAC-CE activation information. Thereafter, the UE may determine the current reception beam while receiving each reference signal configured as a QCL source in one or more newly activated TCI states.
In case that Q=2, the current reception beam may be determined as the (Q=2)th best-performing reference signal among reference signals configured as QCL sources in the activated TCI state, according to the above-described [current reception beam determination scheme 3].
In one method, from the timepoint at which new TCI state activation is applied (e.g., from timepoint t0 1120), the UE may determine which is the current reception beam after receiving Q=2 reference signals among all reference signals associated with the activated TCI state. For example, in case that the UE receives RS #1 1125 at timepoint t1, the best-performing reference signal at time point t1 may be determined as RS #1. Thereafter, the UE may receive RS #2 1130 at timepoint t2, and if RS #1 has better performance than RS #2, the UE may determine the current reception beam as RS #2 and TCI #2 (for example, as the (Q=2)th best-performing reference signal). Thereafter, the UE may measure the performance of each RS at the reception positions of RS #3 1135 and RS #4 1140, and may update the current reception beam (for example, as the (Q=2)th best-performing reference signal) information from RS #2 or maintain RS #2.
In another method, from the timepoint at which new TCI state activation is applied (e.g., from timepoint t0 1120), the UE may determine which is the current reception beam from the timepoint (e.g., from timepoint t4 1140) at which all reference signals associated with the activated TCI state are received at least once. For example, in case that the UE receives RS #1 1125 at timepoint t1, and may determine the best-performing reference signal at time point t1 as RS #1. Thereafter, the UE may receive RS #2 1130 at timepoint t2, and if RS #1 has better performance than RS #2, the UE may determine the current reception beam as RS #2 and TCI #2 (for example, as the (Q=2)th best-performing reference signal). Thereafter, the UE may measure the performance of each RS at the reception positions of RS #3 1135 and RS #4 1140, and may determine that the reception performance is good in the order of RS #3, RS #2, RS #4, and RS #1. Therefore, the UE may determine RS #2 and TCI #2 as the current reception beam (for example, as the (Q=2)th best-performing reference signal).
In another method, the UE may have an additional timer configured by the base station such that, from the timepoint at which a new MAC-CE is activated until the timer expires, the TCI state corresponding to the (Q=2)th best-performing reference signal is determined as the current reception beam.
Such a method of determining the current reception beam from a specific timepoint, if used, may be advantageous in that a timer is implicitly configured so as to prevent a reception beam report started from the UE from frequently occurring between the UE and the base station. For example, in case that the UE determines the current reception beam determination timepoint to be t2 (1130), the UE and the base station may both assume that no reception beam performance report started by the UE will occur at least from the new MAC-CE activation application timepoint (e.g., timepoint t0 1120), or from the HARQ-ACK transmission timepoint 1115) to timepoint t2 1130.
It may be assumed that, among the above-described methods, a method for the UE to determine the current reception beam regarding [event 3] is indicated by the base station through at least one combination of upper layer signaling, MAC-CE signaling, or L1 signaling, or a specific method fixed in specifications is followed in the case of a UE that supports [event 3].
In connection with determining whether [event 3] occurs or not, the UE may consider single-event-based determination and multiple-event-based determination. The UE may report, through UE capability, a single-event-based determination scheme as the basic determination scheme regarding [event 3], and the multi-event-based determination scheme may be used as the determination scheme regarding [event 3] only when the UE reports additional UE capability. In the case of single-event-based determination, the UE may determine the performance of the new reception beam and the current reception beam by receiving a reference signal corresponding to the new reception beam and a reference signal corresponding to the current reception beam only once. During single event-based determination, the UE may determine whether [event 3] has occurred or not at each beam reception location (for example, the reception location of a new reception beam existing after the current reception beam is known, the location of the current reception beam, or/and the reception location of a reference signal configured for a QCL source in an activated TCI state, or an SSB having a QCL relationship with a reference signal configured for a QCL source in an activated TCI state).
With regard to [event 3], the UE may introduce a specific time interval and a counter in order to determine that the performance of a new reception beam is higher than the reception performance of the current reception beam by a specific reference value or more. By using a time interval starting based on a timepoint at which information regarding the current reception beam is identified, the UE may determine whether [event 3] occurs or not at a timepoint within the time interval. The timepoint at which information regarding the current reception beam is identified may be a timepoint at which the currently indicated TCI state is applied, or a timepoint at which a reference signal (which is a CSI-RS or SSB according to the above description) corresponding to the current reception beam is received after the timepoint at which the currently indicated TCI state is applied. The length of the time interval may correspond to a frame, subframe, slot, symbol, or absolute time (e.g., msec) having the periodicity value of the reference signal corresponding to the current reception beam, or a real number value which is shorter or longer than the same. The length of the time interval may be configured for the UE through upper layer signaling from the base station. The UE may reset the corresponding time interval whenever a reference signal corresponding to the current reception beam is received, or at a timepoint at which the time interval is terminated. Within the corresponding time interval, the UE may receive a reference signal (e.g., CSI-RS or SSB) corresponding to each of one or more new reception beams. In case that [event 3] occurs a specific number of times or more with regard to a specific new reception beam within the corresponding time interval, the UE may report the reception beam performance to the base station. In addition, the UE may store the number of times [event 3] continuously occurs in the time interval, from the starting point of the time interval, in the above-described counter. Upon confirming that the value of the corresponding counter is larger than a specific number of times, the UE may report the reception beam performance to the base station. The number of times [event 3] continuously occurs may mean a case in which the performance of a specific new reception beam is higher than that of the current reception beam by a specific reference value or more. For example, in case that respective performances of two different new reception beams are higher than that of the current reception beam by a specific reference value or more, the UE may consider that [event 3] has occurred once for each new reception beam. The UE may identify whether [event 3] occurs or not at each periodicity of the current reception beam, in the corresponding time interval. In case that [event 3] has continuously occurred within the time interval, but has not yet occurred more than a specific number of times, and in case that [event 3] does not occur at a specific periodicity of the current reception beam, and the number of times [event 3] has continuously occurred accordingly fails to exceed the specific number of times, the UE may reset the last timepoint of the specific periodicity regarding the current reception beam to the starting point of the time interval. In this manner, the UE may identify the number of times [event 3] continuously occurs in a specific time interval, and may report the reception beam performance started by the UE to the base station. The specific number of times may be 1 by default, and the UE may have X (a specific natural number greater than 1) configured therefor by the base station. In an embodiment, the UE may report, to the base station, UE capability meaning that the UE regards the specific number of times as 1 or as X (a specific natural number greater than 1). Thereafter, the base station may configure a specific number of times for the UE, based on the UE capability received from the UE. In response, the UE may finally determine a specific number of times, based on configurations received from the base station. In another embodiment, the UE may report, to the base station, UE capability meaning that the UE regards the specific number of times as 1 or as X (a specific natural number greater than 1). In addition, upon receiving the UE capability, the base station may determine or use the same value reported by the UE through UE capability as the specific number of times, without additional upper layer signaling configuration for the corresponding UE.

The UE may use at least one combination of [Event 1], [Event 2], and [Event 3] when reporting reception beam performance started from the UE. For example, the UE may report, to the base station, the reception beam performance started from the UE by considering [event 1]. As another example, the UE may have upper layer signaling configured therefor regarding reception beam performance reporting started from the UE, regarding each of [event 1] and [event 2], and may identify [event 1] and [event 2] separately to report reception beam performance. In case that [event 1] occurs, the UE may report reception beam performance started from the UE, corresponding thereto. In the case that [event 2] occurs, the UE may report reception beam performance started from the UE, corresponding thereto. In case that [event 1] and [event 2] occur simultaneously, the UE may report respective reception beam performances started from the UE, corresponding to [event 1] and [event 2], may select only one of the two, or may report the reception beam performance related to a higher priority event.

The UE may perform UE capability reporting to the base station to indicate that the UE is capable of supporting at least one combination of [event 1], [event 2], and [event 3] through the UE capability. For example, the UE may report, to the base station through UE capability, that the UE is capable of supporting reception beam performance reporting started from the UE regarding [event 1]. For example, the UE may report, to the base station through UE capability, that the UE is capable of supporting reception beam performance reporting started from the UE regarding [event 2]. For example, the UE may report, to the base station through UE capability, that the UE is capable of supporting reception beam performance reporting started from the UE regarding [event 1] and [event 2].

With regard to the above [event 1], [event 2], and [event 3], the UE may define a timer that does not monitor the occurrence of a specific event. For example, in case that beam switching has occurred from the base station, the UE may not monitor a specific event defined in [event 1] to [event 3] for a predetermined time from the corresponding timepoint. In another example, after a specific event defined in [event 1] to [event 3] occurs, the UE may not monitor a specific event defined in [event 1] to [event 3] for a predetermined time from the corresponding timepoint. Accordingly, frequent information exchange and beam switching between the UE and the base station may be prevented by preventing channel state information reporting started from the UE for a predetermined time after the base station has configured or indicated beam switching.

The UE may monitor only one of the above [event 1], [event 2], and [event 3], and if the corresponding event occurs, the UE may perform channel state information reporting started from the UE. Alternatively, the UE may independently monitor one or more specific events, and may perform channel state information reporting started from the UE, corresponding to each event. Alternatively, the UE may monitor one or more particular events individually, but if one or more events occur simultaneously, the UE may perform only channel state information reporting started from the UE, corresponding to a high priority event among the same. With regard to each case, the UE may apply the timer individually or commonly. Common application of the timer in case that the UE is monitoring one or more events may mean that a timer to be applied if a specific event occurs will be applied identically to the other events.

In an embodiment of the disclosure, a CSI reporting method started by the UE will be described. This embodiment may operate in combination with other embodiments.

After the occurrence of a specific event described above for channel state information reporting started from the UE, the UE may perform channel state information reporting started from the UE, thereby transferring information related to the reception beam performance. The UE may report channel state information started from the UE to the base station by considering at least one combination of the following methods:

### [Method 1-1]

The UE may have a PUCCH resource configured therefor to request allocation of a PUSCH resource that may be transmitted to the base station, including reception beam performance reporting started by the UE. In case that a specific event according to any one of the above-described [event 1] to [event 4] or a combination of two or more thereof occurs from the UE, the UE may transmit a PUCCH (or PUSCH resource allocation request information, or scheduling request) to the base station on the corresponding PUCCH resource. The UE may have a PUCCH resource configured by the base station through upper layer signaling for the purpose of reception beam performance reporting started from the UE, and this may be separate configuration information from a PUCCH resource for requesting uplink data scheduling according to the prior art. The PUCCH resource may include one-bit information.

In addition, one PUCCH resource may be configured for the UE to simultaneously request at least one combination of uplink data scheduling and a request for allocation of PUSCH resources which may be transmitted to the base station while including a reception beam performance report started from the UE, and in the corresponding PUCCH resource, two-bit information may be transmitted. In case that the PUCCH resource has information bits of “01”, the corresponding PUCCH resource may indicate a conventional uplink data scheduling request. In case that the PUCCH resource is “10”, the PUCCH resource may trigger a request for allocation of PUSCH resources that may be transmitted to the base station while including the above-described reception beam performance report started from the UE. In case that the PUCCH resource is “11”, the corresponding PUCCH resource may trigger both to be transmitted to the base station while including a reception beam performance report started from the UE and a request for allocation of PUSCH resources that may be transmitted to the base station while including the reception beam performance report started from the UE. In case that the base station has received a corresponding PUCCH resource having information bits of “11” from the UE, the base station may force the UE to transmit one DCI such that PUSCH scheduling information, PUSCH scheduling information for reception beam performance reporting started from the UE, and information for instructing the reception beam performance reporting started from the UE to be included corresponding PUSCH are all included in the DCI. In this case, the corresponding DCI may also be capable of scheduling a PUSCH that may include both uplink data and reception beam performance report. The above technology is only an example, and the disclosure is not limited by the above example.

The UE may have an offset and a slot-unit periodicity configured regarding a PUCCH resource for triggering reception beam performance reporting started from the UE, or one PUCCH resource that may simultaneously request at least one combination of reception beam performance reporting started from the UE and uplink data scheduling. In addition, in case that the specific event has occurred, the UE may transmit the above-described information on the PUCCH resource in the nearest periodicity after a specific time offset from the timepoint of occurrence of the specific event. The information described above may be referred to as a scheduling request, but this name is merely an example and does not limit the scope of the disclosure. The specific time offset may be defined in a slot or ms unit, and may include 0 among possible values (for example, a specific time offset may not be required). Such a time offset may be defined by at least one combination of the following methods: the time offset is defined by UE capability and reported to the base station by the UE; the time offset is notified by the base station through at least one combination of upper layer signaling, MAC-CE signaling, or Li signaling; and time offset is fixedly defined in specifications.

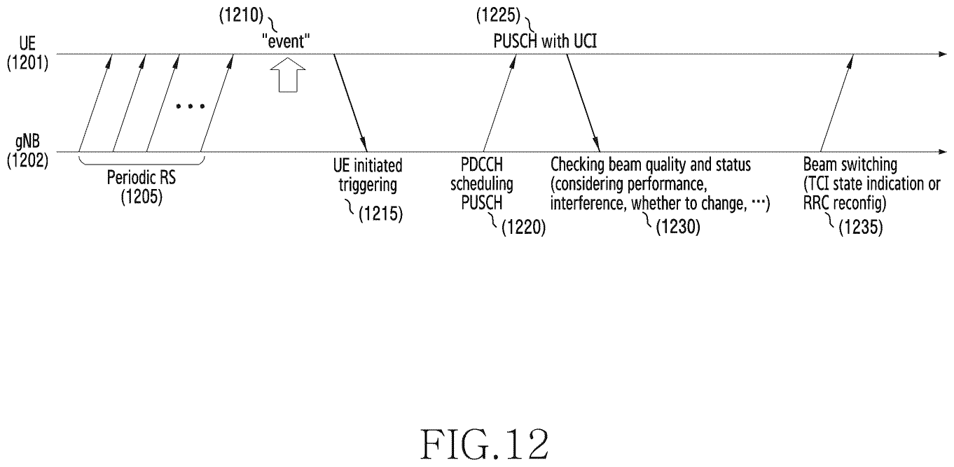

FIG. 12 is a diagram illustrating an operation process of a UE and a base station with regard to a CSI report started by the UE by using a PUCCH resource for triggering a reception beam performance report started from the UE in a wireless communication system according to an embodiment of the disclosure.

The UE 1201 may have a set of periodic channel measurement reference signals configured therefor by the base station 1202 through upper layer signaling, and may periodically receive the periodic channel measurement reference signals to measure reception beam performance (1205). Thereafter, in case that a specific event occurs in the UE (1210), the UE 1201 may transmit a signal to the base station 1202 on a PUCCH resource that triggers reception beam performance reporting started from the UE (1215). The specific event may correspond to at least one of events 1 to 4 described above. The PUCCH resource may be a PUCCH resource different from the PUCCH resource for requesting uplink data scheduling, as described above, or may be a PUCCH resource for requesting at least one combination of an uplink data scheduling request and a reception beam performance reporting request started by the UE, from the base station. In response thereto, the base station 1202 may transmit a PDCCH to the UE 1201 to trigger reception beam performance reporting started from the UE (or schedule a PUSCH for transmitting a reception beam performance report) (1220). The UE 1201 may calculate UCI according to the reception beam performance report request started from the UE in response thereto, and may transmit the same to the base station 1202 while being included in a PUSCH scheduled by a PDCCH (1225). Thereafter, in case of determining that beam switching is necessary for the UE 1201 (1230), the base station 1202 may configure or indicate beam switching for the UE 1201 (1235).

If the above method 1-1 is considered, the process of channel state information reporting started from the UE may be relatively long, and thus may be disadvantageous in terms of delay time. However, as described above, if the base station follows the conventional standards, the base station must transmit non-periodic channel state information report triggering to the UE, based on indirect information, and thus, even though a non-periodic channel state information reporting scheme is available, it may not be sufficiently utilized. Therefore, in case that the UE first performs reception beam performance report triggering started from the UE, as described above, a clear gain in delay time may exist as compared to the conventional art. In addition, reception beam performance report triggering is transmitted to the base station through one PUCCH resource together with an uplink data scheduling request, so that there may be a gain in terms of signaling overhead. In addition, since the reception beam performance report started from the corresponding UE is transmitted through the PUSCH, the UE may transfer UCI of various maximum lengths to the base station, and the same may be applied to methods having various ranges of amount of information exchanged between the UE and the base station (from a small number of bits to a large number of bits).

### [Method 1-2]

The UE may have a pair of PUSCH transmission and PUCCH resources scheduled to be transmitted, for channel state information reporting started from the UE. The UE may generate channel state information started from the UE in the form of UCI or MAC-CE, include the same in a PUSCH, and transfer the same to the base station. The UE may have an offset and a slot-unit periodicity regarding the PUCCH resources and PUSCH transmission, and may have PUSCH transmission-related parameters (including at least one of the time offset between PUCCH resources and PUCCH transmission, time and frequency resource allocation information regarding PUSCH transmission, MCS (for example, the lowest value), the number of MIMO layers (for example, 1), DMRS ports (for example, 0), or waveforms (for example, CP-OFDM)) configured therefor.

In another method, the UE may have a slot-unit periodicity and offset configured regarding the PUCCH resource. In addition, regarding PUSCH transmission, the UE may assume configured grant type 1 PUSCH transmission, and may thus have upper layer signaling configured therefor regarding the configured grant type 1 PUSCH transmission. Therefore, the UE may consider a method of transmitting a PUSCH in the corresponding periodicity only when a signal has been transmitted in a PUCCH resource before the PUSCH transmission periodicity, instead of transmitting the PUSCH in each periodicity. In addition, in case that the specific event occurs, the UE may transmit a signal in the PUCCH resource of the nearest periodicity after a specific time offset from the specific event occurrence timepoint. The specific time offset may be defined in a slot or ms unit, and may include 0 among possible values (for example, no specific time offset may be necessary). Such a time offset may be defined by at least one combination of the following methods: the time offset is defined by UE capability and reported to the base station by the UE; the time offset is notified by the base station through at least one combination of upper layer signaling, MAC-CE signaling, or L1 signaling; and time offset is fixedly defined in specifications.

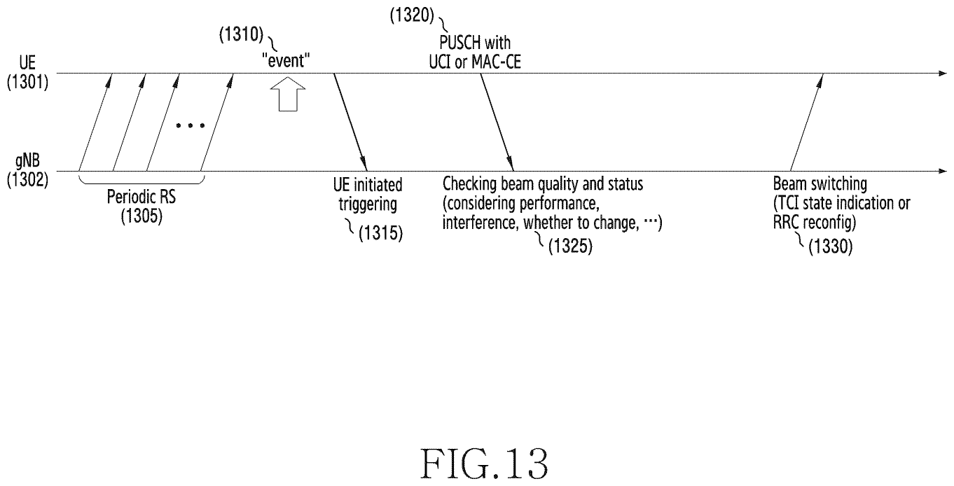

FIG. 13 is a diagram illustrating an operation of a UE and a base station with regard to CSI reporting started by the UE by using a pair of reserved PUCCH resources and PUSCH transmission in a wireless communication system according to an embodiment of the disclosure.

The UE 1301 may have a set of periodic channel measurement reference signals configured therefor by the base station 1302 through upper layer signaling, and may periodically receive the periodic channel measurement reference signals to measure reception beam performance (1305). Therefore, in case that a specific event occurs in the UE 1301 (1310) (for example, the specific event may correspond to at least one of events 1 to 4 described above), the UE 1301 may transmit a signal to the base station 1302 on the PUCCH resource (1315). Thereafter, the UE 1301 may perform PUSCH transmission after a time offset between PUCCH resources configured for the UE and PUSCH transmission (1320). In addition, the UE 1301 may include UCI or MAC-CE in the corresponding PUSCH. In case that the base station 1302 determines that beam switching is required for the UE 1301 (1325), the base station 1302 may configure or indicate that beam switching is required for the UE 1301 (1330).

In case that [method 1-2] described above is considered, the process of channel state information reporting started from the UE may be relatively short, and thus there may be an advantage in terms of delay time. However, the UE needs reserved PUCCH resources and PUSCH transmission resources, and during blind decoding at the base station, even if at least one of the two PUCCH and PUSCH channels fails, the base station may fail to decode the reception beam performance report that the UE intended to transmit, and in order to properly receive the same, the base station may have to perform decoding again with regard to the PUCCH and PUSCH that are retransmitted by the UE later.

The UE may expect to be notified of at least one combination of above [method 1-1] or [method 1-2] by the base station through at least one combination of upper layer signaling, MAC-CE signaling, or L1 signaling, or may expect that at least one combination of above [method 1-1] or [method 1-2] is fixedly defined in specifications. Additionally, in case that the UE is notified of a combination of one or more specific methods by the base station through at least one combination of upper layer signaling, MAC-CE signaling, or L1 signaling, this may indicate that the UE is not capable of supporting one or more other combinations of methods. For example, the UE may expect that [method 1-2] is fixedly defined in specifications with regard to the method and process of channel state information reporting started by the UE described above. As another example, the UE may be notified by the base station of above [method 1-1] through at least one combination of upper layer signaling, MAC-CE signaling, or L1 signaling, and in this case, the UE may consider that the base station has notified that [method 1-2] is not supported.

The UE may report, to the base station, whether or not the UE is capable of supporting at least one combination of [method 1-1] or [method 1-2]. In case that the UE has reported to the base station that a combination of one or more specific methods is supported, it may be considered that the UE has reported that the same cannot support another combination of one or more specific methods. For example, the UE may report, to the base station, whether [method 1-1] or [method 1-2] can be supported. In another example, the UE may report to the base station that the UE is capable of supporting [method 1-1], and such UE capability reporting may indicate that the UE is unable to support [method 1-2].

The above-described [method 1-1] or [method 1-2] all considers periodic channel state information reporting as a conventional channel state information reporting scheme, but the UE may also consider a semi-persistent CSI reporting scheme and/or an aperiodic CSI reporting scheme for channel state information reporting started from the UE. In addition, in the case of a channel measurement reference signal, the UE may also consider a semi-persistent reference signal and a non-periodic reference signal as well as a periodic reference signal.

With regard to [method 1-1] or [method 1-2] above, the UE may define an arbitrary timer, and after performing channel state information reporting started from the UE according to each method, the UE may not perform channel state information reporting started from the UE for a predetermined time. Accordingly, the UE may reduce frequent channel state information reporting, and in the case of a method in which the base station needs blind decoding, blind decoding may not be performed for a period of time.

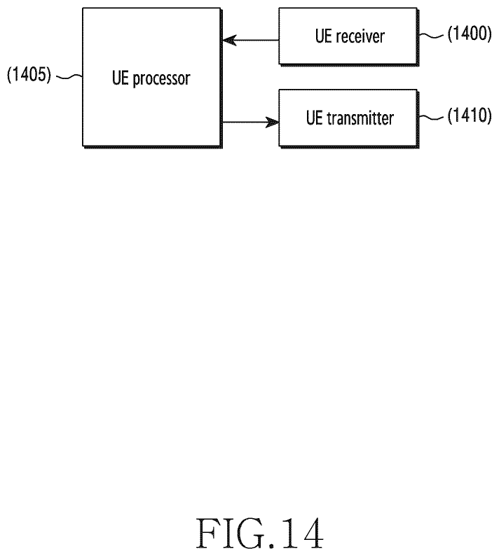

FIG. 14 illustrates a structure of a UE in a wireless communication system according to an embodiment of the disclosure.

Referring to FIG. 14, the UE may include a transceiver, which refers to a UE receiver 1400 and a UE transmitter 1410 as a whole, memory (not illustrated), and a UE processor 1405 (or UE controller or processor). The UE transceiver 1400 and 1410, the memory, and the UE processor 1405 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver 1400 and 1410 may transmit/receive signals with the base station. The signals may include control information and data. To this end, the transceiver 1400 and 1410 may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver 1400 and 1410 are not limited to the RF transmitter and the RF receiver.

In addition, the transceiver 1400 and 1410 may receive signals through a radio channel, output the same to the UE processor 1405, and transmit signals output from the UE processor 1405 through the radio channel.

The memory may store programs and data necessary for the operation of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories, and the memory may store instructions for performing the above-described communication methods.

Furthermore, the UE processor 1405 may control a series of processes so that the UE can operate according to the above-described embodiments. For example, the UE processor 1405 may control components of the UE to receive DCI configured in two layers so as to simultaneously receive multiple PDSCHs. The UE processor 1405 may include multiple processors, and the UE processor 1905 may perform operations of controlling the components of the UE by executing programs stored in the memory.

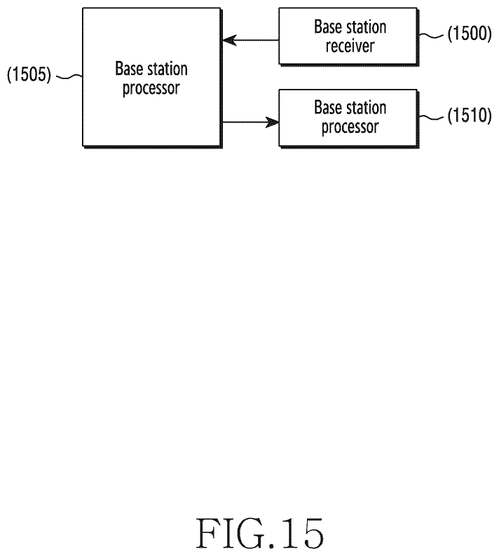

FIG. 15 illustrates a structure of a base station in a wireless communication system according to an embodiment of the disclosure.

Referring to FIG. 15, the base station may include a transceiver, which refers to a base station receiver 1500 and a base station transmitter 1510 as a whole, memory (not illustrated), and a base station processor 1505 (or base station controller or processor). The base station transceiver 1500 and 1510, the memory, and the base station processor 1505 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver 1500 and 1510 may transmit/receive signals with UEs. The signals may include control information and data. To this end, the transceiver 1500 and 1510 may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver 1500 and 1510 are not limited to the RF transmitter and the RF receiver.

In addition, the transceiver 1500 and 1510 may receive signals through a radio channel, output the same to the base station processor 1505, and transmit signals output from the base station processor 1505 through the radio channel.

The memory may store programs and data necessary for the operation of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories, and the memory may store instructions for performing the above-described communication methods.

The base station processor 1505 may control a series of processes so that the base station can operate according to the above-described embodiments of the disclosure. For example, the base station processor 1505 may control components of the base station to configure DCI configured in two layers including allocation information regarding multiple PDSCHs and to transmit the same. The base station processor 1505 may include multiple processors, and the base station processor 1505 may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, configuration information on a channel state information (CSI) report associated with a event type, the configuration information includes information on a report of a current beam and a threshold associated with the event type;
identifying that a reference signal received power (RSRP) of the current beam is lower than the threshold; and
transmitting, to the base station, the CSI report including the RSRP of the current beam based on the information on the report of the current beam.

2. The method of claim 1, wherein, in case that the current beam is a CSI reference signal (CSI-RS), the current beam is identified as a reference signal in an indicated TCI state.

3. The method of claim 1, wherein, in case that the current beam is a synchronization signal block (SSB), the current beam is identified as a SSB which is quasi-co located with a reference signal in an indicated TCI state.

4. The method of claim 1, wherein a bandwidth of the RSRP of the current beam includes 7 bits.

5. A method performed by a base station in a wireless communication system, the method comprising:
transmitting, to a user equipment (UE), configuration information on a channel state information (CSI) report associated with a event type, the configuration information includes information on a report of a current beam and a threshold associated with the event type; and
receiving, from the UE, the CSI report including a reference signal received power (RSRP) of the current beam based on the information on the report of the current beam,
wherein the RSRP of the current beam is lower than the threshold.

6. The method of claim 5, wherein, in case that the current beam is a CSI reference signal (CSI-RS), the current beam is identified as a reference signal in an indicated TCI state.

7. The method of claim 5, wherein, in case that the current beam is a synchronization signal block (SSB), the current beam is identified as a SSB which is quasi-co located with a reference signal in an indicated TCI state.

8. The method of claim 5, wherein a bandwidth of the RSRP of the current beam includes 7 bits.

9. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, configuration information on a channel state information (CSI) report associated with a event type, the configuration information includes information on a report of a current beam and a threshold associated with the event type,
identify that a reference signal received power (RSRP) of the current beam is lower than the threshold, and
transmit, to the base station, the CSI report including the RSRP of the current beam based on the information on the report of the current beam.

10. The UE of claim 9, wherein, in case that the current beam is a CSI reference signal (CSI-RS), the current beam is identified as a reference signal in an indicated TCI state.

11. The UE of claim 9, wherein, in case that the current beam is a synchronization signal block (SSB), the current beam is identified as a SSB which is quasi-co located with a reference signal in an indicated TCI state.

12. The UE of claim 9, wherein a bandwidth of the RSRP of the current beam includes 7 bits.

13. A base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a user equipment (UE), configuration information on a channel state information (CSI) report associated with a event type, the configuration information includes information on a report of a current beam and a threshold associated with the event type, and
receive, from the UE, the CSI report including a reference signal received power (RSRP) of the current beam based on the information on the report of the current beam,
wherein the RSRP of the current beam is lower than the threshold.

14. The base station of claim 13, wherein, in case that the current beam is a CSI reference signal (CSI-RS), the current beam is identified as a reference signal in an indicated TCI state.

15. The base station of claim 13, wherein, in case that the current beam is a synchronization signal block (SSB), the current beam is identified as a SSB which is quasi-co located with a reference signal in an indicated TCI state.

16. The base station of claim 13, wherein a bandwidth of the RSRP of the current beam includes 7 bits.
